(19) United States
(12) Patent Application Publication
(10) Pub. No.: US 2026/0357796 A1
(43) Pub. Date: Nov. 12, 2026

(54) GAS RECOVERY SYSTEMS AND METHODS

(71) Applicant: TPE MIDSTREAM LLC, Tulsa, OK (US)

(72) Inventors: Steve Evans, Westford, MA (US); Kyle Giunta, North Chelmsford, MA (US); James LeFave, JR., Wilmington, MA (US); Calvin Winey, Peterborough, NH (US); Douglas A. Sahm, Lutz, FL (US)

(21) Appl. No.: 19/714,277

(22) Filed: Jun. 19, 2026

Related U.S. Application Data
(63) Continuation of application No. PCT/US2024/061102, filed on Dec. 19, 2024.
(63) Continuation-in-part of application No. PCT/US2024/061094, filed on Dec. 19, 2024.
(63) Continuation-in-part of application No. PCT/US2024/061095, filed on Dec. 19, 2024.
(63) Continuation-in-part of application No. PCT/US2024/061096, filed on Dec. 19, 2024.
(63) Continuation-in-part of application No. PCT/US2024/061099, filed on Dec. 19, 2024.
(60) Provisional application No. 63/614,289, filed on Dec. 22, 2023.
(60) Provisional application No. 63/614,292, filed on Dec. 22, 2023.
(60) Provisional application No. 63/614,297, filed on Dec. 22, 2023.
(60) Provisional application No. 63/614,287, filed on Dec. 22, 2023.
(60) Provisional application No. 63/614,293, filed on Dec. 22, 2023.

(51) Int. Cl. F04B 37/10; F04B 45/053; F17D 1/04

(52) U.S. Cl. CPC F04B 37/10; F04B 45/0533; F17D 1/04

(57) ABSTRACT

Gas recovery systems and methods are disclosed. An example apparatus includes a bleed gas source, and a drive device fluidly coupled to the bleed gas source and further fluidly coupled between a first location and a second location, a pressure differential between the first and second locations to drive operation of the drive device, the operation of the drive device to evacuate bleed gas from the bleed gas source and route the evacuated bleed gas to a third location.

### RELATED APPLICATIONS

This patent is a continuation of International Application No. PCT/US2024/061102, filed Dec. 19, 2024, which claims priority to U.S. Provisional Application No. 63/614,289, filed Dec. 22, 2023, a continuation-in-part of International Application No. PCT/US2024/061094, filed Dec. 19, 2024, which claims priority to U.S. Provisional Application No. 63/614,292, filed Dec. 22, 2023, a continuation-in-part of International Application No. PCT/US2024/061095, filed Dec. 19, 2024, which claims priority to U.S. Provisional Application No. 63/614,297, filed Dec. 22, 2023, a continuation-in-part of International Application No. PCT/US2024/061096, filed Dec. 19, 2024, which claims priority to U.S. Provisional Application No. 63/614,287, filed Dec. 22, 2023, and a continuation-in-part of International Application No. PCT/US2024/061099, filed Dec. 19, 2024, which claims priority to U.S. Provisional Application No. 63/614,293, filed Dec. 22, 2023. International Application No. PCT/US2024/061102, U.S. Provisional Application No. 63/614,289, International Application No. PCT/US2024/061094, U.S. Provisional Application No. 63/614,292, International Application No. PCT/US2024/061095, U.S. Provisional Application No. 63/614,297, International Application No. PCT/US2024/061096, U.S. Provisional Application No. 63/614,287, International Application No. PCT/US2024/061099, and U.S. Provisional Application No. 63/614,293 are hereby incorporated by reference in their entireties. Priority to International Application No. PCT/US2024/061102, U.S. Provisional Application No. 63/614,289, International Application No. PCT/US2024/061094, U.S. Provisional Application No. 63/614,292, International Application No. PCT/US2024/061095, U.S. Provisional Application No. 63/614,297, International Application No. PCT/US2024/061096, U.S. Provisional Application No. 63/614,287, International Application No. PCT/US2024/061099, and U.S. Provisional Application No. 63/614,293 is hereby claimed.

### FIELD OF THE DISCLOSURE

This disclosure relates generally to gas pipelines and, more particularly, to gas recovery systems and methods.

### BACKGROUND

In a natural gas pipeline, gas in a pipe can include methane and/or one or more other constituent gases. In some instances, gas-operated equipment can be implemented on the pipe to utilize pressurized gas from the pipe. The gas is often vented to the atmosphere, which is wasteful and harmful to the environment.

### BRIEF DESCRIPTION OF THE DRAWINGS

FIG. 1 illustrates an example gas recovery system constructed in accordance with teachings of this disclosure.

FIG. 2 illustrates a first example drive system that can be used to implement the example gas recovery system of FIG. 1.

FIG. 3 illustrates a second example drive system that can be used to implement the example gas recovery system of FIG. 1.

FIG. 4 illustrates a third example drive system that can be used to implement the example gas recovery system of FIG. 1.

FIG. 5A illustrates an example lever and an example rod that may be implemented in examples disclosed herein.

FIG. 5B illustrates the pistons and/or the rod of FIG. 5A in a second example position.

FIG. 5C illustrates the pistons and/or the rod of FIGS. 5A and/or 5B in a third example position.

FIG. 6A illustrates an example compressor that may be implemented in the example gas recovery system of FIG. 1.

FIG. 6B is a perspective view of a second example compressor that may be implemented in examples disclosed herein.

FIG. 6C illustrates the second example compressor of FIG. 6B with example cover plates removed.

FIG. 6D is a cross-sectional view of the second example compressor of FIGS. 6A and/or 6B taken along line A-A of FIG. 6C.

FIG. 6E is a top view of the second example compressor of FIG. 6D.

FIG. 6F is a cross-sectional view of the second example compressor of FIGS. 6B, 6C, 6D, and/or 6E taken along line B-B of FIG. 6C.

FIG. 6G is a cross-sectional view of the second example compressor of FIGS. 6B, 6C, 6D, 6E, and/or 6F taken along line C-C of FIG. 6C.

FIG. 6H is a front view of the second example compressor of FIG. 6G.

FIG. 7 illustrates a fourth example drive system that can be used to implement the example gas recovery system of FIG. 1.

FIG. 8 illustrates a fifth example drive system that can be used to implement the example gas recovery system of FIG. 1.

FIG. 9 illustrates a sixth example drive system that can be used to implement the example gas recovery system of FIG. 1.

FIG. 10 illustrates a seventh example drive system that can be used to implement the example gas recovery system of FIG. 1.

FIG. 11 illustrates an example screw-driven pump that can be implemented in the seventh example drive system of FIG. 10.

FIG. 12 illustrates an example vane pump that can be implemented in the seventh example drive system of FIG. 10.

FIG. 13 illustrates an example swash plate pump that can be implemented in the seventh example drive system of FIG. 10.

FIG. 14 illustrates an eighth example drive system that can be used to implement the example gas recovery system of FIG. 1.

FIG. 15 illustrates an example compressor unit that can be implemented in the eighth example drive system of FIG. 14.

FIG. 16 illustrates a ninth example drive system that can be used to implement the example gas recovery system of FIG. 1.

FIG. 17A illustrates a tenth example drive system that can be used to implement the example gas recovery system of FIG. 1.

FIG. 17B illustrates a perspective view of an example dual-diaphragm actuator that may be implemented in examples disclosed herein.

FIG. 17C illustrates a cross-sectional view of the example dual-diaphragm actuator of FIG. 17B.

FIG. 17D illustrates an example triple-diaphragm actuator that may be implemented in examples disclosed herein.

FIG. 17E illustrates an example quadruple-diaphragm actuator that may be implemented in examples disclosed herein.

FIG. 17F illustrates a perspective view of a second example dual-diaphragm actuator that may be implemented in examples disclosed herein.

FIG. 17G illustrates a partial transparent view of the second example dual-diaphragm actuator of FIG. 17F.

FIG. 18A illustrates a first example accumulator reservoir in an undeflected position.

FIG. 18B illustrates the first example accumulator reservoir of FIG. 18A in a deflected position.

FIG. 19A illustrates a second example accumulator reservoir in an undeflected position.

FIG. 19B illustrates the second example accumulator reservoir of FIG. 19A in a deflected position.

FIG. 20 is a flowchart representative of an example method to produce the first example drive system of FIG. 2, the second example drive system of FIG. 3, and/or the third example drive system of FIG. 4.

FIG. 21 is a flowchart representative of an example method to produce the fourth example drive system of FIG. 7.

FIG. 22 is a flowchart representative of example operations to implement a gas recovery procedure using the second example drive system of FIG. 2.

FIG. 23 is a flowchart representative of an example method to produce the fifth example drive system of FIG. 8.

FIG. 24 is a flowchart representative of an example method to produce the sixth example drive system of FIG. 9.

FIG. 25 is a flowchart representative of an example method to produce the seventh example drive system of FIG. 10.

FIG. 26 is a flowchart representative of an example method to produce the eighth example drive system of FIG. 14.

FIG. 27 is a flowchart representative of an example method to produce the ninth example drive system of FIG. 16.

FIG. 28 is a flowchart representative of an example method to produce the tenth example drive system of FIG. 17A.

FIG. 29 is a flowchart representative of an example method to produce the example gas recovery system of FIG. 1.

FIG. 30 is a flowchart representative of an example method 3000 to implement an example gas recovery procedure using the example gas recovery system of FIG. 1.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Buildings, plants, factories, and other facilities commonly use natural gas for various purposes such as heating, power generation, transportation, etc. In some cases, natural gas is transported between two or more locations using gas pipelines. Some pipelines include one or more gas-operated devices implemented thereon. Some such devices utilize gas pressure from the pipeline to operate, then release the gas (e.g., bleed gas) to the atmosphere. For example, the devices can include bleed devices, which can be flow control devices powered by the pressurized gas to automatically maintain a process condition such as a flow rate, a pressure, a temperature, etc., of the gas in the pipeline. In some cases, the bleed devices are intermittent bleed devices (e.g., intermittent bleed pneumatic devices) that may intermittently release (e.g., vent, discharge) a portion or all of the gas supplied thereto. Alternatively, some bleed devices continuously vent the supply gas to the atmosphere. Natural gas is composed of methane and/or one or more other constituent gases (e.g., carbon dioxide, water vapor, ethane, propane, etc.) that, when vented to the atmosphere, can be harmful to the environment and may pose a safety concern due to a risk of accidental combustion.

In recent years, to reduce release of bleed gas to the environment, some gas-powered devices have been replaced with electrically-actuated counterparts. However, electrically-actuated devices are often more expensive than gas-powered devices, and electrical power is often not available at many locations along the pipeline. Alternatively, pneumatically-actuated devices can be used instead of gas-operated devices to reduce and/or eliminate the emission of bleed gas. However, a supply of compressed air is not commonly available along the pipeline, and installation of an air compressor may be costly and/or may require electrical power.

Examples disclosed herein implement an example gas recovery system that is used to capture bleed gas emitted from a gas source (e.g., one or more gas-operated devices) and return the captured gas to a pipeline. In examples disclosed herein, the gas recovery system includes an example drive device fluidly coupled between a first example location and a second example location. In some examples, the first location corresponds to a first example pipe at a first example pressure, and the second location corresponds to a second example pipe at a second example pressure, where the first pressure is greater than the second pressure. In some examples, the drive device includes one or more example components (e.g., one or more example pistons, one or more example diaphragm actuators, one or more example turbines, one or more example fluid constrictors, etc.) fluidly coupled to the first location and/or the second location. In some examples, a pressure differential between the first and second locations is used to drive operation of the drive device and/or the one or more components thereof. In some examples, the drive device is further fluidly and/or operatively coupled to the gas source, such that operation of the drive device drives evacuation and/or compression of bleed gas from the gas source. Further, in some examples, the operation of the drive device can be used to route and/or pump the evacuated bleed gas to a third example location (e.g., corresponding to the first location, the second location, and/or a different example location) of a pipeline.

By capturing and returning bleed gas to a pipeline, examples disclosed herein may reduce an amount of the bleed gas vented and/or released to the atmosphere, which reduces risk of harm to the environment and/or reduces waste. Additionally, by utilizing pressure differential between two or more locations of a pipeline to drive the gas recovery system, examples disclosed herein reduce a need for additional pneumatic and/or electrical systems to be installed on a pipeline. In particular, examples disclosed herein can be implemented (e.g., retrofitted) on top of existing gas-operated devices and/or pipeline infrastructure, thus avoiding costs associated with installation of air compressors and/or outfitting of the pipeline with electrical power.

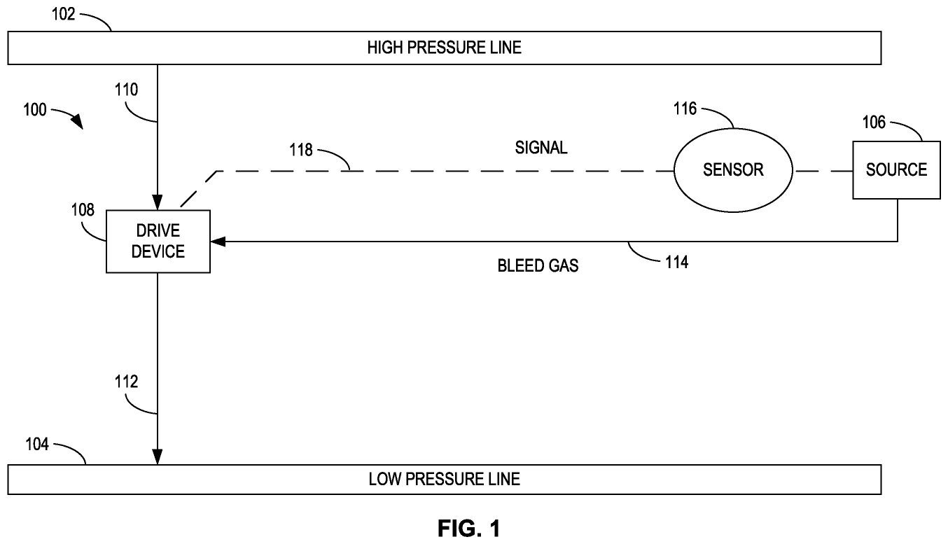

FIG. 1 illustrates an example gas recovery system (e.g., a differential pressure-driven gas recovery system) 100 constructed in accordance with teachings of this disclosure. In the illustrated example of FIG. 1, the gas recovery system 100 is fluidly coupled between a first example pipe (e.g., a high-pressure line) 102 and a second example pipe (e.g., a low-pressure line) 104. In this example, the first pipe 102 is pressurized to a first example pressure (e.g., between 900 pounds per square inch (psi) and 1500 psi), and the second pipe 104 is pressurized to a second example pressure (e.g., between 100 psi and 700 psi), where the second pressure is less than the first pressure.

In this example, the gas recovery system 100 is fluidly and/or operatively coupled to an example gas source (e.g., a bleed gas source) 106. In some examples, the gas source 106 corresponds to one or more gas-operated devices that utilize gas pressure from at least one of the first pipe 102 or the second pipe 104 to operate. For example, the gas-operated device(s) can include valves, actuators, and/or other flow control devices that may be operated using the pressurized gas. In some examples, the gas utilized to operate the gas-operated device(s) is then released (e.g., continuously and/or periodically) as bleed gas to the atmosphere. The release of such bleed gas to the atmosphere can be wasteful and harmful to the environment and/or may pose a safety concern due to a risk of accidental combustion.

In examples disclosed herein, the gas recovery system 100 utilizes a pressure differential between the first pipe 102 and the second pipe 104 to capture and/or compress bleed gas from the gas source 106 and provide the gas to another location (e.g., the first pipe 102 and/or the second pipe 104). For example, the pressure differential can be used to route drive gas from the first pipe 102 to one or more example components (e.g., an example piston and/or an example cylinder, an example diaphragm actuator, an example turbine, etc.) of an example drive device 108 of the gas recovery system 100 to drive operation thereof. In some examples, the drive gas can be used to drive reciprocal motion of an example piston in an example cylinder, reciprocal deflection of an example diaphragm of a diaphragm actuator, rotation of an example turbine, etc. In such examples, the operation of the one or more components of the drive device 108 results in the evacuation and/or compression of bleed gas from the gas source 106. Further, the drive device 108 can route and/or pump the evacuated bleed gas to a second location (e.g., the first pipe 102, the second pipe 104, a different pipe, a gas storage location, etc.), thus reducing an amount of the bleed gas to be vented and/or otherwise released to the atmosphere. In the illustrated example of FIG. 1, the drive device 108 is fluidly coupled between the first pipe 102 and the second pipe 104. In particular, a third example pipe 110 fluidly couples the drive device 108 to the first pipe 102, and a fourth example pipe 112 fluidly couples the drive device 108 to the second pipe 104. Further, an example bleed line 114 fluidly couples the gas source 106 to the drive device 108. In some examples, the gas recovery system 100 can pull the bleed gas from the gas source 106 via the bleed line 114 without resulting in a negative pressure (e.g., less than 0 psi) at the gas source 106. In this example, an example sensor (e.g., a sensor device) 116 is operatively coupled between the drive device 108 and the gas source 106.

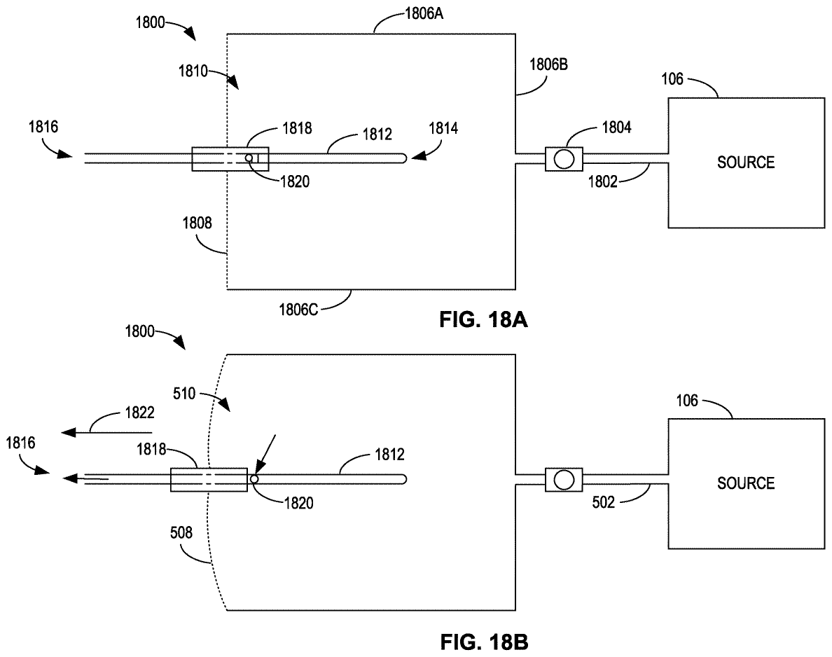

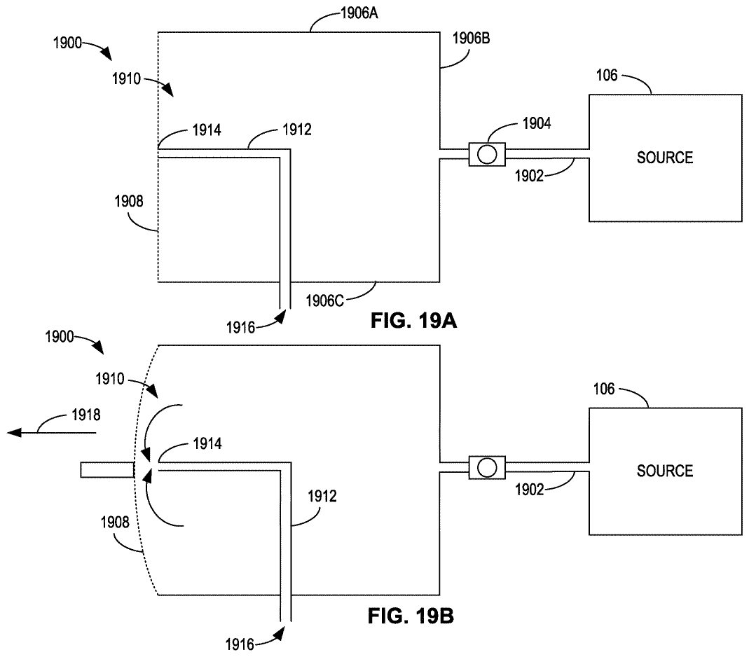

In the illustrated example of FIG. 1, the sensor 116 measures and/or detects bleed gas output from the gas source 106. In some examples, the sensor 116 is operatively coupled to an example accumulator (e.g., the first example accumulator reservoir 1800 of FIGS. 18A and/or 18B and/or the second example accumulator reservoir 1900 of FIGS. 19A and/or 19B) fluidly coupled to the gas source 106, where the accumulator receives and/or stores the bleed gas from the gas source 106. In some examples, the sensor 116 measures and/or detects a pressure in the accumulator, and the sensor 116 detects that bleed gas is present in the accumulator when the pressure of the bleed gas in the accumulator satisfies an example threshold (e.g., the pressure is at or above 1 psi, 1.5 psi, etc.). In this example, in response to the sensor 116 detecting the presence of bleed gas from the gas source 106 (e.g., in response to the pressure of the bleed gas in the accumulator satisfying the threshold), the sensor 116 provides an example control signal 118 to the drive device 108 to turn on and/or shut off the drive device 108 and/or otherwise control flow of gas to the drive device 108. In some examples, the control signal 118 can include a pneumatic signal and/or an electrical signal provided to the drive device 108. In some examples, based on the control signal 118, the drive device 108 operates to draw bleed gas away from the gas source 106 via the bleed line 114. The drive device 108 can compress the bleed gas and/or provide the bleed gas to the second pipe 104.

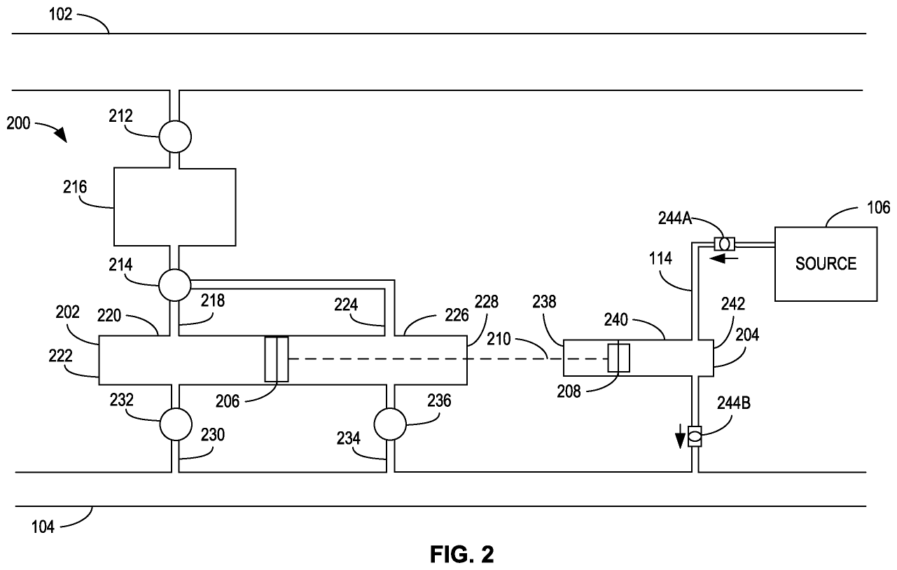

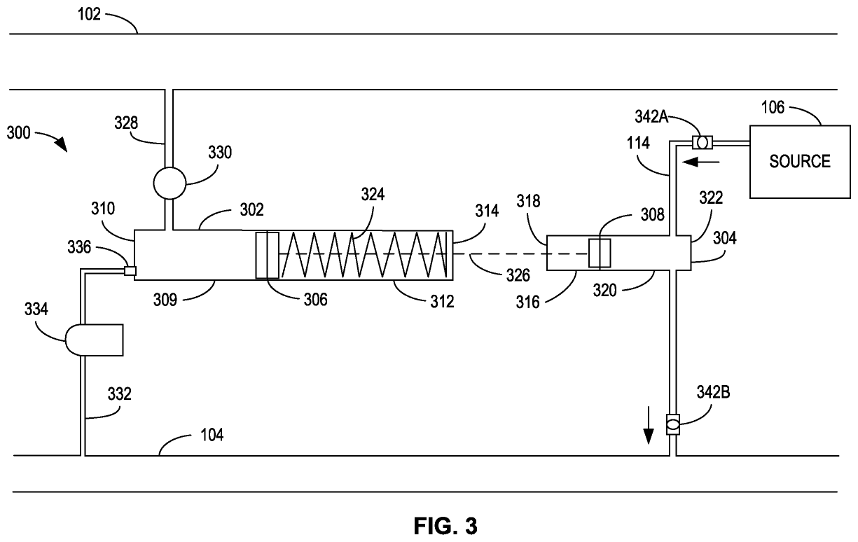

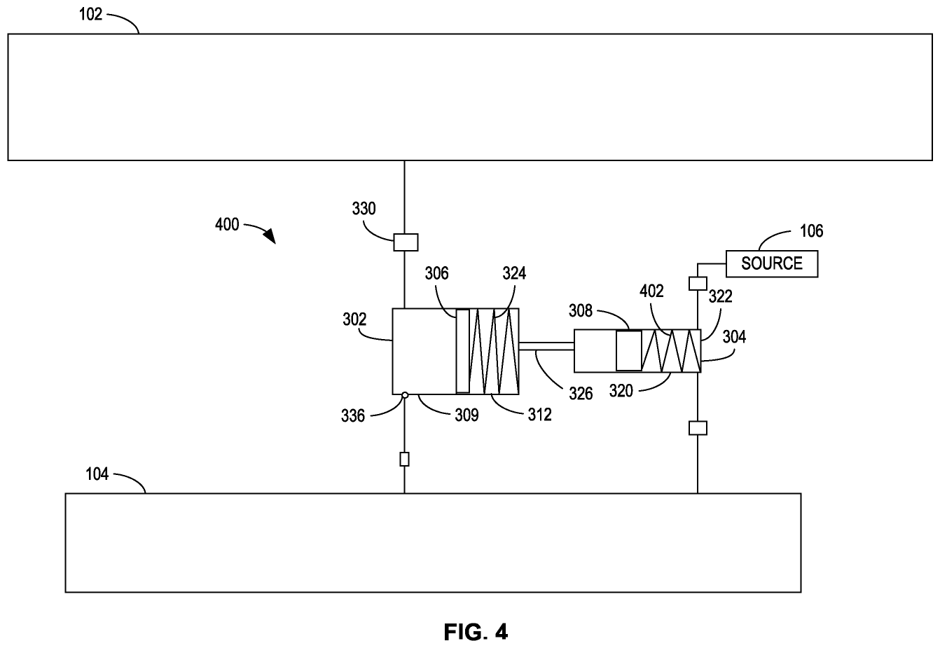

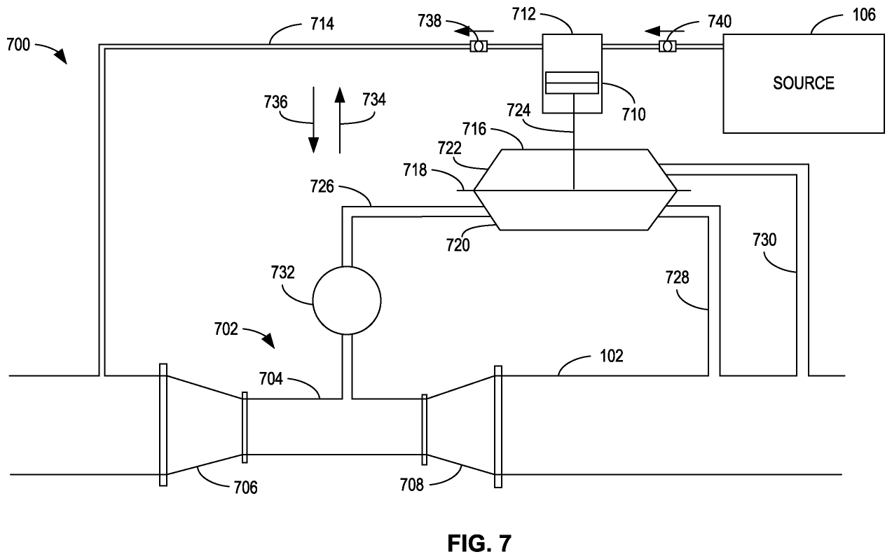

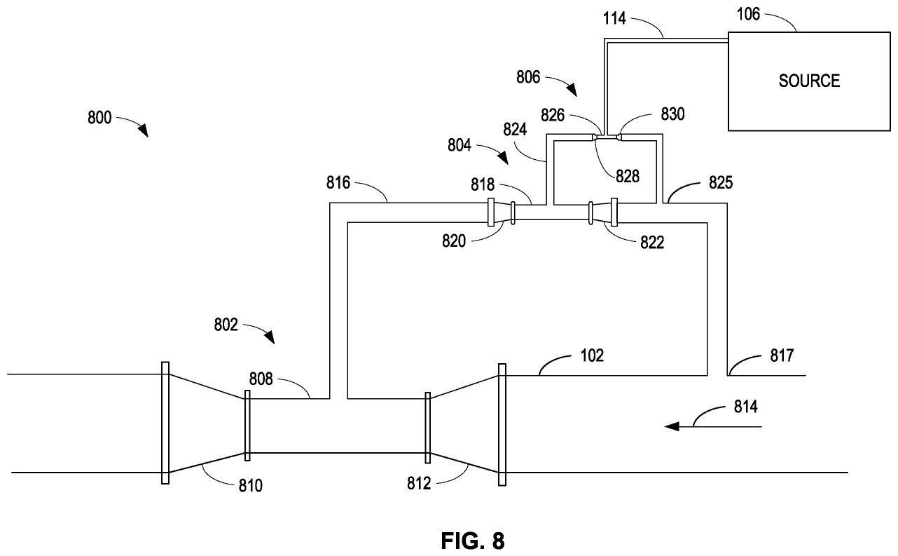

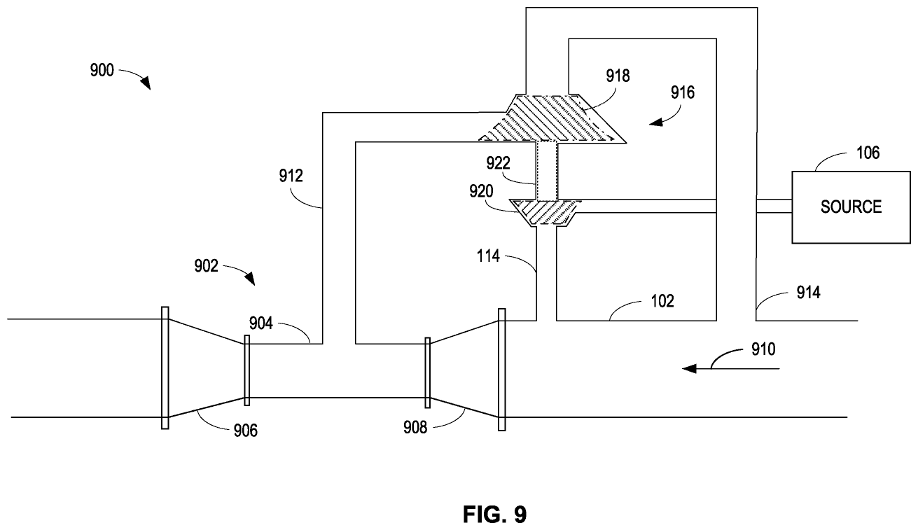

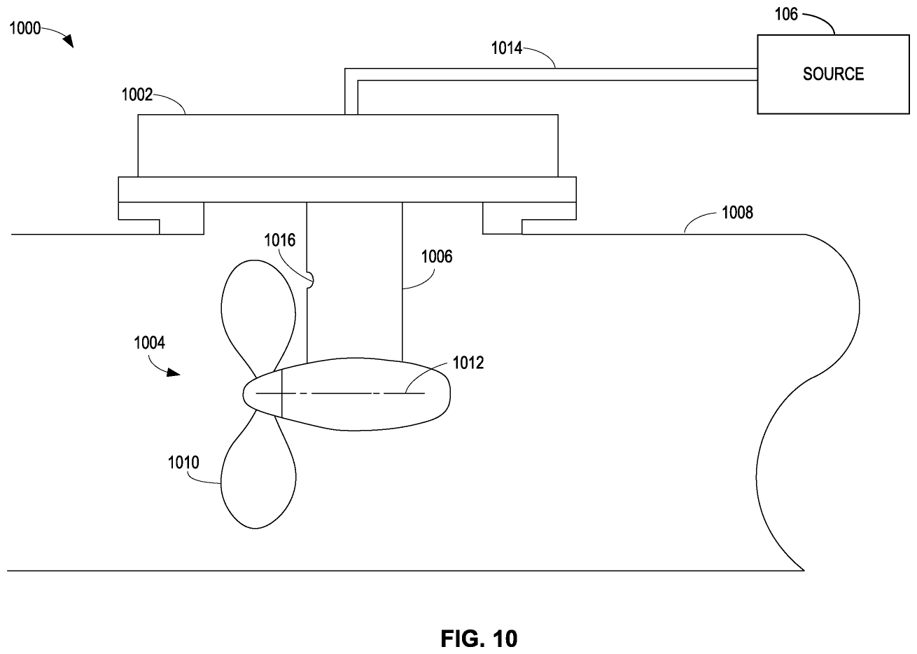

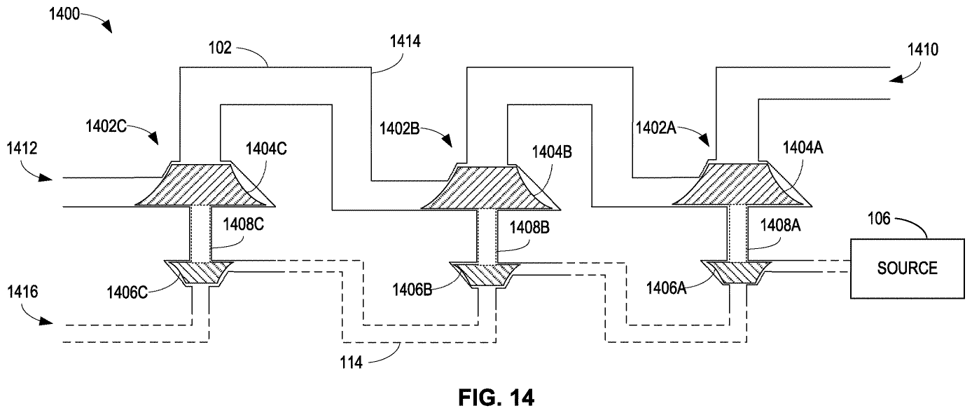

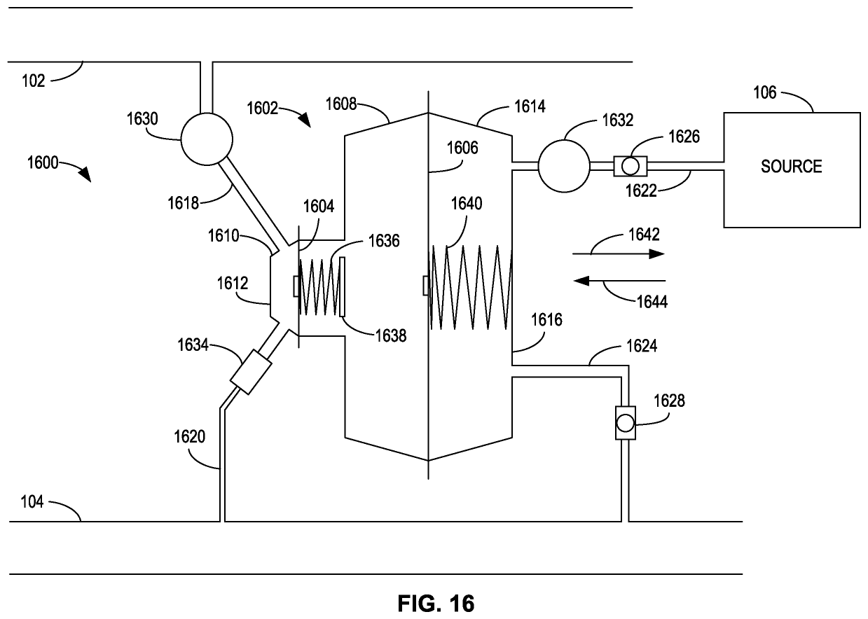

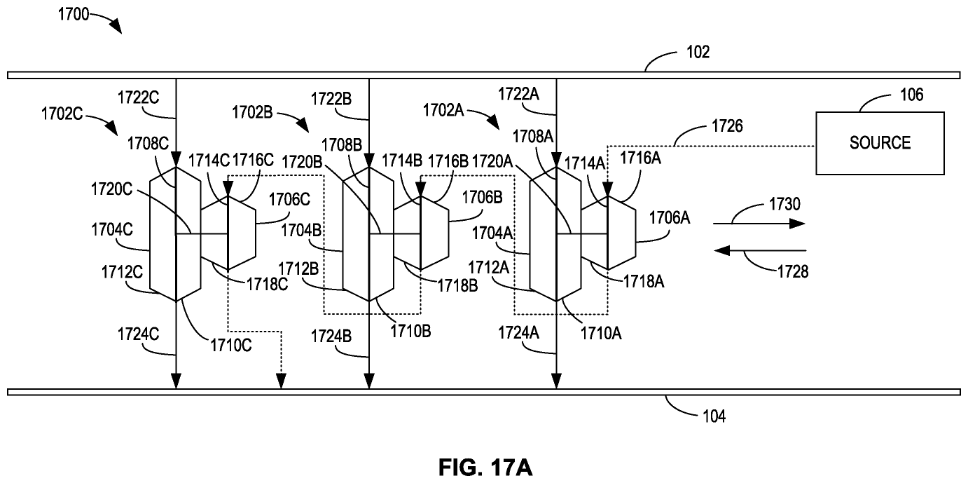

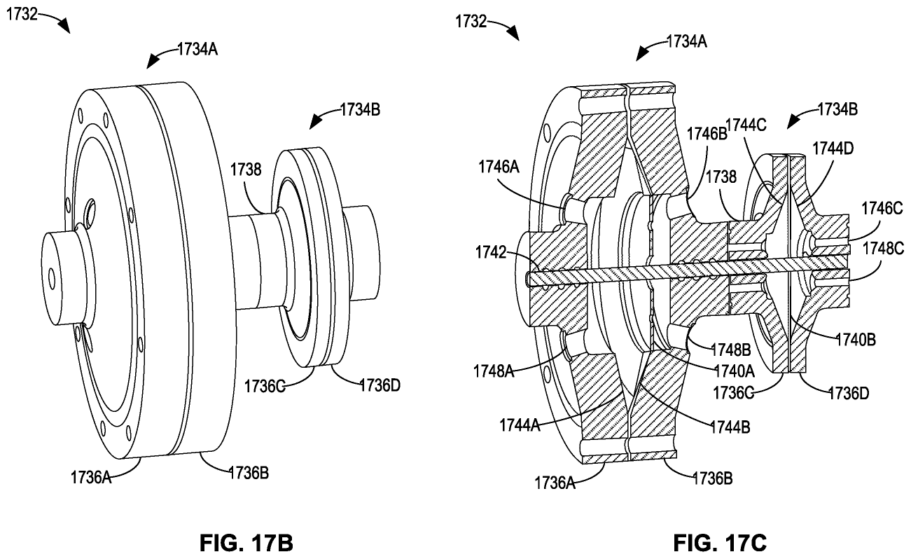

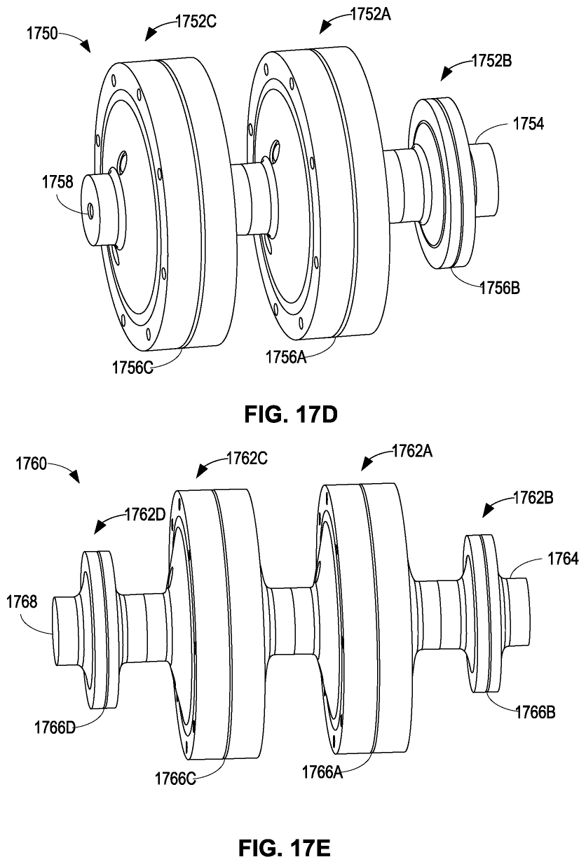

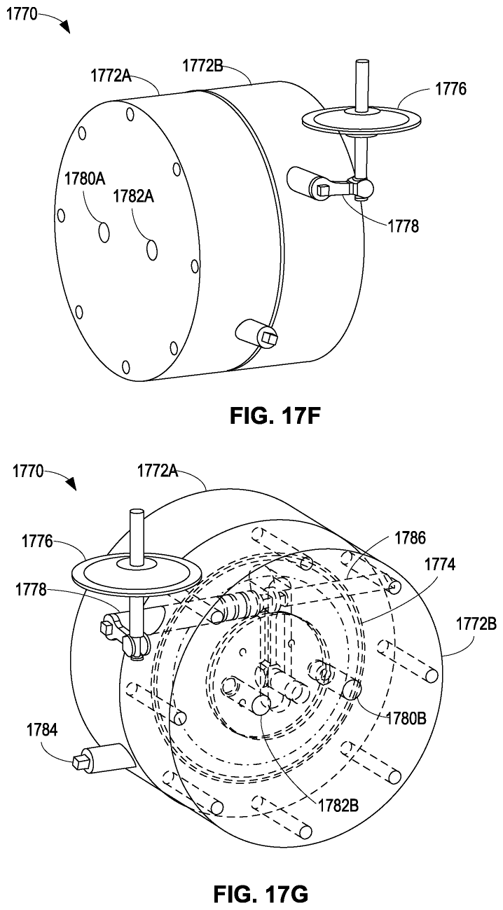

In some examples, different devices and/or configurations can be used to implement the functionality of the gas recovery system 100 of FIG. 1. In examples disclosed herein, the drive device 108 may be implemented using one or more example turbines, one or more example valves and/or example pistons, one or more example diaphragms, one or more example fluid constrictor devices (e.g., Venturis), one or more example pumps, and/or any other suitable device(s). For example, the drive device 108 can be implemented using one or more of the first example drive system 200 shown in FIG. 2, the second example drive system 300 shown in FIG. 3, the third example drive system 400 shown in FIG. 4, the fourth example drive system 700 shown in FIG. 7, the fifth example drive system 800 shown in FIG. 8, the sixth example drive system 900 shown in FIG. 9, the seventh example drive system 1000 shown in FIG. 10, the eighth example drive system 1400 shown in FIG. 14, the ninth example drive system 1600 shown in FIG. 16, or the tenth example drive system 1700 shown in FIG. 17A. In some examples, the one(s) of the drive systems 200, 300, 400, 700, 800, 900, 1000, 1400, 1600, 1700 can be selected (e.g., by an operator) for implementation based on an amount of space available, based on availability of equipment (e.g., number(s) and/or type(s) of valves, pistons, fluid constrictors, diaphragm actuators, turbines, etc.), based on availability of electrical and/or pneumatic power sources, etc.

FIG. 2 illustrates a first example drive system 200 that can be used to implement the example gas recovery system 100 of FIG. 1. In the illustrated example of FIG. 2, the first drive system 200 includes a first example cylinder (e.g., a first drive cylinder, a first compression cylinder) 202 fluidly and/or operatively coupled between the first and second pipes 102, 104. Further, a second example cylinder (e.g., a second drive cylinder, a second compression cylinder) 204 is implemented on the bleed line 114 and is fluidly and/or operatively coupled between the gas source 106 and the second pipe 104. In this example, a first example piston (e.g., a piston actuator) 206 is positioned in and/or slidable within the first cylinder 202, and a second example piston 208 is positioned in and/or slidable within the second cylinder 204. An example rod 210 couples (e.g., operatively couples) the first and second pistons 206, 208 such that the first and second pistons 206, 208 move together within the respective cylinders 202, 204.

In the illustrated example of FIG. 2, a first example valve 212, a second example valve 214, and an example reservoir 216 coupled therebetween are fluidly coupled between the first pipe 102 and the first cylinder 202. In this example, the second valve 214 is fluidly coupled, via a first example inlet line 218, to a first example chamber 220 defined in the first cylinder 202 between the first piston 206 and a first example end 222 of the first cylinder 202. Additionally, the second valve 214 is fluidly coupled, via a second example inlet line 224, to a second example chamber 226 defined in the first cylinder 202 between the first piston 206 and a second example end 228 of the first cylinder 202. In this example, the first chamber 220 is fluidly coupled to the second pipe 104 via a first example outlet line 230 and a third example valve 232 implemented along the first outlet line 230, and the second chamber 226 is fluidly coupled to the second pipe 104 via second example outlet line 234 and a fourth example valve 236 implemented along the second outlet line 234.

In some examples, the second valve 214 is a three-way valve that can be switched and/or moved between three different positions (e.g., configurations). For example, when the second valve 214 is in a closed position (e.g., a closed configuration), the second valve 214 restricts (e.g., blocks, prevents) fluid flow from the reservoir 216 to the first inlet line 218 and to the second inlet line 224. Further, when the second valve 214 is in a first open position (e.g., a first open configuration), the second valve 214 enables fluid flow from the reservoir 216 to the first inlet line 218, and restricts fluid flow from the reservoir 216 to the second inlet line 224. Conversely, when the second valve 214 is in a second open position (e.g., a second open configuration), the second valve 214 restricts fluid flow from the reservoir 216 to the first inlet line 218, and enables fluid from flow the reservoir 216 to the second inlet line 224. While the second valve 214 is implemented as a three-way valve in this example, the second valve 214 can be implemented using one or more different valves (e.g., separate valves implemented on the respective inlet lines 218, 224) instead. In some examples, the sensor 116 of FIG. 1 is operatively coupled to one or more of the valves 212, 214, 232, 236. In some such examples, the sensor 116 can switch one(s) of the valves 212, 214, 232, 236 between the open and closed positions by providing, halting, and/or adjusting the control signal 118 to one(s) of the valves 212, 214, 232, 236.

In some examples, the valves 212, 214, 232, 236 are in a closed position prior to initiation of a gas recovery procedure. To initiate the gas recovery procedure, the first valve 212 is opened to enable fluid (e.g., gas) to flow from the first pipe 102 to the reservoir 216. In some examples, the first valve 212 is held in an open position until the reservoir 216 is filled and/or is pressurized to a threshold pressure, where the threshold pressure corresponds to the first pressure in the first pipe 102. Once the reservoir 216 is pressurized to the threshold pressure, the first valve 212 is closed, the fourth valve 236 is opened, and the second valve 214 is switched to the first open position. In such examples, pressurized fluid from the reservoir 216 flows to the first chamber 220 via the first inlet line 218, and a buildup of pressure in the first chamber 220 causes the first piston 206 to move rightward within the first cylinder 202 (e.g., toward the second end 228 of the first cylinder 202). As the first piston 206 moves rightward, a volume of the gas in the first chamber 220 increases and, thus, a first pressure in the first chamber 220 decreases until the first pressure corresponds to a second pressure in the second chamber 226. In some examples, as the first piston 206 moves rightward in FIG. 2, the first piston 206 pushes the rod 210, and, thus, the second piston 208 rightward in the second cylinder 204. Further, as the first piston 206 moves rightward, gas is expelled from the second chamber 226 via the fourth valve 236 and/or the second outlet line 234, and the expelled gas is provided to the second pipe 102.

In some examples, the first piston 206 reaches a first piston position when the first pressure in the first chamber 220 corresponds to (e.g., is substantially equal to) the second pressure in the second chamber 226, such that the first piston 206 is stationary and/or ceases moving rightward in the first cylinder 202. In such examples, the second valve 214 switches to the closed position, and the first valve 212 is opened to enable refilling and/or re-pressurization of the reservoir 216 with fluid from the first pipe 102. In some examples, when the reservoir 216 is re-pressurized to the threshold pressure, the first and fourth valves 212, 236 are closed, the third valve 232 is opened, and the second valve 214 is switched to the second open position. In such examples, pressurized fluid from the reservoir 216 flows to the second chamber 226 via the second inlet line 224, and a buildup of pressure in the second chamber 226 causes the first piston 206 to move leftward within the first cylinder 202 (e.g., toward the first end 222 of the first cylinder 202).

As the first piston 206 moves leftward in FIG. 2, the first piston 206 pushes the rod 210 and, thus, the second piston 208 leftward in the second cylinder 204. Further, as the first piston 206 moves leftward, gas is expelled from the first chamber 220 via the third valve 232 and/or the first outlet line 230, and the expelled gas is returned to the second pipe 102. Further, as the first piston 206 moves leftward in FIG. 2, a volume of the gas in the second chamber 226 increases and, thus, the second pressure in the second chamber 226 decreases until the second pressure corresponds to the first pressure in the first chamber 220. In some examples, the first piston 206 reaches a second piston position when the first pressure in the first chamber 220 corresponds to the second pressure in the second chamber 226, such that the first piston 206 is stationary and/or ceases moving leftward in the first cylinder 202.

In some examples, by opening and/or closing respective ones of the valves 212, 214, 232, 236 as described above, flow of gas from the first pipe 102 can be alternated between the first and second chambers 220, 226 to drive reciprocal motion of the first piston 206 in the first cylinder 202. In turn, the resulting reciprocal motion of the second piston 208 in the second cylinder 204 is used to draw bleed gas (e.g., exhaust gas) away from the gas source 106 and provide (e.g., push) the bleed gas to the second pipe 104. In particular, when the second piston 208 moves leftward in the second cylinder 204 in FIG. 2 (e.g., toward a third example end 238 of the second cylinder 204), suction caused by the leftward motion of the second piston 208 draws the bleed gas from the gas source 106 and into a third example chamber 240 of the second cylinder 204. Conversely, when the second piston 208 moves rightward in the second cylinder 204 in FIG. 2 (e.g., toward a fourth example end 242 of the second cylinder 204), the second piston 208 causes gas to be expelled from the third chamber 240 and flow to the second pipe 104.

In the example of FIG. 2, a first example check valve 244A is implemented along the bleed line 114 between the gas source 106 and the second cylinder 204, and second example check valve 244B is implemented along the bleed line 114 between the third chamber 240 and the second pipe 104. In some examples, the check valves 244A, 244B restrict backflow of fluid from the second pipe 104 and/or the third chamber 240 toward the gas source 106. While two of the check valves 244A, 244B are used in this example, a different number of check valves may be used instead. In the illustrated example of FIG. 2, by recovering the bleed gas from the gas source 106 and returning the bleed gas to the second pipe 104, the first drive system 200 of FIG. 2 can reduce emissions of gas from the gas source 106 to the atmosphere, which reduces waste and/or risk of harm to the environment.

FIG. 3 illustrates a second example drive system 300 that can be used to implement the example gas recovery system 100 of FIG. 1. In the illustrated example of FIG. 3, the first drive system 200 includes a first example cylinder 302 fluidly coupled between the first and second pipes 102, 104, and a second example cylinder 304 is implemented on the bleed line 114 and fluidly coupled between the gas source 106 and the second pipe 104. In this example, a first example piston (e.g., a first spring-loaded piston, a piston actuator) 306 is positioned in and/or slidable within the first cylinder 302, and a second example piston 308 is positioned in and/or slidable within the second cylinder 304. In the example of FIG. 3, a first example chamber 309 is defined in the first cylinder 302 between the first piston 306 and a first example end 310 of the first cylinder 302, and a second example chamber 312 is defined in the first cylinder 302 between the first piston 306 and a second example end 314 of the first cylinder 302. Further, a third example chamber 316 is defined in the second cylinder 304 between the second piston 308 and a third example end 318 of the second cylinder 304, and a fourth example chamber 320 is defined in the second cylinder 304 between the second piston 308 and a fourth example end 322 of the second cylinder 304. In the example of FIG. 3, an example spring 324 is positioned in the second chamber 312 of the first cylinder 302 and is coupled (e.g., operatively coupled) between the first piston 306 and the second end 314 of the first cylinder 302. An example rod 326 couples (e.g., operatively couples) the first and second pistons 306, 308 such that the first and second pistons 306, 308 move together within the respective cylinders 302, 304.

In the illustrated example of FIG. 3, the first chamber 309 of the first cylinder 302 is fluidly coupled to the first pipe 102 via an example inlet line 328, and a first example valve 330 is implemented along the inlet line 328 to control a flow of fluid (e.g., gas) to the first chamber 309. In particular, when the first valve 330 is in a closed position, the closed first valve 330 restricts (e.g., blocks, prevents) fluid flow to the first chamber 309, and, when the first valve 330 is in an open position, the first valve 330 enables fluid flow to the first chamber 309. Further, the first chamber 309 is fluidly coupled to the second pipe 104 via an example outlet line 332, and a second example valve (e.g., an overpressure safety valve) 334 is implemented along the outlet line 332. In this example, an example bleed valve 336 couples the first chamber 309 to the outlet line 332.

In operation, a gas recovery procedure can be initiated by switching the first valve 330 to the open position, which enables fluid to flow from the first pipe 102 to the first chamber 309 via the inlet line 328. In some examples, a buildup of fluid pressure in the first chamber 309 causes the first piston 306 to move rightward within the first cylinder 302 in FIG. 3 (e.g., toward the second end 314 of the first cylinder 302) to compress the spring 324 in the second chamber 312. In some examples, as the first piston 306 moves rightward in FIG. 3, the first piston 306 pushes the rod 326 and, thus, the second piston 308 rightward in the second cylinder 304. In some examples, the first valve 330 is switched to the closed position when the pressure in the first chamber 309 corresponds to a first pressure in the first pipe 102 (e.g., 1300 psi, 1400 psi, 1450 psi, 1500 psi, etc.). In some examples, the sensor 116 of FIG. 1 is operatively coupled to the first valve 330. In some such examples, the sensor 116 can switch the first valve 330 between the open and closed positions by providing, halting, and/or adjusting the control signal 118 to the first valve 330.

In some examples, the bleed valve 336 relieves pressure from the first chamber 309 by slowly releasing the fluid from the first chamber 309 into the outlet line 332. In such examples, the fluid released to the outlet line 332 is at a second pressure less than the first pressure in the first chamber 309. In particular, the second pressure corresponds to the pressure in the second pipe 104 (e.g., 40 psi, 50 psi, 55 psi, etc.) in some examples. The fluid from the first chamber 309 then flows to the second pipe 104 and/or mixes with the fluid therein. In the example of FIG. 3, the second valve 334 is a pressure relief valve (e.g., an overpressure safety valve) that relieves pressure from the outlet line 332 when the pressure of the fluid therein does not satisfy (e.g., is greater than) a threshold pressure. In some examples, the threshold pressure is at or above the pressure in the second pipe 104. In some examples, by relieving and/or preventing excessive pressures in the outlet line 332, the second valve 334 can reduce and/or prevent damage to one or more components of the second drive system 300.

In some examples, the pressure in the first chamber 309 reduces as the fluid from the first chamber 309 is released to the outlet line 332. In some examples, when the pressure in the first chamber 309 is less than a spring force of the compressed spring 324, the spring 324 extends and pushes the first piston 306 leftward in the first cylinder 302 toward the first end 310 of the first cylinder 302 and, thus, causes the second piston 308 to move leftward in the second cylinder 304 toward the third end 318 of the second cylinder 304. When the pressure in the first chamber 309 returns to a starting pressure (e.g., 30 psi, 40 psi, 45 psi, 55 psi, etc.) and/or the spring 324 is uncompressed, the first valve 330 can be reopened to enable additional fluid to flow from the first pipe 102 to the first chamber 309.

In some examples, the above process may be repeated to drive reciprocal motion of the first piston 306 and the second piston 308 in the respective first and second cylinders 302, 304. In some such examples, the reciprocal motion of the second piston 308 can be used to draw bleed gas (e.g., exhaust gas) away from the gas source 106 and provide (e.g., push) the bleed gas to the second pipe 104. In particular, when the second piston 308 moves leftward in the second cylinder 304 in FIG. 3 (e.g., toward the third end 318 of the second cylinder 304), suction caused by the leftward motion of the second piston 308 draws the bleed gas from the gas source 106 and into the fourth chamber 320 of the second cylinder 304. Conversely, when the second piston 308 moves rightward in the second cylinder 304 in FIG. 3 (e.g., toward the fourth end 322 of the second cylinder 304), the second piston 308 causes the bleed gas to be expelled from the fourth chamber 320 and flow to the second pipe 104.

In the example of FIG. 3, a first example check valve 342A is implemented along the bleed line 114 between the gas source 106 and the second cylinder 304, and second example check valve 342B is implemented along the bleed line 114 between the second cylinder 304 and the second pipe 104. While two of the check valves 342A, 342B are used in this example, a different number of check valves may be used instead. In some examples, the check valves 342A, 342B restrict backflow of fluid from the second pipe 104 and/or the fourth chamber 320 toward the gas source 106.

FIG. 4 illustrates a third example drive system 400 that can be used to implement the example gas recovery system 100 of FIG. 1. The third drive system 400 is substantially similar to the second drive system 300 in the illustrated example of FIG. 3, but further includes a second example spring 402 positioned in the fourth chamber 320 of the second cylinder 304 and coupled (e.g., operatively coupled) between the second piston 308 and the fourth end 322 of the second cylinder 304. In some examples, the second spring 402 can be used in addition to or instead of the first spring 324 in the second chamber 312 of the first cylinder 302. In the illustrated example of FIG. 4, when the first valve 330 is open and fluid flows from the first pipe 102 to the first chamber 309, pressure in the first chamber 309 pushes the first and second pistons 306, 308 rightward in FIG. 4, thus compressing both the first and second springs 324, 402 in the respective second and fourth chambers 312, 320. Further, when the fluid pressure is released from the first chamber 309 through the bleed valve 336, spring forces from the compressed first and second springs 324, 402 cause the first and second pistons 306, 308 to move leftward in FIG. 4, such that the first and second springs 324, 402 can return to an uncompressed (or less compressed) starting position.

In some examples, by utilizing both the first and second springs 324, 402, the spring force on the first and second pistons 306, 308 is greater compared to when only one of the first spring 324 or the second spring 402 is used. As such, the first and second pistons 306, 308 can return to the starting position faster and/or at lower pressures in the first chamber 309 compared to when only one of the first spring 324 or the second spring 402 is used. While the first and second pistons 306, 308 are operatively coupled via the rod 326 in this example, in some other examples, force between the pistons 306, 308 may be communicated using another mechanical link and/or hydraulic fluid.

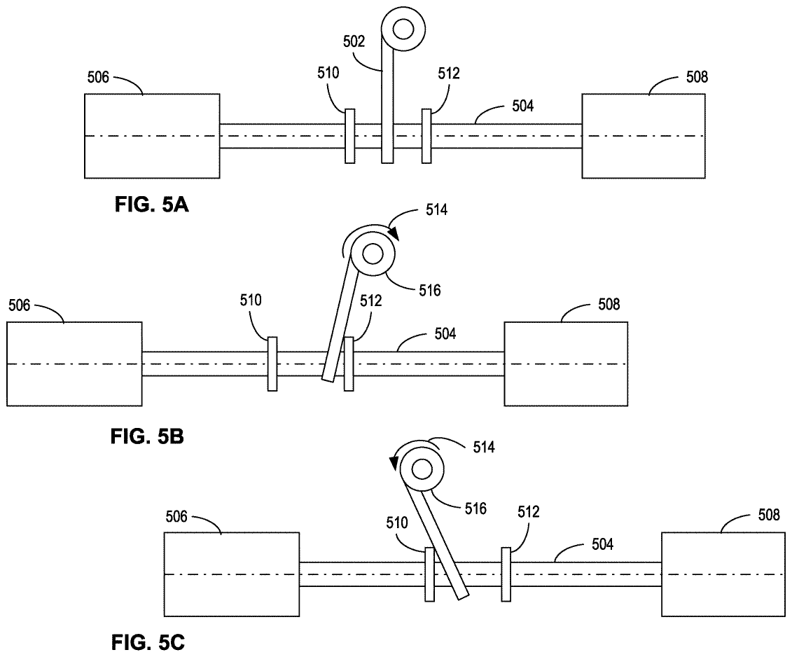

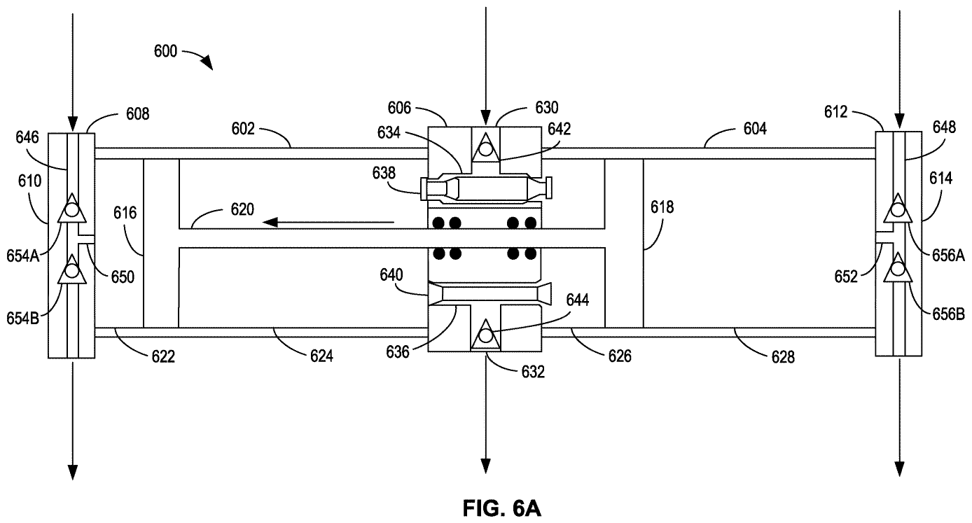

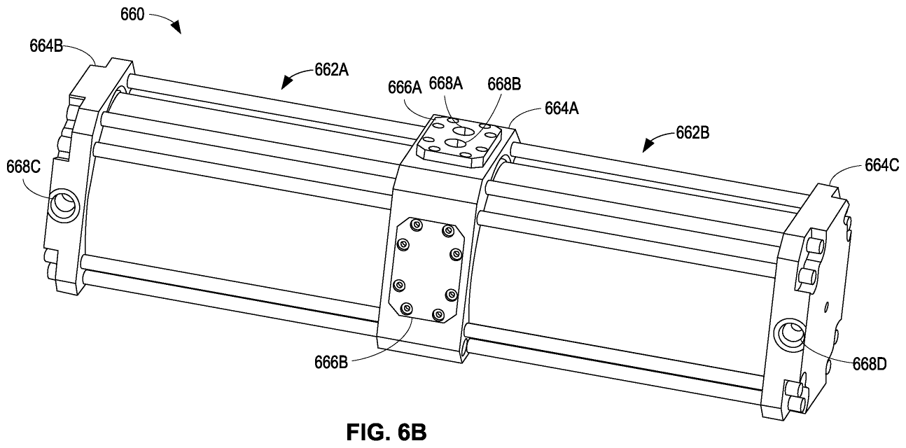

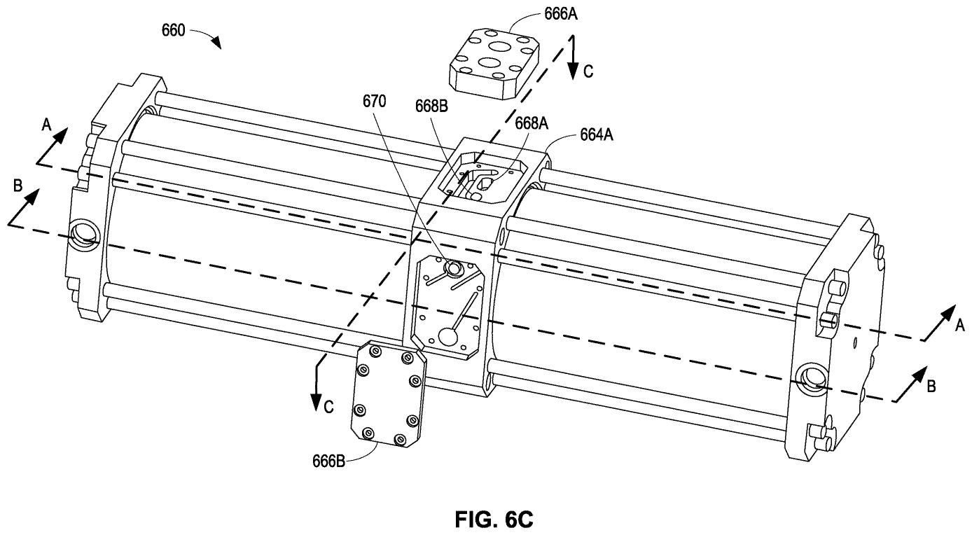

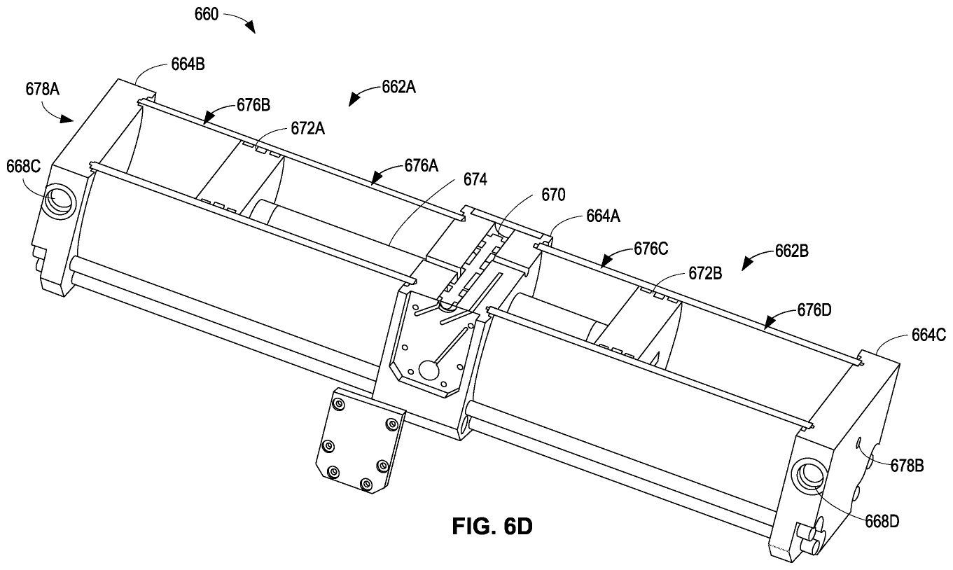

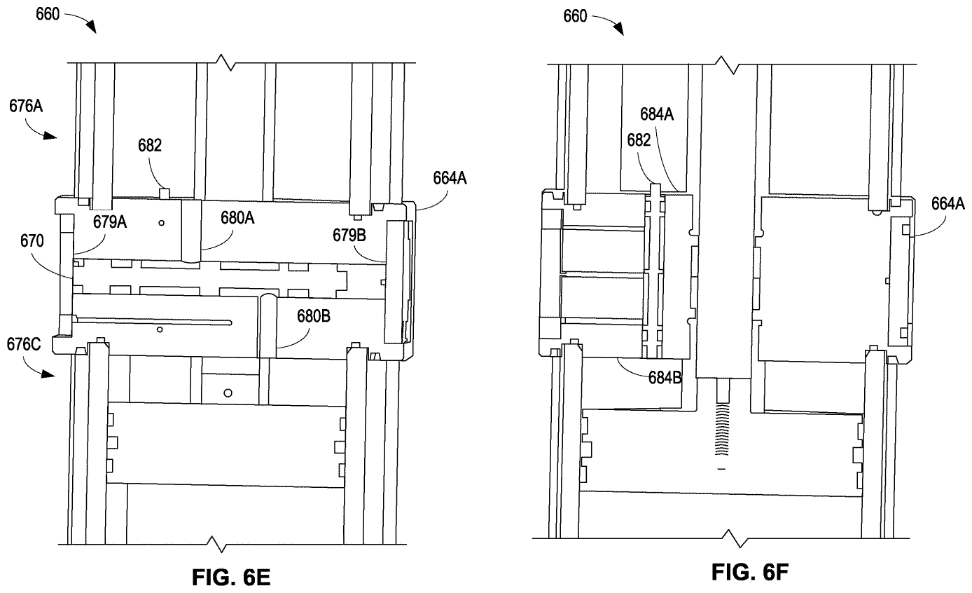

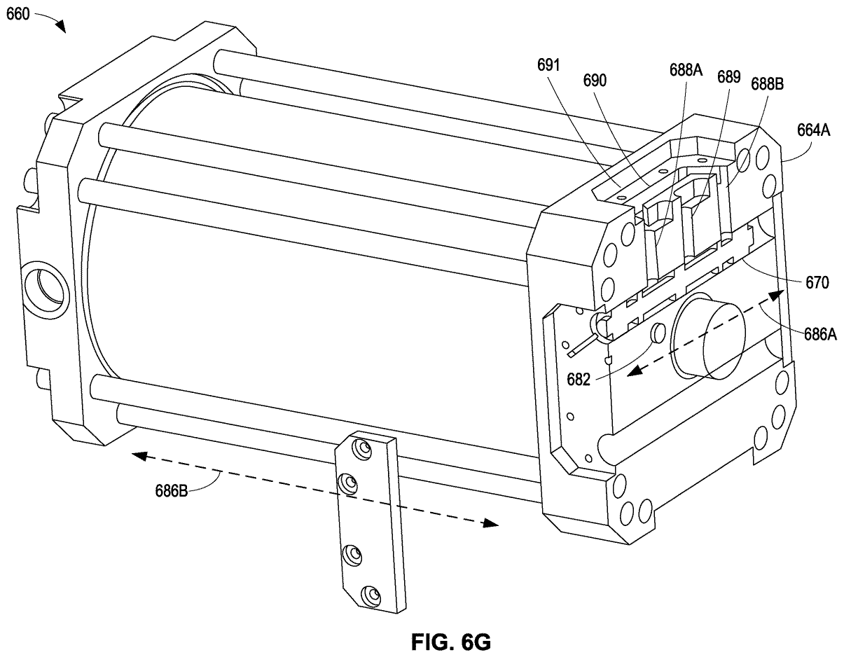

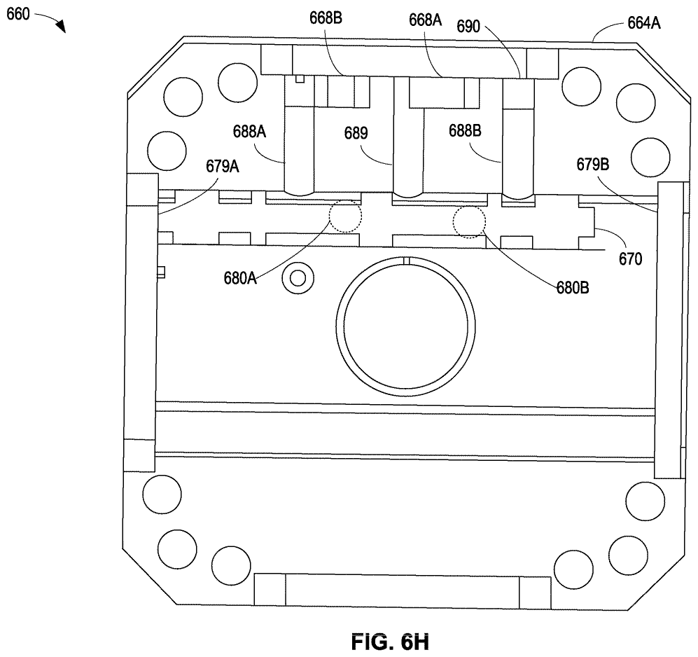

FIG. 5A illustrates an example lever (e.g., a valve lever) 502 and an example rod 504 that may be implemented in examples disclosed herein. In particular, the lever 502 and rod 504 may be implemented in one or more of the first example drive system 200 of FIG. 2, the second example drive system 300 of FIG. 3, the third example drive system 400 of FIG. 4, the fourth example drive system 700 of FIG. 7, or the example compressor 600 of FIG. 6A. In the illustrated example of FIG. 5A, the example rod 500 is coupled between first and second example pistons 506, 508. In some examples, the first and second example pistons 506, 508 of FIG. 5A correspond to the pistons 206, 208 of FIG. 2, and the example rod 504 of FIG. 5A corresponds to the rod 210 of FIG. 2. In some examples, the first and second example pistons 506, 508 of FIG. 5A correspond to the pistons 306, 308 of FIGS. 3 and/or 4, and the example rod 504 of FIG. 5A corresponds to the rod 326 of FIGS. 3 and/or 4. In some examples, the first and second example pistons 506, 508 of FIG. 5A correspond to the piston 710 and the diaphragm 718 of FIG. 7, and the example rod 504 of FIG. 5A corresponds to the rod 724 of FIG. 7. In some examples, the first and second example pistons 506, 508 of FIG. 5A correspond to the piston 710 and the diaphragm 718 of FIG. 7, and the example rod 504 of FIG. 5A corresponds to the rod 724 of FIG. 7.

In the illustrated example of FIG. 5A, the rod 504 includes first and second example flanges 510, 512, and the lever 502 is positioned between the first and second flanges 510, 512. In particular, the rod 504 and/or the pistons 506, 508 are shown in a first position (e.g., a starting position) in which the lever 502 is not in contact with the flanges 510, 512. In some examples, the lever 502 is operatively coupled to one or more flow control devices (e.g., the valve 214 of FIG. 2, the valve 330 of FIGS. 3 and/or 4, the plugs 638, 640 of FIG. 6A, and/or the valve 732 of FIG. 7) to control position(s) of the flow control device(s) based on movement of the pistons 506, 508 and/or the rod 504.

Turning to FIG. 5B, the pistons 506, 508 and/or the rod 504 are shown in a second position (e.g., a leftward position) relative to the pistons 506, 508 and/or the rod 504 in FIG. 5A. In some examples, the pistons 506, 508 and/or the rod 504 move to the second position when a second pressure in the second chamber 226 of FIG. 2 is greater than a first pressure in the first chamber 220 of FIG. 2. For example, the second pressure may be between 900 psi and 1500 psi, and the first pressure may be between 100 psi and 700 psi. In some examples, when the rod 504 is in the second position of FIG. 5B, contact between the second flange 512 and the lever 502 produces a first example moment 514 in a first direction (e.g., a clockwise direction) about an example rotational axis 516 of the lever 502. In some examples, the first moment 514 causes the valve 214 of FIG. 2 to switch to a first position in which the valve 214 enables fluid flow to the first chamber 220 and restricts fluid flow to the second chamber 226. Additionally or alternatively, the first moment 514 can cause the valve 330 of FIGS. 3 and/or 4 and/or the valve 732 of FIG. 7 to move to a first position (e.g., an open position), and/or may adjust a position of the plugs 638, 640 of FIG. 6A (e.g. leftward and/or rightward in FIG. 6A).

Conversely, FIG. 5C illustrates the pistons 506, 508 and/or the rod 504 in a third position (e.g., a rightward position) relative to the first position shown in FIG. 5A. In some examples, the pistons 506, 508 and/or the rod 504 move to the third position when a second pressure in the second chamber 226 of FIG. 2 is less than a first pressure in the first chamber 220 of FIG. 2, a fourth pressure in the second chamber 312 of FIGS. 3 and/or 4 is less than a third pressure in the first chamber 309 of FIGS. 3 and/or 4, a fifth pressure in the third chamber 626 is greater than a sixth pressure in the second chamber 624 of FIG. 6A, etc. In the illustrated example of FIG. 5C, when the rod 504 is in the third position of FIG. 5C, contact between the first flange 510 and the lever 502 produces a second example moment 518 in a second direction (e.g., a counterclockwise direction) about the rotational axis 516, where the second direction is opposite to the first direction. In some examples, the second moment 518 causes the valve 214 of FIG. 2 to switch to a second position in which the valve 214 enables fluid flow to the second chamber 226 and/or restricts fluid flow to the first chamber 220. Additionally or alternatively, the second moment 518 can cause the valve 330 of FIGS. 3 and/or 4 and/or the valve 732 of FIG. 7 to move to a second position (e.g., a closed position), and/or may adjust a position of the plugs 638, 640 of FIG. 6A (e.g. leftward and/or rightward in FIG. 6A).

In some examples, detent features may be used to hold the lever 502 and, thus, the flow control device(s) (e.g., the valve 214 of FIG. 2, the valve 330 of FIGS. 3 and/or 4, the plugs 638, 640 of FIG. 6A, and/or the valve 732 of FIG. 7) in position during a dwell period (e.g., a duration during which the rod 504 moves from the second position of FIG. 5B to the third position of FIG. 5C and/or from the third position to the second position). In some examples, a duration of the dwell period is selected to enable proper functioning (e.g., cycling) of the drive system (e.g., the first example drive system 200 of FIG. 2, the second example drive system 300 of FIG. 3, the third example drive system 400 of FIG. 4, the fourth example drive system 700 of FIG. 7, or the example compressor 600 of FIG. 6A). In some examples, the duration of the dwell period may be selected based on a pressure and/or flow of the gas through the flow control device(s). In some examples, by holding the lever 502 and, thus, the flow control device(s) in place during the dwell period, the detent features reduce and/or prevent premature switching of the flow control device(s).

In some examples, the pistons 506, 508 and the rod 504 cycle between the second position of FIG. 5B and the third position of FIG. 5C to alternate the flow of fluid between the first and second chambers 220, 226. The alternating flow is used to adjust pressures in the first and second chambers 220, 226, which, in turn, drives the reciprocal motion of the pistons 506, 508 and the rod 504. As such, the reciprocal motion of the pistons 506, 508 and the rod 504 can be controlled without the use of a separate drive device (e.g., an actuator, a pneumatic switch, etc.) to adjust the position of the valve 214. Further, while the rod 504, the pistons 506, 508, and/or the lever 502 are described in connection with the first drive system of FIG. 2, the rod 504, the pistons 506, 508, and/or the lever 502 can additionally or alternatively be implemented in the second drive system 300 of FIG. 3 and/or the third drive system 400 of FIG. 4 to control the position(s) of one or more valves therein.

FIG. 6A illustrates an example compressor (e.g., a reciprocating compressor) 600 that may be implemented in the example gas recovery system 100 of FIG. 1. In the illustrated example of FIG. 6A, the compressor 600 includes a first example cylinder 602 and a second example cylinder 604 coupled together at a first example flanged portion 606 of the compressor 600. The compressor 600 further includes a second example flanged portion 608 coupled to the first cylinder 602 at a first end 610 of the compressor 600, and a third example flanged portion 612 coupled to the second cylinder 604 at a second end 614 of the compressor 600. In the example of FIG. 6A, a first example piston 616 is positioned in and/or slidable within the first cylinder 602, and a second example piston 616 is positioned in and/or slidable within the second cylinder 604. An example rod 620 couples (e.g., operatively couples) the first and second pistons 616, 618. A first example chamber 622 is defined in the first cylinder 602 between the second flanged portion 608 and the first piston 616, a second example chamber 624 is defined in the first cylinder 602 between the first piston 616 and the first flanged portion 606, a third example chamber 626 is defined in the second cylinder 604 between the first flanged portion 606 and the second piston 618, and a fourth example chamber 628 is defined between the second piston 618 and the third flanged portion 612.

In the illustrated example of FIG. 6A, the first flanged portion 606 includes an example inlet port 630 fluidly coupled to the first pipe 102 of FIG. 1 and an example outlet port 632 fluidly coupled to the second pipe 102. In this example, the inlet port 630 is fluidly coupled to a first example fluid passageway 634 extending through the first flanged portion 606 between the second and third chambers 624, 626. Further, the outlet port 632 is fluidly coupled to a second example fluid passageway 636 extending through the first flanged portion 606 between the second and third chambers 624, 626. In the example of FIG. 6A, a first example plug 638 is disposed in and/or movable within the first fluid passageway 634, and a second example plug 640 is disposed in and/or movable within the second fluid passageway 636. In this example, example check valves 642, 644 are implemented within the respective inlet and outlet ports 630, 632 to restrict backflow from the first fluid passageway 634 to the inlet port 630 and/or from the outlet port 632 to the second fluid passageway 636.

In the illustrated example of FIG. 6A, the first and second plugs 638, 640 are shown in a first position (e.g., a rightward position) in the respective first and second fluid passageways 634, 636. When in the first position, the first plug 638 engages with the first flanged portion 606 to restrict fluid flow from the inlet port 630 to the second chamber 626 and enable fluid flow from the inlet port 630 to the first chamber 624. Conversely, the second plug 640 in the first position engages with the first flanged portion 606 to restrict fluid flow from the first chamber 624 to the outlet port 632 and enable fluid flow from the second chamber 626 to the outlet port 632. In operation, when the first and second plugs 638, 640 are in the first position of FIG. 6A, fluid from the first pipe 102 flows to the second chamber 624 to increase a pressure in the second chamber 624. As a result of the buildup of pressure in the second chamber 624, the first and second pistons 616, 618 move leftward in FIG. 6A toward the first end 610 of the compressor 600.

In the illustrated example of FIG. 6A, the second flanged portion 608 includes a third example fluid passageway 646 that operatively couples the gas source 106 to the second pipe 104 of FIG. 1. Further, the third flanged portion 612 includes a fourth example fluid passageway 648 that operatively couples the gas source 106 to the second pipe 104. In this example, the third fluid passageway 646 is fluidly coupled to the first chamber 622 via a first example port 650, and the fourth fluid passageway 648 is fluidly coupled to the fourth chamber 628 via a second example port 652. In this example, example check valves 654A, 654B are implemented along the third fluid passageway 646 to restrict backflow from the second pipe 104 and/or the first chamber 622, and example check valves 656A, 656B are implemented along the fourth fluid passageway 648 to restrict backflow from the second pipe 104 and/or the fourth chamber 628.

In some examples, as the first and second pistons 616, 618 move leftward in FIG. 6A, fluid from the third chamber 626 is expelled via the second fluid passageway 636 and the outlet port 632 to the second pipe 104. Further, a pressure of the fluid in the second chamber 624 reduces as a volume of the fluid in the second chamber 624 expands. In such examples, as the first and second pistons 616, 618 move leftward in FIG. 6A, fluid is expelled from the first chamber 622 to the second pipe 104 via the first port 650 and the third fluid passageway 646. Additionally, bleed gas from the gas source is drawn and/or pulled into the fourth chamber 628 via the fourth fluid passageway 648 and the second port 652.

In some examples, the first and second pistons 616, 618 move leftward in FIG. 6A until reaching a first piston position (e.g., a leftmost position) in which the first piston 616 contacts the second flanged portion 608, the second piston 618 contacts one(s) of the plugs 638, 640, and/or a first pressure in the first chamber 622 corresponds to a second pressure in the second chamber 624. In some such examples, when the first and second pistons 616, 618 reach the first piston position, the plugs 638, 640 move to a second position (e.g., a leftward position) within the respective fluid passageways 634, 636. In some examples, the plugs 638, 640 are moved and/or actuated based on a signal (e.g., a pneumatic signal). In some examples, the sensor 116 of FIG. 1 is operatively coupled to the plugs 638, 640, and the sensor 116 can switch the plugs 638, 640 between the first and second positions by providing, halting, and/or adjusting the control signal 118 to the plugs 638, 640. In some examples, the second piston 618 contacts the plugs 638, 640 to push the plug 638, 640 leftward to the second position. When in the second position, the first plug 638 engages with the first flanged portion 606 to enable fluid flow from the inlet port 630 to the second chamber 626 and restrict fluid flow from the inlet port 630 to the first chamber 624. Conversely, the second plug 640 in the second position engages with the first flanged portion 606 to enable fluid flow from the first chamber 624 to the outlet port 632 and restrict fluid flow from the second chamber 626 to the outlet port 632.

When the first and second plugs 638, 640 are in the second position, fluid from the first pipe 102 flows to the third chamber 626 to increase a pressure in the third chamber 626. As a result of the buildup of pressure in the third chamber 626, the first and second pistons 616, 618 move rightward in FIG. 6A toward the second end 614 of the compressor 600. In some examples, as the first and second pistons 616, 618 move rightward in FIG. 6A, fluid from the second chamber 624 is expelled via the second fluid passageway 636 and the outlet port 632 to the second pipe 104, and the bleed gas previously pulled into the fourth chamber 628 is expelled from the fourth chamber 628 to the second pipe 104 via the second port 652 and the fourth fluid passageway 648. Additional bleed gas from the gas source is drawn and/or pulled into the first chamber 622 via the third fluid passageway 646 and the first port 650. In some examples, the first and second pistons 616, 618 move rightward in FIG. 6A until reaching a second piston position (e.g., a rightmost position) in which the first piston 616 contacts one(s) of the plugs 638, 640, the second piston 618 contacts the third flanged portion 612, and/or a third pressure in the third chamber 626 corresponds to a fourth pressure in the fourth chamber 628.

In some examples, the plugs 638, 640 return to the first position when the first and second pistons 618, 618 reach the second piston position. As a result, the above process is repeated to drive reciprocal motion of the pistons 616, 618 within the respective cylinders 602, 604. In such examples, the reciprocal motion of the pistons 616, 618 causes bleed gas to be pulled from the gas source 106 to the first and fourth chambers 622, 628, and further causes the pulled bleed gas to be expelled from the first and fourth chambers 622, 628 and provided to the second pipe 104. Accordingly, the compressor 600 of FIG. 6A enables recovery of bleed gas from the gas source, which reduces an amount of bleed gas released and/or vented to the atmosphere.

FIG. 6B is a perspective view of a second example compressor 660 that may be implemented in examples disclosed herein. In the illustrated example of FIG. 6B, the second compressor 660 includes first and second example cylinders 662A, 662B coupled to a first example flanged section 664A positioned therebetween. Further, the first and second cylinders 662A, 662B are coupled to second and third example flanged sections 664B, 664C at respective ends of the second compressor 660. In the illustrated example of FIG. 6B, example cover plates 666A, 666B are coupled (e.g., bolted) to respective surfaces of the first flanged section 664A. Further, the second compressor 660 includes first and second openings 668A, 668B extending through the first cover plate 666A and/or the first flanged section 664A, and third and fourth example openings 668C, 668D positioned in respective ones of the second and third flanged sections 664B, 664C.

FIG. 6C illustrates the second example compressor 660 of FIG. 6B with the cover plates 666A, 666B removed. In the illustrated example of FIG. 6C, the first and second openings 668A, 668B extend into the first flanged section 664A. In some examples, the first flanged section 664 receives drive fluid (e.g., high-pressure fluid) from a first location (e.g., the first pipe 102 of FIG. 1) via the first opening 668A, and the drive fluid is expelled from the first flanged section 664 to a second location (e.g., the second pipe 104 of FIG. 1) via the second opening 668B. In the illustrated example of FIG. 6C, an example rod 670 is positioned in and movable within the first flanged section 664. In some examples, based on a position of the rod 670, the rod 670 can direct the flow of drive fluid between the first and second cylinders 662A, 662B.

FIG. 6D is a cross-sectional view of the second example compressor 660 of FIGS. 6A and/or 6B taken along line A-A of FIG. 6C. In the illustrated example of FIG. 6D, the second compressor 660 includes a first example piston 672A positioned in and/or slidable within the first cylinder 662A, and a second example piston 672B positioned in and/or slidable within the second cylinder 662B. In this example, the first and second pistons 672A, 672B are operatively coupled via an example shaft 674 extending through the first flanged section 664A, such that the first and second pistons 672A, 672B move together in the respective first and second cylinders 662A, 662B. In this example, a first example chamber 676A is defined in the first cylinder 662A between the first flanged section 664A and the first piston 672A, and a second example chamber 676B is defined between the second flanged section 664B and the first piston 672A. Further, a third example chamber 676C is defined in the second cylinder 662B between the first flanged section 664A and the second piston 672B, and a fourth example chamber 676D is defined in the second cylinder 662B between the third flanged section 664C and the second piston 672B. In some examples, the second flanged section 664B includes a first inlet port 678A, and the third flanged section 664C includes a second inlet port 678B, where the first and second inlet ports 678A, 678B are fluidly coupled to the gas source 106 of FIG. 1 to receive bleed gas therefrom.

In the illustrated example of FIG. 6D, the pressure differential between the first pipe 102 and the second pipe 104 can be used to drive operation of the second compressor 660. For example, when the rod 670 is in a first rod position, the rod 670 enables drive fluid from the first pipe 102 to enter the first flanged section 664A (e.g., via the first opening 668A of FIGS. 6B and/or 6C) and flow to the first chamber 676A. In such examples, the drive fluid applies pressure on the first piston 672A and causes the first piston 672A to slide toward the second flanged section 664B. In some examples, the first piston 672A compresses fluid (e.g., bleed gas) in the second chamber 676B and expels the compressed fluid from the second chamber 676B via the third opening 668C of the second flanged section 664B. Further, when the first piston 672A moves toward the second flanged section 664B, the second piston 672B moves toward the first flanged section 664A and causes drive fluid to be expelled from the third chamber 676C to the second pipe 104 via the second opening 668B of FIG. 6C. In such examples, the movement of the second piston 672B toward the first flanged section 664A draws additional bleed gas into the fourth chamber 676D via the second inlet port 678B.

Conversely, when the rod 670 is in a second rod position, the rod 670 enables drive fluid from the first pipe 102 to flow to the third chamber 676C. In such examples, the drive fluid applies pressure on the second piston 672B and causes the second piston 672B to slide toward the third flanged section 664C. In some examples, the second piston 672B compresses fluid (e.g., bleed gas) in the fourth chamber 676D and expels the compressed fluid from the fourth chamber 676D via the fourth opening 668D of the third flanged section 664C. Further, when the second piston 672B moves toward the third flanged section 664C, the first piston 672A moves toward the first flanged section 664A and causes drive fluid to be expelled from the first chamber 676A to the second pipe 104 via the second opening 668B of FIG. 6C. In such examples, the movement of the first piston 672A toward the first flanged section 664A draws additional bleed gas into the second chamber 676B via the first inlet port 678A.

In some examples, the rod 670 can move between the first and second rod positions to alternate the flow of drive fluid between the first and third chambers 676A, 676C, thus driving reciprocal motion of the first and second pistons 672A, 672B within the respective first and second cylinders 662A, 662B. As a result, the second compressor 660 draws bleed gas from the gas source 106, compresses the bleed gas, and/or provides the compressed bleed gas to the second pipe 104, thus reducing an amount of bleed gas to be vented to the atmosphere.

FIG. 6E is a top view of the second example compressor 660 of FIG. 6D. In the illustrated example of FIG. 6E, the rod 670 is in the second rod position in which the rod 670 contacts a first inner surface 679A of the first flanged section 664A. In some examples, when the rod 670 is in the second rod position of FIG. 6E, drive gas is provided to the third chamber 676C via a second example fluid passageway 680B in the first flanged section 664A, and drive gas is expelled from the first chamber 676A via a first example fluid passageway 680A. Conversely, the rod 670 is in the first rod position when the rod 670 contacts a second inner surface 679B of the first flanged section 664A. In some examples, when the rod 670 is in the first rod position, drive gas is provided to the first chamber 676A via the first fluid passageway 680A, and drive gas is expelled from the third chamber 676C via the second fluid passageway 680B. In some examples, the rod 670 remains in the second rod position of FIG. 6E until the first piston 672A of FIG. 6D contacts an example pin 682 positioned in the first flanged section 664A.

FIG. 6F is a cross-sectional view of the second example compressor 660 of FIGS. 6B, 6C, 6D, and/or 6E taken along line B-B of FIG. 6C. In the illustrated example of FIG. 6F, the pin 682 is shown in a first pin position in which the pin 682 protrudes from a first example surface 684A of the first flanged section 664A and is substantially flush with a second example surface of the first flanged section 664A. In some examples, when the pin 682 is in the first pin position of FIG. 6F, the pin 682 enables drive gas to be routed to the rod 670 of FIG. 6E such that the rod 670 moves to and/or is held in the second rod position of FIG. 6E. In some examples, when the first piston 672A of FIG. 6D contacts the pin 682, the first piston 672A pushes the pin 682 to a second pin position in which the pin 682 protrudes from the second surface 684B and is substantially flush with the first surface 684A. In some examples, when the pin 682 is in the second pin position, the pin 682 enables drive gas to be routed to the rod 670 such that the rod 670 moves to the first rod position. In some examples, the pin 682 enables the rod 670 to move between the first and second rod positions and, thus, cause reciprocal motion of the first and second pistons 672A, 672B without the use of pneumatic and/or electrical control signals.

FIG. 6G is a cross-sectional view of the second example compressor 660 of FIGS. 6B, 6C, 6D, 6E, and/or 6F taken along line C-C of FIG. 6C. In the illustrated example of FIG. 6G, the rod 670 is positioned in the first flanged section 664A along a transverse direction 686A of the second compressor 660, and the pin 682 is positioned in the first flanged section 664 along a longitudinal direction 686B of the second compressor 660. As such, the pin 682 is substantially perpendicular to the rod 670 in this example. In the example of FIG. 6G, the first flanged section 664A further includes first and second example fluid outlets 688A, 688B and an example fluid inlet 689. In some examples, the first and second fluid outlets 688A, 688B are fluidly coupled to the second opening 668B of FIGS. 6B and/or 6C to expel fluid thereto, and the fluid inlet 689 is fluidly coupled to the first opening 668A of FIGS. 6B and/or 6C to receive fluid therefrom. In this example, the first flanged section 664A further includes an example channel 690 in an example surface 691 of the first flanged section 664A. In some examples, the channel 690 enables exhaust fluid from both the first and second example fluid outlets 688A, 688B to flow to the second opening 668B and, thus, to the second pipe 104.

FIG. 6H is a front view of the second example compressor 660 of FIG. 6G. In the illustrated example of FIG. 6C, the rod 670 is in the second rod position in which the rod 670 contacts the first inner surface 679A of the first flanged section 664A. In this example, when the rod 670 is in the second rod position, the fluid inlet 689 fluidly couples the first opening 668A to the second fluid passageway 680B and, thus, to the third example chamber 676C of FIGS. 6D and/or 6E. Further, when the rod 670 is in the second rod position, the first fluid outlet 688A fluidly couples the first fluid passageway 680A and, thus, the first chamber 676A of FIGS. 6D and/or 6E to the second opening 668B. As a result, drive fluid can be provided to the third chamber 676C and/or can be expelled from the first chamber 676A when the rod 670 is in the second rod position.

In some examples, the rod 670 moves to the first rod position in which the rod 670 contacts the second inner surface 679B of the first flanged section 664A. In such examples, when the rod 670 is in the first rod position, the fluid inlet 689 fluidly couples the first opening 668A to the first fluid passageway 680A and, thus, to the first example chamber 676A of FIGS. 6D and/or 6E. Further, when the rod 670 is in the first rod position, the second fluid outlet 688B and the channel 690 fluidly couple the second fluid passageway 680A and, thus, the third chamber 676C of FIGS. 6D and/or 6E to the second opening 668B. As a result, drive fluid can be provided to the first chamber 676A and/or can be expelled from the third chamber 676C when the rod 670 is in the first rod position.

FIG. 7 illustrates a fourth example drive system 700 that can be used to implement the example gas recovery system 100 of FIG. 1. In the illustrated example of FIG. 7, the fourth drive system 700 includes an example fluid constrictor (e.g., a Venturi) 702 implemented along the first pipe 102. For example, the Fluid constrictor 702 includes an example pipe section 704 coupled between example nozzles 706, 708, where a diameter of the pipe section 704 is less than a diameter of the first pipe 102. In the example of FIG. 7, as fluid flows through the pipe section 704, the reduction in diameter from the first pipe 102 to the pipe section 704 causes the fluid to reduce in pressure and/or increase in velocity. As a result, the fluid in the pipe section 704 is at a first pressure (e.g., 1300 psi, 1350 psi, 1400 psi, etc.) less than a second pressure (e.g., 1450 psi, 1500 psi, 1550 psi, etc.) in the first pipe 102. In some examples, the pressure differential between the first pipe 102 and the pipe section 704 can be used to drive reciprocal motion of an example piston 710 positioned in and/or slidable within an example cylinder 712. In this example, the cylinder 712 is implemented along an example bleed line 714 fluidly coupled between the gas source 106 and the first pipe 102.

In the illustrated example of FIG. 7, the fourth drive system 700 includes an example diaphragm actuator (e.g., a double-acting diaphragm actuator) 716 operatively coupled to the piston 710. In particular, the diaphragm actuator 716 includes an example diaphragm 718 defining first and second example chambers 720, 722 in the diaphragm actuator 716. In this example, the diaphragm 718 is operatively coupled to the piston 710 via an example rod 724, such that deflection of the diaphragm 718 results in corresponding movement of the piston 710 in the cylinder 712. A first example fluid line 726 fluidly couples the pipe section 704 to the first chamber 720 of the diaphragm actuator 716, and a second example fluid line 728 fluidly couples the first chamber 720 to the first pipe 102. Additionally, a third example fluid line 730 fluidly couples the second chamber 722 of the diaphragm actuator 716 to the first pipe 104. In this example, an example valve (e.g., a flow valve) 732 is implemented along the first fluid line 726 to control the flow of fluid between the pipe section 704 and the diaphragm actuator 716. For example, the valve 732 can move between an open position in which the valve 732 enables fluid flow between the pipe section 704 and the diaphragm actuator 716 and a closed position in which the valve 732 restricts fluid flow between the pipe section 704 and the diaphragm actuator 716. In some examples, the sensor 116 of FIG. 1 is operatively coupled to the valve 732, and the sensor 116 can switch the valve 732 between the open and closed positions by providing, halting, and/or adjusting the control signal 118 to the valve 732. In the example of FIG. 7, the bleed line 714 is fluidly coupled to the first pipe 102 on a first side (e.g., a downstream side) of the fluid constrictor 702 and the diaphragm actuator 716 is fluidly coupled to the first pipe 102 on a second side (e.g., an upstream side) of the fluid constrictor 702 opposite the first side.

In some examples, the diaphragm 718 can deflect (e.g., from a starting position of the diaphragm 718 shown in FIG. 7) based on a pressure differential between the first and second chambers 720, 722. For example, the diaphragm 718 deflects in a first direction 734 (e.g., toward the cylinder 712, upward in FIG. 7) when a first pressure in the first chamber 720 is greater than a second pressure in the second chamber 722. Conversely, the diaphragm 718 deflects in a second direction 736 (e.g., away from the cylinder 712, downward in FIG. 7) when the first pressure in the first chamber 720 is less than the second pressure in the second chamber 722. In the illustrated example of FIG. 7, repeatedly opening and closing the valve 732 can be used to vary a pressure in the first chamber 720 of the diaphragm actuator 716, thus causing the diaphragm 718 to deflect in the first and second directions 734, 736 in an alternating manner.

In the illustrated example of FIG. 7, the deflection of the diaphragm 718 in the first and second directions 734, 736 results in corresponding motion (e.g., reciprocal motion) of the piston 710 within the cylinder 712. In some examples, the reciprocal motion of the piston 710 is used to drive recovery of bleed gas from the gas source 106. For example, bleed gas from the gas source 106 is drawn (e.g., pulled) into the cylinder 712 when the piston 710 moves in the second direction 736, and the bleed gas is expelled (e.g., pushed) from the cylinder 712 into the first pipe 102 via the bleed line 714 when the piston 710 moves in the first direction 734. In this example, check valves 738, 740 are implemented along the bleed line 714 to restrict backflow from the first pipe 102 to the cylinder 712 and/or from the cylinder 712 to the gas source 106.

FIG. 8 illustrates a fifth example drive system 800 that can be used to implement the example gas recovery system 100 of FIG. 1. In the illustrated example of FIG. 8, the fifth drive system 800 includes a first example fluid constrictor (e.g., a first Venturi) 802, a second example fluid constrictor (e.g., a second Venturi) 804, and a third example fluid constrictor (e.g., a third Venturi) 806 fluidly and/or operatively coupled between the first pipe 102 and the gas source 106, where the fluid constrictors 802, 804, 806 can be used to draw bleed gas from the gas source 106 and provide the bleed gas to the first pipe 102.

In the illustrated example of FIG. 8, the first fluid constrictor 802 is implemented along the first pipe 102, and includes a first example pipe section 808 coupled between first example nozzles 810, 812. In particular, the first nozzles 810, 812 are tapered from the first pipe 102 to the first pipe section 808, such that a first diameter of the first pipe section 808 is less than a second diameter (e.g., between 16 inches and 48 inches, less than 16 inches, etc.) of the first pipe 102. In the example of FIG. 8, as fluid (e.g., gas) flows from the first pipe 102 into and through the first pipe section 808 (e.g., in an example direction 814 of FIG. 8), the reduction in diameter from the first pipe 102 to the first pipe section 808 causes the fluid to reduce in pressure and increase in velocity in the first pipe section 808. As a result, the fluid in the first pipe section 808 is at a first pressure (e.g., 1300 psi, 1350 psi, 1400 psi, etc.) less than a second pressure (e.g., 1450 psi, 1500 psi, 1550 psi, etc.) of the first pipe 102.

In the illustrated example of FIG. 8, a first example tap line (e.g., a first bypass line) 816 is fluidly coupled between the first pipe section 808 and a first location 817 of the first pipe 102, where the first location 817 is upstream relative to the first fluid constrictor 802. In this example, the first tap line 816 has a third example diameter less than the first diameter of the first pipe section 808 and/or less than the second diameter of the first pipe 102. In this example, the second fluid constrictor 804 is implemented along the first tap line 816, and includes a second example pipe section 818 coupled between second example nozzles 820, 822. In this example, the second nozzles 820, 822 are tapered from the first tap line 816 to the second pipe section 818, such that a fourth diameter of the second pipe section 818 is less than the third diameter of the first tap line 816.

In the illustrated example of FIG. 8, a second example tap line (e.g., a second bypass line) 824 is fluidly coupled between the second pipe section 818 and a second location 825 of the first tap line 816, where the second location 825 is upstream relative to the second fluid constrictor 804. In this example, the second tap line 824 has a fifth example diameter less than the fourth diameter of the second pipe section 818 and/or less than the third diameter of the first tap line 816. In this example, the third fluid constrictor 806 is implemented along the second tap line 824, and includes a third example pipe section 826 coupled between third example nozzles 828, 830. In this example, the third nozzles 828, 830 are tapered from the second tap line 824 to the third pipe section 826, such that a sixth diameter of the third pipe section 826 is less than the fifth diameter of the second tap line 824. In the illustrated example of FIG. 8, the gas source 106 is fluidly coupled to the third pipe section 826 via the example bleed line 114. In this example, a seventh diameter of the bleed line 114 is less than or equal to the sixth diameter of the third pipe section 826.

In operation, flow of gas through the first pipe 102 results in suction of bleed gas from the gas source 106 and into the first pipe 102. For example, a first flow of gas through the first pipe 102 and/or the first fluid constrictor 802 (e.g., in the direction 814) produces a first pressure differential between the first pipe section 808 and the first location 817 of the first pipe 102. In turn, the first differential pressure produces a second flow of gas (e.g., causes suction of the gas) from the first location 817 to the first pipe section 808 through the first tap line 816 and the second fluid constrictor 804. In such examples, the second flow through the first tap line 816 and/or the second fluid constrictor 804 is at a reduced pressure and/or reduced flow rate compared to the first flow through the first pipe 102 and/or the first fluid constrictor 802. Further, the flow of gas through the first tap line 816 and/or the second fluid constrictor 804 produces a second pressure differential between the second pipe section 818 of the second fluid constrictor 804 and the second location 825 of the first tap line 816. In turn, the second differential pressure produces a third flow of gas (e.g., causes suction of the gas) from the second location 825 to the second pipe section 818 through the second tap line 824 and/or the third fluid constrictor 806. In such examples, the third flow through the second tap line 816 and/or the third fluid constrictor 806 is at a reduced pressure and/or reduced flow rate compared to the first flow through the first pipe 102 and/or the second flow through the first tap line 816.

In the illustrated example of FIG. 8, the third flow of gas through the second tap line 816 and the third fluid constrictor produces a negative pressure differential between the third pipe section 826 of the third fluid constrictor 806 and the gas source 106. In some examples, the negative pressure differential is between 0.5 psi and 1 psi less than an output pressure from the gas source 106. In some examples, the negative pressure differential can be different (e.g., greater than 1 psi, less than 0.5 psi, etc.). In some examples, the negative pressure differential causes suction of bleed gas from the gas source 106 and into the third pipe section 826. The bleed gas can further flow into the second pipe section 818 via the second tap line 824, and into the first pipe section 808 via the first tap line 816. As such, the bleed gas can be provided and/or returned to the first pipe 102 instead of vented and/or released to the atmosphere.

In the illustrated example of FIG. 8, the first tap line 816 and the second fluid constrictor 804 correspond to a first example differential pressure circuit, and the second tap line 824 and the third fluid constrictor 806 correspond to a second example differential pressure circuit. Stated differently, three fluid constrictors (e.g., the first, second, and third fluid constrictors 802, 804, 806) are plumbed in parallel in this example. In some examples, a different number (e.g., 1, 2, 4 or more, etc.) of the fluid constrictors may be used instead. For example, the fifth drive system 800 of FIG. 8 can include a different number of the differential pressure circuits coupled between the gas source 106 and the first pipe 102. For example, one or more additional differential pressure circuits can be coupled between the gas source 106 and the first pipe 102 to adjust a pressure differential therebetween. In some examples, the first differential pressure circuit (e.g., the first tap line 816 and the second fluid constrictor 804) and/or the second differential pressure circuit (e.g., the second tap line 824 and the third fluid constrictor 806) may be omitted, such that the bleed line 114 is coupled (e.g., directly coupled) to the second fluid constrictor 804 and/or the first fluid constrictor 802.

FIG. 9 illustrates a sixth example drive system 900 that can be used to implement the example gas recovery system 100 of FIG. 1. In the illustrated example of FIG. 9, the sixth drive system 900 includes an example fluid constrictor (e.g., a Venturi) 902 implemented along the first pipe 102. In this example, the fluid constrictor 902 includes an example pipe section 904 coupled between example nozzles 906, 908. In particular, the nozzles 906, 908 are tapered from the first pipe 102 to the pipe section 904, such that a first diameter of the pipe section 904 is less than a second diameter of the first pipe 102. In the example of FIG. 9, as fluid (e.g., gas) flows from the first pipe 102 into and through the pipe section 904 (e.g., in an example direction 910 of FIG. 9), the reduction in diameter from the first pipe 102 to the pipe section 904 causes the fluid to reduce in pressure and increase in velocity in the pipe section 904. As a result, the fluid in the pipe section 904 is at a first pressure (e.g., 1300 psi, 1350 psi, 1400 psi, etc.) less than a second pressure (e.g., 1450 psi, 1500 psi, 1550 psi, etc.) of the first pipe 102.

In the illustrated example of FIG. 9, an example tap line (e.g., a bypass line) 912 is fluidly coupled between the pipe section 904 and a first location 914 of the first pipe 102, where the first location 914 is upstream relative to the fluid constrictor 902. Further, the example bleed line 114 is fluidly coupled between the gas source 106 and the first pipe 102, where the bleed line 114 is coupled to a location of the first pipe 102 between the fluid constrictor 902 and the first location 914. In the example of FIG. 9, and example turbine 916 is operatively coupled between the tap line 912 and the bleed line 114. In particular, the turbine 916 includes first example turbine blades 918 positioned in the tap line 912, second example turbine blades 920 positioned in the bleed line 114, and an example shaft 922 operatively coupled between the first and second turbine blades 918, 920. In some examples, the shaft 922 translates rotational motion between the first and second turbine blades 918, 920, such that the first and second turbine blades 918, 920 rotate together.

In operation, flow of gas through the first pipe 102 results in suction of bleed gas from the gas source 106 and into the first pipe 102. For example, a first flow of gas through the first pipe 102 and/or the fluid constrictor 902 (e.g., in the direction 910) produces a first pressure differential between the pipe section 904 and the first location 914 of the first pipe 102. In turn, the first differential pressure produces a second flow of gas (e.g., causes suction of the gas) from the first location 914 to the pipe section 904 through the tap line 912. In some examples, the second flow of gas through the tap line 912 drives rotation of the first turbine blades 918. The rotation of the first turbine blades 918 drives corresponding rotation of the second turbine blades 920 in the bleed line 114. In such examples, the second turbine blades 920 draw and compress bleed gas from the gas source 106, and provide the compressed bleed gas into the pipe section 904 to mix with the gas therein. In some examples, the second turbine blades 920 compress the bleed gas to a third example pressure (e.g., 1500 psi or above) greater than the first pressure in the pipe section 904 and/or the second pressure in the first pipe 102.

FIG. 10 illustrates a seventh example drive system 1000 that can be used to implement the example gas recovery system 100 of FIG. 1. In the illustrated example of FIG. 10, the seventh drive system 1000 includes an example pump (e.g., a pump) 1002 and an example turbine 1004, where the turbine 1004 is mounted on an example column 1006 and positioned in a flow path of an example pipe 1008. In some examples, the pipe 1008 corresponds to one of the first pipe 102 or the second pipe 104 of FIG. 1. In some examples, a pressure in the pipe 1008 is less than an example threshold (e.g., 55 psi, 50 psi, etc.).

In the illustrated example of FIG. 10, gas flow through the pipe 1008 drives rotation of example turbine blades 1010 of the turbine 1004 about an example axis (e.g., a rotational axis) 1012. In some examples, the turbine 1004 is positioned between a first location of the pipe 1008 and a second location of the pipe 1008, where a pressure differential between the first and second locations results in and/or produces the gas flow through the pipe 1008. In some examples, the turbine 1004 is operatively coupled to the pump 1002 such that rotation of the turbine blades 1010 drives operation of the pump 1002. In particular, the pump 1002 operates to draw bleed gas from the gas source 106 and provide the bleed gas to the pipe 1008. In this example, the pump 1002 is fluidly coupled to the gas source 106 via an example bleed line 1014, where the bleed gas can flow from the gas source 106 to the pump 1002 via the bleed line 1014. Further, the bleed gas flows from the pump 1002 to the pipe 1008 via an example column outlet (e.g., an outlet port) 1016 defined in the column 1006. In some examples, by providing and/or returning the bleed gas to the pipe 1008, the seventh drive system 1000 of FIG. 10 can reduce an amount of bleed gas vented and/or otherwise released to the atmosphere.

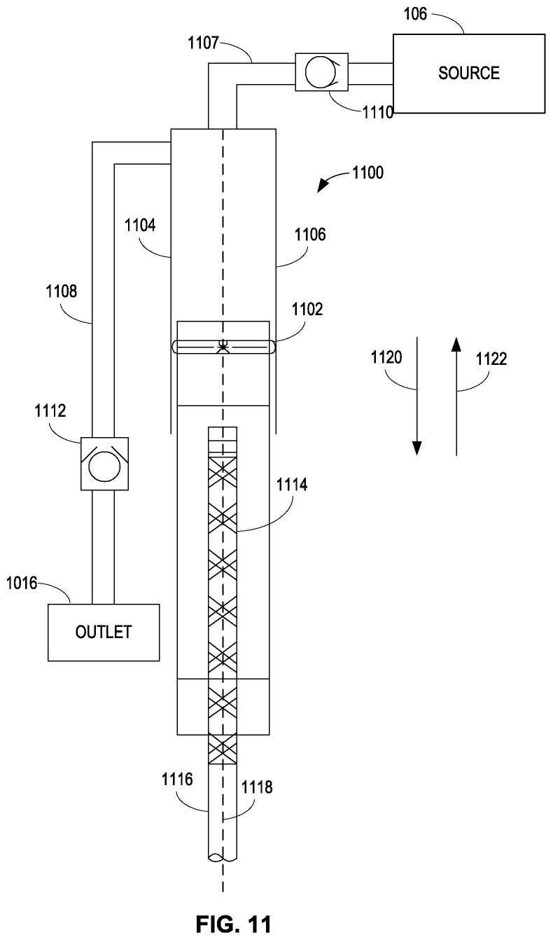

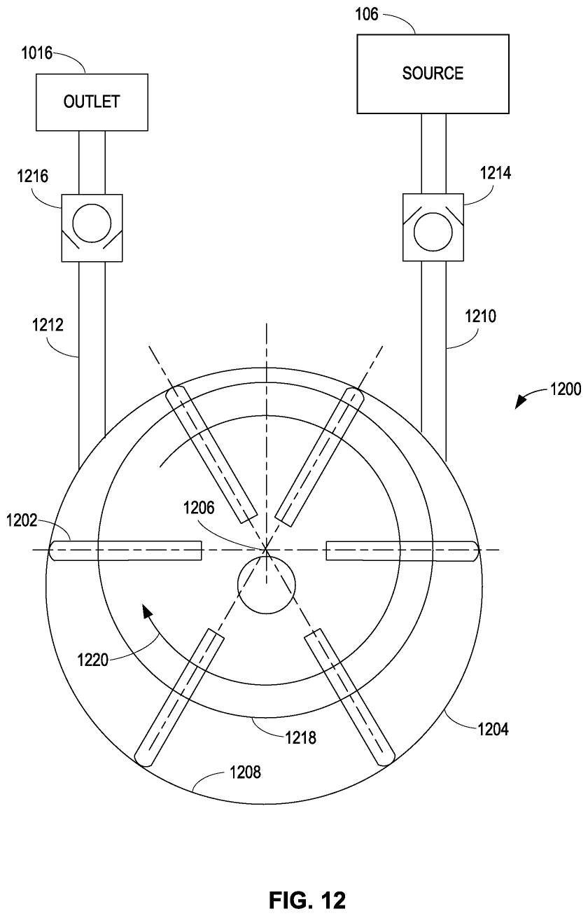

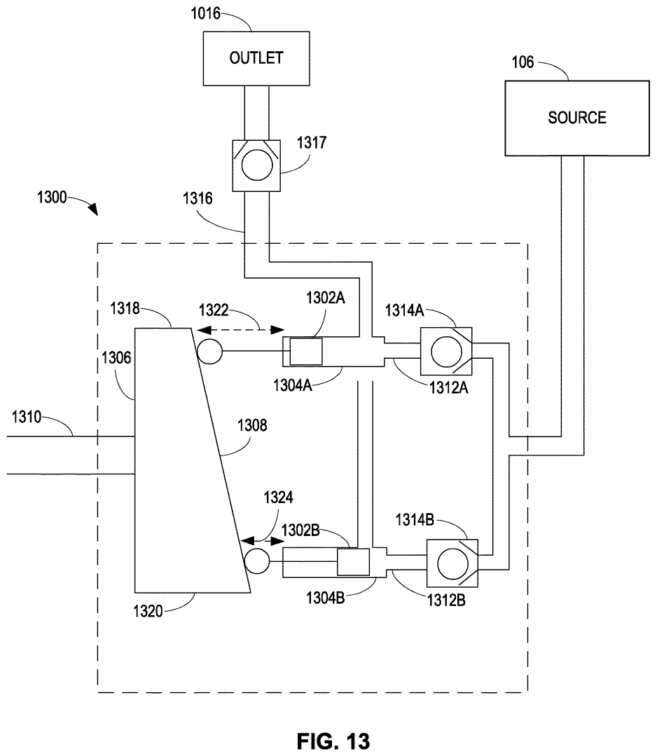

In some examples, one or more different devices and/or configurations can be used to implement the functionality of the example pump 1002 of FIG. 10. For example, the pump 1002 may be implemented using an example screw-driven pump (e.g., as described in connection with FIG. 11 below), and example vane pump (e.g., as described in connection with FIG. 12 below), an example swash plate pump (e.g., as described in connection with FIG. 13 below), and/or any other suitable device(s).

FIG. 11 illustrates an example screw-driven pump 1100 that can be used to implement the example pump 1002 of FIG. 10. In the illustrated example of FIG. 11, the screw-driven pump 1100 includes an example piston 1102 positioned in and/or movable within an example cylinder 1104. In this example, an example chamber 1106 is defined in the cylinder 1104. The chamber 1106 is fluidly coupled to the example gas source 106 of FIGS. 1 and/or 2 via an example inlet line 1107 (e.g., corresponding to the example bleed line 1014 of FIG. 10), and is further fluidly coupled to the example column outlet 1016 of FIG. 10 via an example outlet line 1108. In this example, example check valves 1110, 1112 are implemented along the inlet line 1107 and the outlet line 1108 to restrict fluid flow (e.g., backflow) from the chamber 1106 to the gas source 106 and/or from the column outlet 1016 to the chamber 1106.

In the illustrated example of FIG. 11, the screw-driven pump 1100 further includes an example self-reversing screw (e.g., a self-reversing lead screw) 1114 operatively coupled to the piston 1102. Further, the self-reversing screw 1114 is coupled to an example shaft 1116 of the example turbine 1004 of FIG. 10. In some examples, rotation of the turbine blades 1010 about the example axis 1012 of FIG. 10 is translated (e.g., via one or more example gears) to the shaft 1116 to drive rotation of the shaft 1116 about a second example axis (e.g., a second rotational axis) 1118. Further, rotation of the shaft 1116 drives corresponding rotation of the self-reversing screw 1114 about the second axis 1118, resulting in translation (e.g., linear translation) of the self-reversing screw 1114 along the second axis 1118. In particular, the rotation of the self-reversing screw 1114 in a first rotational direction about the second axis 1118 results in reciprocal motion of the self-reversing screw 1114 in first and second example directions 1120, 1122 along the second axis 1118. In this example, the piston 1102 is operatively coupled to the self-reversing screw 1114 such that the piston 1102 moves (e.g., translates) with the self-reversing screw 1114 along the first and second directions 1120, 1122.

In operation, rotation of the turbine blades 1010 causes continuous rotation of the self-reversing screw 1114 in the first rotational direction about the second axis 1118. As a result, the self-reversing screw 1114 is translated in the first direction 1120 toward a first example position (e.g., a first linear position) along the second axis 1118. In this example, as the self-reversing screw 1114 moves in the first direction 1120, the piston 1102 moves with the self-reversing screw 1114 in the first direction 1120. In some examples, when the piston 1102 moves in the first direction 1120, bleed gas is drawn (e.g., suctioned) from the gas source 106 and into the chamber 1106 of the cylinder 1104.

In this example, after the self-reversing screw 1114 reaches a first position (e.g., a first linear position) along the second axis 1118, continued rotation of the self-reversing screw 1114 in the first rotational direction causes the screw to move (e.g., translate) in a reverse direction (e.g., the second direction 1122 of FIG. 11). In such examples, as the self-reversing screw 1114 moves in the second direction 1122, the piston 1102 moves with the self-reversing screw 1114 in the second direction 1122. In some examples, when the piston 1102 moves in the second direction 1122, the bleed gas is expelled from the chamber 1106 and flows into the outlet line 1108 towards the column outlet 1016 of FIG. 10. In some such examples, the expelled bleed gas exits the column outlet 1016 and mixes with the flow of gas in the pipe 1008 of FIG. 10. In some examples, by providing and/or returning the bleed gas to the pipe 1008, an amount of the bleed gas vented and/or otherwise released to the atmosphere can be reduced.

FIG. 12 illustrates an example vane pump 1200 that can be used to implement the example pump 1002 of FIG. 10. In the illustrated example of FIG. 12, the vane pump 1200 includes example vanes 1202 rotatable within an example pump housing 1204. In this example, the vanes 1202 are rotatable about an example rotational axis 1206, where the rotational axis 1206 in this example is offset from a geometric center of the pump housing 1204. In some examples, the vanes 1202 are spring-loaded and can extend away from and/or retract towards the rotational axis 1206, such that the vanes 1202 can maintain contact with an inner surface 1208 of the pump housing 1204 during rotation. In the example of FIG. 12, the pump housing 1204 is fluidly coupled to the example gas source 106 of FIGS. 1 and/or 2 via an example inlet line 1210, and is further fluidly coupled to the example column outlet 1016 of FIG. 10 via an example outlet line 1212. In this example, example check valves 1214, 1216 are implemented along the inlet line 1210 and the outlet line 1212 to restrict backflow from the pump housing 1204 to the gas source 106 and/or from the column outlet 1016 to the pump housing 1204.

In the illustrated example of FIG. 12, the vanes 1202 are operatively coupled to an example rotor 1218, and the rotor 1218 is further operatively coupled to the example turbine 1004 of FIG. 10. In this example, rotation of the turbine blades 1010 about the example rotational axis 1012 of FIG. 10 drives corresponding rotation of the rotor 1218 in an example clockwise direction (e.g., represented by arrow 1220) in FIG. 12. In such examples, the vanes 1202 rotate with the rotor 1218 in the clockwise direction 1220 about the rotational axis 1206. In some examples, rotation of the vanes 1202 draws bleed gas from the gas source 106 through the inlet line 1210 and into the pump housing 1204. Further, the rotating vanes 1202 can pressurize (e.g., compress) the bleed gas in the pump housing 1204, then eject and/or expel the bleed gas to the column outlet 1016 via the outlet line 1212. In some such examples, by pressurizing the bleed gas in the vane pump 1200, the bleed gas can be provided and/or returned to the pipe 1008 at a pressure substantially similar to a pressure of the fluid in the pipe 1008.

FIG. 13 illustrates an example swash plate pump 1300 that can be used to implement the example pump 1002 of FIG. 10. In the illustrated example of FIG. 13, the swash plate pump 1300 includes example pistons 1302 (e.g., a first example piston 1302A and a second example piston 1302B) movable and/or slidable within respective example cylinders 1304 (e.g., a first example cylinder 1304A and a second example cylinder 1304B). While the swash plate pump 1300 includes two of the pistons 1302A, 1302B and the corresponding two of the cylinders 1304A, 1304B, in this example, a different number (e.g., one, three or more, etc.) of the pistons and/or the corresponding cylinders may be used instead. In this example, the swash plate pump 1300 further includes an example swash plate 1306 operatively coupled to the pistons 1302. In particular, the pistons 1302 are operatively coupled to an example angled surface 1308 of the swash plate 1306 such that the pistons 1302 remain in contact with the angled surface 1308 while the swash plate 1306 rotates. In some examples, the swash plate 1306 is further operatively coupled to the example turbine 1004 of FIG. 10 via an example shaft 1310, such that the turbine 1004 can drive rotation of the swash plate 1306.

In the illustrated example of FIG. 13, the cylinders 1304A, 1304B are fluidly coupled to the gas source 106 of FIG. 1 via respective example inlet lines 1312A, 1312B. Further, example check valves 1314A, 1314B are implemented along respective ones of the inlet lines 1312A, 1312B to enable fluid flow from the gas source 106 to the cylinders 1304A, 1304B and restrict fluid flow (e.g., backflow) from the cylinders 1304A, 1304B to the gas source 106. In this example, the cylinders 1304A, 1304B are further fluidly coupled to the column outlet 1016 of FIG. 10 via an example outlet line 1316, and an example check valve 1317 is implemented along the outlet line 1316 to enable fluid flow from the cylinders 1304A, 1304B to the column outlet 1016 and restrict flow (e.g., backflow) from the column outlet 1016 to the cylinders 1304A, 1304B.

In operation, rotation of the turbine blades 1010 of FIG. 10 about the example rotational axis 1012 of FIG. 10 drives corresponding rotation of the shaft 1310 and, thus, the swash plate 1306 of FIG. 13. In such examples, the swash plate 1306 serves as a cam to drive reciprocal motion of the pistons 1302A, 1302B (e.g., cam followers) within the cylinders 1304A, 1304B. For example, as the swash plate 1306 rotates, distances between the angled surface 1308 of the swash plate 1306 and the cylinders 1304A, 1304B vary. For example, when the swash plate 1306 is in a first rotational position shown in FIG. 13, a first portion 1318 of the swash plate 1306 is proximate the first cylinder 1304A and a second portion 1320 of the swash plate 1306 is proximate the second cylinder 1304B, where the first portion 1318 has a first thickness less than a second thickness of the second portion 1320. In particular, when the swash plate 1306 is in the first rotational position, the first cylinder 1304A is at a first distance 1322 from the angled surface 1308 and the second cylinder 1304B is at a second distance 1324 from the angled surface 1308, where the first distance 1322 is greater than the second distance 1324. As a result, when the swash plate 1306 is in the first rotational position, the first piston 1302A moves to first piston position (e.g., a leftward position in FIG. 13) within the first cylinder 1304A, thus drawing fluid (e.g., bleed gas) from the gas source 106 into the first cylinder 1304A. Further, the second piston 1302 moves to a second piston position (e.g., a rightward position in FIG. 13) within the second cylinder 1304B, thus compressing and/or expelling fluid from the second cylinder 1304B to the column outlet 1016 via the outlet line 1316.

In some examples, the swash plate 1306 can rotate to a second rotational position in which the first portion 1318 of the swash plate 1306 is proximate the second cylinder 1304B and the second portion 1320 of the swash plate 1306 is proximate the first cylinder 1304A. In such examples, the angled surface 1308 pushes the first piston 1302A (e.g., rightward in FIG. 13) toward the second piston position within the first cylinder 1304A, thus causing the first piston 1302A to compress and/or expel the fluid from the first cylinder 1304A to the column outlet 1016. Conversely, when the swash plate 1306 rotates to the second rotational position, the angled surface 1308 pulls the second piston (e.g., leftward in FIG. 13) toward the first piston position within the second cylinder 1304B, thus causing fluid (e.g., bleed gas) to be drawn into the second cylinder 1304B from the gas source 106. In some examples, as the swash plate 1306 rotates (e.g., continuously rotates) between the first and second rotational positions, the resulting reciprocal motion of the pistons 1302A, 1302B within the corresponding cylinders 1304A, 1304B is used to provide and/or return bleed gas from the gas source 106 to the pipe 1008 of FIG. 10, which reduces an amount of the bleed gas vented and/or otherwise released to the atmosphere.

FIG. 14 illustrates an eighth example drive system 1400 that can be used to implement the example gas recovery system 100 of FIG. 1. In the illustrated example of FIG. 14, the eighth drive system 1400 includes multiple example compressor units (e.g., compressor pumps) 1402A, 1402B, 1402C implemented between the first pipe 102 of FIG. 1 and the example bleed line 114 of FIG. 1. In particular, the compressor units 1402A, 1402B, 1402C include example turbine blades 1404A, 1404B, 1404B positioned in the first pipe 102 and corresponding example compressor blades 1406A, 1406B, 1406C positioned in the bleed line 114. Further, the turbine blades 1404A, 1404B, 1404C are operatively coupled to respective ones of the compressor blades 1406A, 1406B, 1406C via example shafts (e.g., drive shafts) 1408A, 1408B, 1408C, such that rotation of the turbine blades 1404A, 1404B, 1404C drives corresponding rotation of the compressor blades 1406A, 1406B, 1406C.

In the illustrated example of FIG. 14, fluid flows through the first pipe 102 from a first end 1410 to a second end 1412 of the first pipe 102. In this example, the first pipe 102 includes multiple (e.g., two or more) example bends (e.g., bent portions) 1414 between corresponding ones of the compressor units 1402. In some examples, the first pipe 102 can include fewer bends (e.g., can be substantially straight) between ones of the compressor units 1402. In some examples, the fluid flow in the first pipe 102 drives rotation of the turbine blades 1404A, 1404B, 1404C. For example, the fluid flows from the first end 1410 to the first turbine blades 1404A to drive rotation of the first turbine blades 1404A. Further, the fluid flows from the first turbine blades 1404A to the second turbine blades 1404B to drive rotation of the second turbine blades 1404B, and the fluid further flows from the second turbine blades 1404B to the third turbine blades 1404C to drive rotation of the third turbine blades 1404C.

In some examples, a pressure of the fluid drops when the fluid passes across ones of the turbine blades 1404. For example, the fluid flows from the first end 1410 to the first turbine blades 1404A at a first example pressure (e.g., 1500 psi or above), and the pressure of the fluid drops across the first turbine blades 1404A to a second example pressure (e.g., less than the first pressure). Similarly, the pressure drops from the second pressure to a third example pressure (e.g., less than the first and second pressures) across the second turbine blades 1404B, the pressure further drops from the third pressure to a fourth example pressure (e.g., less than the first, second, and third pressures) across the third turbine blades 1404C. In some examples, the fluid flows from the third turbine blades 1404C to the second end 1412 of the first pipe 102 at the fourth pressure, where the fourth pressure is at or near a pressure (e.g., 55 psi or less) in the second pipe 104 of FIG. 1. In some such examples, the second end 1412 is fluidly coupled to the second pipe 104 of FIG. 1 to provide the fluid to the second pipe 104 at the fourth pressure.

In the illustrated example of FIG. 14, the rotation of the turbine blades 1404 drives corresponding rotation of the compressor blades 1406 in the bleed line 114, and the rotation of the compressor blades 1406 is used to draw and/or compress bleed gas from the gas source 106. For example, rotation of the first compressor blades 1406A draws bleed gas from the gas source 106 at a first bleed gas pressure (e.g., 0 psi, 1 psi, etc.). In such examples, the first compressor blades 1406A compress the bleed gas to a second bleed gas pressure (e.g., greater than the first bleed gas pressure) and pump the compressed bleed gas to the second compressor blades 1406B. Similarly, the second compressor blades 1406B further compress the bleed gas to a third bleed gas pressure (e.g., greater than the first and second bleed gas pressure), and the third compressor blades 1406C compress the bleed gas to a fourth bleed gas pressure (e.g., greater than the first, second, and third bleed gas pressures). As a result, the compressed bleed gas flows to a third end 1416 of the bleed line 114 at the fourth bleed gas pressure, where the fourth bleed gas pressure is at or near a pressure in the second pipe 104 of FIG. 1 (e.g., 55 psi or less). In some examples, the third end 1416 is fluidly coupled to the second pipe 104 of FIG. 1 to provide the bleed gas to the second pipe 104 at the fourth bleed gas pressure.

In the illustrated example of FIG. 14, three of the compressor units 1402 are implemented in series along the first pipe 102 and/or the bleed line 114. In some examples, a different number (e.g., one, two, four or more, etc.) of the compressor units 1402 can be used instead. In some examples, the number of the compressor units 1402 can be selected based on a pressure differential between the first and second pipe 104 and/or based on a pressure drop across each of the compressor units 1402. For example, the number of and/or sizes of the compressor units 1402 can be selected such that a pressure of the fluid at the second end 1412 of the first pipe 102 and/or a pressure of the bleed gas at the third end 1416 of the bleed line 114 corresponds to (e.g., is substantially the same as) a pressure of the fluid in the second pipe 104.

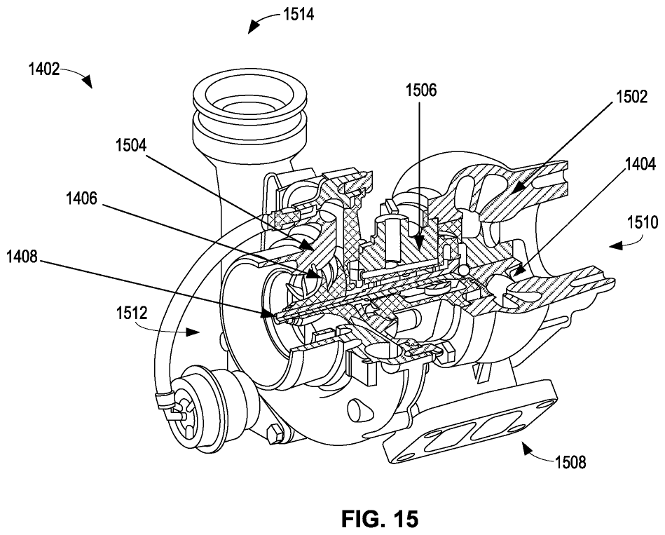

FIG. 15 is a perspective view of one of the example compressor units 1402 of FIG. 14. In the illustrated example of FIG. 15, the compressor unit 1402 includes the example turbine blades 1404 positioned in and/or rotatable within an example turbine housing 1502, and the example compressor blades 1406 positioned in and/or rotatable within an example compressor housing 1504. Further, the compressor unit 1402 includes the example shaft 1408 positioned in and/or rotatable within an example bearing housing 1506. In this example, the shaft 1408 operatively couples the turbine blades 1404 to the compressor blades 1406, such that the turbine blades 1404 and the compressor blades 1406 rotate together within the respective housings 1502, 1504.

In the illustrated example of FIG. 15, the turbine housing 1502 includes a first example inlet port (e.g., a drive fluid inlet port) 1508 and a first example outlet port (e.g., a drive fluid outlet port) 1510 fluidly coupled to the first pipe 102 of FIGS. 1 and/or 6. In some examples, the turbine housing 1502 receives fluid (e.g., drive fluid) from the first pipe 102 via the first inlet port 1508 at a first example pressure, and returns the fluid to the first pipe 102 via the first outlet port 1510 at a second example pressure (e.g., less than the first pressure). Further, the compressor housing 1504 includes a second example inlet port (e.g., a bleed gas inlet port) 1512 and a second example outlet port (e.g., a bleed gas outlet port) 1514 fluidly coupled to the bleed line 114 of FIGS. 1 and/or 6. In some examples, the compressor housing 1504 receives bleed gas from the bleed line 114 via the second inlet port 1512 at a third example pressure, and returns the bleed gas to the bleed line 114 via the second outlet port 1514 at a fourth example pressure (e.g., greater than the third pressure). While the compressor unit 1402 of FIG. 15 illustrates one of the example compressor units 1402 that can be implemented in the eighth example drive system 1400 FIG. 14, one or more different types of compressors (e.g., reciprocating compressors, rotary compressors, etc.) may be used for one or more of the compressor units 1402 of FIG. 14.

FIG. 16 illustrates a ninth example drive system (e.g., a second diaphragm-driven system) 1600 that can be used to implement the example gas recovery system 100 of FIG. 1. In the illustrated example of FIG. 16, the ninth drive system 1600 includes an example diaphragm actuator (e.g., a diaphragm pump) 1602 fluidly coupled between the first pipe 102 and the second pipe 104. In this example, the diaphragm actuator 1602 is a dual diaphragm pump including a first example diaphragm 1604 and a second example diaphragm 1606. In some examples, one of the first diaphragm 1604 or the second diaphragm 1606 may be omitted. In this example, a first example chamber 1608 is defined in the diaphragm actuator 1602 between the first and second diaphragms 1604, 1606. Further, a second example chamber 1610 is defined in the diaphragm actuator 1602 between the first diaphragm 1604 and a first end 1612 of the diaphragm actuator 1602, and a third example chamber 1614 is defined between the second diaphragm 1606 and a second end 1616 of the diaphragm actuator 1602. While the first, second, and third chambers 1608, 1610, 1614 are referred to as separate chambers in this example, the first, second, and third chambers 1608, 1610, 1614 may be referred to as respective portions of a single chamber of the diaphragm actuator 1602.

In the illustrated example of FIG. 16, the first chamber 1608 is sealed between the first and second diaphragms 1604, 1606. In particular, the first diaphragm 1604 prevents and/or restricts passage of fluid between the first and second chambers 1608, 1610, and the second diaphragm 1606 prevents and/or restricts passage of fluid between the first and third chambers 1608, 1614. In this example, the second chamber 1610 is fluidly coupled to the first pipe 102 via a first example inlet line 1618, and is fluidly coupled to the second pipe 104 via a first example outlet line 1620. Further, the third chamber 1614 is fluidly coupled to the gas source 106 via a second example inlet line 1622, and is fluidly coupled to the second pipe 104 via a second example outlet line 1624. In this example, example check valves 1626, 1628 are implemented along the respective second inlet and outlet lines 1622, 1624. In some examples, the check valves 1626, 1628 enable fluid flow from the gas source 106 to the third chamber 1614 and/or from the third chamber 1614 to the second pipe 104, and restrict fluid flow (e.g., backflow) from the second pipe 104 to the third chamber 1614 and/or from the third chamber 1614 to the gas source 106. In the illustrated example of FIG. 16, a first example valve 1630 is implemented along the first inlet line 1618, and a second example valve 1632 is implemented along the second inlet line 1622. Further, an example bleed valve 1634 is implemented along the first outlet line 1620.

In the illustrated example of FIG. 16, a first example spring 1636 is positioned in the first chamber 1608 and operatively coupled between the first diaphragm 1604 and an inner surface 1638 of the first chamber 1608. Further, a second example spring 1640 is positioned in the third chamber 1614 and operatively coupled between the second diaphragm 1606 and the second end 1616 of the diaphragm actuator 1602. In some examples, the first and second springs 1636, 1640 bias the respective first and second diaphragms 1604, 1606 to a starting position (e.g., an undeflected position) shown in FIG. 16. In some examples, in addition to or instead of the first and second springs 1636, 1640 of FIG. 16, one or more springs can be operatively coupled between the first diaphragm 1604 and the first end 1612 of the diaphragm actuator 1602, and/or between the second diaphragm 1606 and the inner surface 1638 of the diaphragm actuator 1602.

In some examples, deflection of the first and second diaphragms 1604, 1606 of the diaphragm actuator 1602 is used to drive evacuation and/or pumping of bleed gas from the gas source 106 and into the second pipe 104. For example, in operation, the first chamber is filled with first fluid at a first example pressure, and the first valve 1630 is opened to enable flow of second fluid (e.g., drive fluid) from the first pipe 102 into the second chamber 1610. In such examples, the second fluid is at a second pressure (e.g., between 900 psi and 1500 psi) greater than a first pressure of the first fluid in the first chamber 1608. In some examples, as a result of a pressure differential between the first and second chambers 1608, 1610, the first diaphragm 1604 deflects in a first example direction 1642 (e.g., rightward in FIG. 16), thus compressing the first spring 1636. In some examples, as the first diaphragm 1604 deflects in the first direction 1642, the fluid is the first chamber 1608 is displaced and/or compressed, resulting in deflection of the second diaphragm 1606 in the first direction 1642 and compression of the second spring 1640 by the second diaphragm 1606. In such examples, when the second diaphragm 1606 deflects in the first direction 1642, the second diaphragm 1606 expels fluid (e.g., bleed gas) from the third chamber 1614 to the second pipe 104 via the second outlet line 1624.

In some examples, when the first and second diaphragms 1604, 1606 reach a first deflected position (e.g., rightward in FIG. 16), the first valve 1630 is closed to restrict further fluid flow from the first pipe 102 to the second chamber 1610, and the second valve 1632 is opened to enable flow of bleed gas from the gas source 106 to the third chamber 1614. In some examples, fluid pressure from the second chamber 1610 is gradually released to the second pipe 104 via the bleed valve 1634. In some such examples, the bleed valve 1634 releases the fluid to the second pipe 104 at a pressure near a pressure of fluid in the second pipe 104. As the pressure in the second chamber 1610 decreases, the first and second springs 1636, 1640 push the respective first and second diaphragms 1604, 1606 in a second example direction 1644 (e.g., leftward in FIG. 16), such that the first and second diaphragms 1604, 1606 return to the starting (e.g., undeflected) position. In some examples, when the second diaphragm 1606 moves in the second direction 1644 to the starting position, additional bleed gas is drawn from the gas source 106 into the third chamber 1614 via the second inlet line 1622. In some examples, when the first and second diaphragms 1604, 1606 return to the starting position, the second valve 1632 can be closed, and the first valve 1630 can be re-opened to repeat the above process. In some examples, the sensor 116 of FIG. 1 is operatively coupled to the first valve 1630 and/or the second valve 1632, and the sensor 116 can switch the first valve 1630 and/or the second valve 1632 between the open and closed positions by providing, halting. and/or adjusting the control signal 118 to the first valve 1630 and/or the second valve 1632.

FIG. 17A illustrates a tenth example drive system (e.g., a third diaphragm-driven system) 1700 that can be used to implement the example gas recovery system 100 of FIG. 1. In the illustrated example of FIG. 17A, the tenth drive system 1700 includes multiple example diaphragm actuators 1702 (e.g., a first diaphragm actuator 1702A, a second diaphragm actuator 1702B, and a third diaphragm actuator 1702C) fluidly coupled between the first and second pipes 102, 104. In this example, the diaphragm actuators 1702A, 1702B, 1702C include respective example drive chambers 1704A, 1704B, 1704C and respective example compression chambers 1706A, 1706B, 1706C. Further, first example diaphragms 1708A, 1708B, 1708C are implemented in respective ones of the drive chambers 1704A, 1704B, 1704C between first example chamber portions 1710A, 1710B, 1710C and second example chamber portions 1712A, 1712B, 1712C of the respective drive chambers 1704A, 1704B, 1704C. Similarly, second example diaphragms 1714A, 1714B, 1714C are implemented in respective ones of the compression chambers 1706A, 1706B, 1706C between third example chamber portions 1716A, 1716B, 1716C and fourth example chamber portions 1718A, 1718B, 1718C of the respective compression chambers 1706A, 1706B, 1706C. In this example, the first diaphragms 1708A, 1708B, 1708C are operatively coupled to respective ones of the second diaphragms 1714A, 1714B, 1714C via respective example rods 1720A, 1720B, 1720C, such that movement and/or deflection of the first diaphragms 1708A, 1708B, 1708C drives corresponding movement and/or deflection of the second diaphragms 1714A, 1714B, 1714C.

In the illustrated example of FIG. 17A, the drive chambers 1704A, 1704B, 1704C are fluidly coupled to the first pipe 102 via respective example inlet lines 1722A, 1722B, 1722C, and are further fluidly coupled to the second pipe 104 via respective example outlet lines 1724A, 1724B, 1724C. In this example, the gas source 106 is fluidly coupled to the second pipe 104 via an example bleed line 1726, and the compression chambers 1706A, 1706B, 1706C are implemented in series along the bleed line 1726. While three of the diaphragm actuators 1702A, 1702B, 1702C are used in this example, a different number of the diaphragm actuators may be used instead.

In operation, high pressure fluid (e.g., fluid at a pressure between 900 psi and 1500 psi) flows from the first pipe 102 and into the compression chambers 1706A, 1706B, 1706C via the inlet lines 1722A, 1722B. 1722C. In some examples, the fluid is provided to alternating ones of the first chamber portions 1710A, 1710B, 1710C and the second chamber portions 1712A, 1712B, 1712C to drive reciprocal deflection of the first diaphragms 1708A, 1708B, 1708C. For example, when the fluid is provided to the first chamber portions 1710A, 1710B, 1710C, a pressure differential between the first and second chamber portions 1710A, 1710B, 1710C, 1712A, 1712B, 1712C causes the first diaphragms 1708A, 1708B, 1708C to deflect in a first direction 1728 (e.g., leftward in FIG. 17). In such examples, deflection of the first diaphragms 1708A, 1708B, 1708C in the first direction 1728 causes fluid to be expelled from the second chamber portions 1712A, 1712B, 1712C and into the second pipe 104 via the outlet lines 1724A, 1724B, 1724C. Conversely, when the fluid from the first pipe 102 is provided to the second chamber portions 1712A, 1712B, 1712C, the pressure differential between the first and second chamber portions 1710A, 1710B, 1710C, 1712A, 1712B, 1712C causes the first diaphragms 1708A, 1708B, 1708C to deflect in a second direction 1730 (e.g., rightward in FIG. 17). In such examples, deflection of the first diaphragms 1708A, 1708B, 1708C in the second direction 1730 causes fluid to be expelled from the first chamber portions 1710A, 1710B, 1710C and into the second pipe 104 via the outlet lines 1724A, 1724B, 1724C.

In some examples, reciprocal deflection of the first diaphragms 1708A, 1708B, 1708C drives corresponding reciprocal deflection of the second diaphragms 1714A, 1714B, 1714C in the compression chambers 1706A, 1706B, 1706C. In such examples, the reciprocal motion of the second diaphragms 1714A, 1714B, 1714C is used to compress and/or pump bleed gas from the gas source 106 to the second pipe 104. For example, when the second diaphragm 1714A of the first compression chamber 1706A deflects in the first direction 1728, the second diaphragm 1714A compresses and/or expels bleed gas from the fourth chamber portion 1718A of the first compression chamber 1706A, and draws additional bleed gas from the gas source 106 into the third chamber portion 1716A of the first compression chamber 1706A. Conversely, when the second diaphragm 1714A of the first compression chamber 1706A deflects in the second direction 1730, the second diaphragm 1714A compresses and/or expels bleed gas from the third chamber portion 1716A of the first compression chamber 1706A, and draws additional bleed gas from the gas source 106 into the fourth chamber portion 1718A of the first compression chamber 1706A. In some examples, the bleed gas from the gas source 106 is at a first example pressure (e.g., 0 psi, 1 psi, 1 atmosphere (atm) etc.), and the first compression chamber 1706A compresses the bleed gas to a second example pressure (e.g., 15 psi, 20 psi, 2 atm, etc.) greater than the first pressure.

Further, the compressed bleed gas expelled from the first compression chamber 1706A is provided to alternating ones of the third and fourth chamber portions 1716B, 1718B of the second compression chamber 1706B, where the second diaphragm 1714B of the second compression chamber 1706B compresses the bleed gas to a third example pressure (e.g., 45 psi, 50 psi, 3 atm, etc.) greater than the second pressure. Similarly, the compressed bleed gas expelled from the second compression chamber 1706B is provided to alternating ones of the third and fourth chamber portions 1716C, 1718C of the third compression chamber 1706C, where the second diaphragm 1714C of the third compression chamber 1706C compresses the bleed gas to a fourth example pressure (e.g., 100 psi, 120 psi, 4 atm, etc.) greater than the third pressure. In some examples, the third compression chamber 1706C expels the compressed bleed gas. In some examples, the fourth pressure of the compressed bleed gas is at or above the pressure of the fluid in the second pipe 104. In this example, a compression ratio of ones of the diaphragm actuators 1702 is 2:1, where the compression ratio represents a ratio between a first volume of one of the drive chambers 1704A, 1704B, 1704C and a second volume of a corresponding one of the compression chambers 1706A, 1706B, 1706C. In some examples, a different compression ratio can be used for one or more of the diaphragm actuators 1702.

FIGS. 17B and 17C illustrate a perspective view and a cross-sectional view, respectively, of an example dual-diaphragm actuator 1732 that can be implemented in examples disclosed herein. For example, the dual-diaphragm actuator 1732 of FIGS. 17B and/or 17C can be used for the diaphragm actuator 1602 in the ninth example drive system 1600 of FIG. 16 and/or can be used for one(s) of the example diaphragm actuators 1702A, 1702B, 1702C of the tenth example drive system 1700 of FIG. 17A. As shown in the illustrated example of FIG. 17B, the dual-diaphragm actuator 1732 includes a first example diaphragm housing 1734A including a first example flanged section 1736A coupled to a second example flanged section 1736B, and a second example diaphragm housing 1734B including a third example flanged section 1736C coupled to a fourth example flanged section 1736D. In this example, a first diameter of the first diaphragm housing 1734A is greater than a second diameter of the second diaphragm housing 1734B. In this example, the first diaphragm housing 1734A is coupled to the second diaphragm housing 1734B via an example cylinder 1738.

Turning to FIG. 17C, the dual-diaphragm actuator 1732 includes a first example diaphragm 1740A positioned in the first diaphragm housing 1734A between the first and second flanged sections 1736A, 1736B, and a second example diaphragm 1740B positioned in the second diaphragm housing 1734B between the third and fourth flanged sections 1736C, 1736D. In this example, the first diaphragm 1740A and the second diaphragm 1740B are operatively coupled via an example rod 1742 positioned in the cylinder 1738, such that deflection of the first diaphragm 1740A drives corresponding deflection of the second diaphragm 1740B.

In the illustrated example of FIG. 17C, the first diaphragm 1740A and the first flanged section 1736A define a first example chamber 1744A in the first diaphragm housing 1734A, and the first diaphragm 1740A and the second flanged section 1736B define a second example chamber 1744B in the first diaphragm housing 1734A. Further, the first flanged section 1736A includes a first example inlet port 1746A and a first example outlet port 1748A fluidly coupled to the first chamber 1744A, and the second flanged section 1736B includes a second example inlet port 1746B and a second example outlet port 1748B fluidly coupled to the second chamber 1744B. In some examples, the first and second inlet ports 1746A, 1746B are further fluidly coupled to the first example pipe 102 of FIG. 1 to receive drive fluid therefrom. In some examples, the first and second inlet ports 1746A, 1746B receive the drive fluid in an alternating manner to drive reciprocal motion and/or deflection of the first diaphragm 1740A. In some examples, the first and second outlet ports 1748A, 1748B are further fluidly coupled to the second example pipe 104 of FIG. 1 to expel and/or provide the drive gas thereto.

In the illustrated example of FIG. 17C, the second diaphragm 1740B and the third flanged section 1736C define a third example chamber 1744C in the second diaphragm housing 1734B, and the second diaphragm 1740B and the fourth flanged section 1736D define a fourth example chamber 1744D in the second diaphragm housing 1734B. In this example, the fourth flanged section 1736D includes a third example inlet port 1746C and a third example outlet port 1748C fluidly coupled to the fourth chamber 1744D. In some examples, the third inlet port 1746C is fluidly coupled to the example gas source 106 of FIG. 1, and the third outlet port 1748D is fluidly coupled to the second example pipe 104 of FIG. 1. In some examples, reciprocal motion of the first diaphragm 1740A in the first diaphragm housing 1734 drives corresponding reciprocal motion of the second diaphragm 1740B in the second diaphragm housing 1734B. In some such examples, the reciprocal motion of the second diaphragm 1740B is used to draw bleed gas from the gas source 106 and into the fourth chamber 1744D via the third inlet port 1746C, and/or is used to compress and/or expel bleed gas from the fourth chamber 1744D to the second pipe 104 via the third outlet port 1748C.

FIG. 17D illustrates a triple-diaphragm actuator 1750 that may be implemented in examples disclosed herein. In the illustrated example of FIG. 17D, the triple-diaphragm actuator 1750 includes a first example diaphragm housing 1752A and a second example diaphragm housing 1752B, where the first and second diaphragm housings 1752A, 1752B of FIG. 17D are substantially similar to the first and second diaphragm housings 1734A, 1734B of the example dual-diaphragm actuator 1732 of FIGS. 17B and/or 17C. Further, the triple-diaphragm actuator 1750 of FIG. 17D includes a third example diaphragm housing 1752C, where the first, second, and third diaphragm housings 1752A, 1752B, 1752C are coupled together via an example column 1754. In this example, the third diaphragm housing 1752C has substantially the same dimensions as the first diaphragm housing 1752A, and a second dimension (e.g., a width, a diameter) of the second diaphragm housing 1752 is less than a first dimension of the first diaphragm housing 1752A and/or the third diaphragm housing 1752C. In some examples, an example rod 1758 is positioned in the example column 1754 to operatively couple example diaphragms 1756A, 1756B, 1756C positioned in respective ones of the diaphragm housings 1752A, 1752B, 1752C.

In some examples, the first diaphragm housing 1752A and/or the third diaphragm housing 1752C are fluidly coupled between the first pipe 102 and the second pipe 104 of FIG. 1, such that reciprocal motion and/or deflection of the first diaphragm 1756A and/or the third diaphragm 1756C are driven based on a pressure differential between the first and second pipes 102, 104. In some examples, the reciprocal motion of the first diaphragm 1756A and/or the third diaphragm 1756C drives corresponding reciprocal motion of the second diaphragm 1756B. In some such examples, the second diaphragm housing 1752B is fluidly coupled to the gas source 106 of FIG. 1, and the reciprocal motion of the second diaphragm 1756B is used to draw bleed gas from the gas source 106 and compress and/or expel the bleed gas to the second pipe 104. In some examples, by including the third diaphragm housing 1752C, the triple-diaphragm actuator 1750 of FIG. 17D can compress the bleed gas to a greater pressure compared to the dual-diaphragm actuator 1732 of FIGS. 17B and/or 17C.

FIG. 17E illustrates a quadruple-diaphragm actuator 1760 that may be implemented in examples disclosed herein. In the illustrated example of FIG. 17E, the quadruple-diaphragm actuator 1760 includes a first example diaphragm housing 1762A, a second example diaphragm housing 1762B, and a third example diaphragm housing 1762C, where the first, second, and third diaphragm housings 1762A, 1762B, 1762C of FIG. 17E are substantially similar to the first, second, and third diaphragm housings 1752A, 1752B, 1752C of the example triple-diaphragm actuator 1750 of FIG. 17D. Further, the quadruple-diaphragm actuator 1760 of FIG. 17E includes a fourth example diaphragm housing 1762D, where the first, second, third, and fourth diaphragm housings 1762A, 1762B, 1762C, 1762D are coupled together via an example column 1764.

In the illustrated example of FIG. 17E, the third diaphragm housing 1762C has substantially the same dimensions as the first diaphragm housing 1762A, and the fourth diaphragm housing 1762D has substantially the same dimensions as the second diaphragm housing 1762B. In this example, the second and fourth diaphragm housings 1762B, 1762D are smaller (e.g., in width and/or diameter) compared to the first and third diaphragm housings 1762A, 1762C. In some examples, size(s) of one or more of the diaphragm housings 1762A, 1762B, 1762C, 1762D may be different. In the illustrated example of FIG. 17E, an example rod 1768 is positioned in the example column 1764 to operatively couple example diaphragms 1766A, 1766B, 1766C, 1766D positioned in respective ones of the diaphragm housings 1762A, 1762B, 1762C, 1762D.

In some examples, the first diaphragm housing 1762A and/or the third diaphragm housing 1762C are fluidly coupled between the first pipe 102 and the second pipe 104 of FIG. 1, such that reciprocal motion and/or deflection of the first diaphragm 1766A and/or the third diaphragm 1766C are driven based on a pressure differential between the first and second pipes 102, 104. In some examples, the reciprocal motion of the first diaphragm 1766A and/or the third diaphragm 1766C drives corresponding reciprocal motion of the second diaphragm 1766B and/or the fourth diaphragm 1766D. In some such examples, the second and fourth diaphragm housings 1762B, 1762D are fluidly coupled to the gas source 106 of FIG. 1, and the reciprocal motion of the second diaphragm 1766B and/or the fourth diaphragm 1766D is used to draw bleed gas from the gas source 106 of FIG. 1 and compress and/or expel the bleed gas to the second pipe 104.

In some examples, the second and fourth diaphragms 1766B, 1766D operate in parallel to evacuate and/or compress bleed gas from the gas source 106. In such examples, a rate of compression (e.g., an amount of bleed gas compressed in a given duration) of the quadruple-diaphragm actuator 1760 of FIG. 17E is greater than a rate of compression of the triple-diaphragm actuator 1750 of FIG. 17D. Additionally or alternatively, in some examples, bleed gas compressed by and/or output from a first one of the second diaphragm housing 1762 or the fourth diaphragm housing 1762 is provided to a second one of the second diaphragm housing 1762 or the fourth diaphragm housing 1762, such that the second and fourth diaphragms 1766B, 1766D operate in series to evacuate and/or compress bleed gas from the gas source 106. In such examples, the quadruple-diaphragm actuator 1760 of FIG. 17E can compress the bleed gas to a greater pressure compared to the triple-diaphragm actuator 1750 of FIG. 17D.

FIGS. 17F and 17G illustrate a perspective view and a partial transparent view, respectively, of a second example dual-diaphragm actuator 1770 that may be implemented in examples disclosed herein. In the illustrated example of FIG. 17F, the second dual-diaphragm actuator 1770 includes a first example housing portion 1772A coupled to a second example housing portion 1772B. A first example diaphragm 1774 (e.g., as shown in FIG. 17G) is positioned within the first and second housing portions 1772A, 1772B. Further, a second example diaphragm 1776 is operatively coupled to the first diaphragm 1774 via an example linkage 1778 extending through the second housing portion 1772B. In the illustrated example of FIG. 17F, the first housing portion 1772A includes a first example inlet port 1780A and a first example outlet port 1782A.

Turning to FIG. 17G, the second housing portion 1772B includes a second example inlet port 1780B and a second example outlet port 1782B. In some examples, the first inlet port 1780A of the first housing portion 1772A and the second inlet port 1780B of the second housing portion 1772B are fluidly coupled to the first pipe 102 of FIG. 1, and the first outlet port 1782A of the first housing portion 1772A and the second outlet port 1782B of the second housing portion 1772B are fluidly coupled to the second pipe 104 of FIG. 1. In some examples, drive fluid from the first pipe 102 is provided to the first and second housing portions 1772A, 1772B via the first and second inlet ports 1780A, 1780B in an alternating manner to drive reciprocal motion and/or deflection of the first diaphragm 1774. In some examples, the drive fluid is expelled from the first and second housing portions 1772A, 1772B to the second pipe 104 via the first and second outlet ports 1782A, 1782B.

In some examples, the linkage 1778 operatively couples the first and second diaphragms 1774, 1776 such that reciprocal motion of the first diaphragm 1774 results in reciprocal motion of the second diaphragm 1776. In some examples, the second diaphragm 1776 is positioned along the example bleed line 114 of FIG. 1, such that the reciprocal motion of the second diaphragm 1776 draws bleed gas from the gas source 106 and compresses and/or pumps the bleed gas to a second location (e.g., the second pipe 104). In some examples, one or more additional diaphragms may be operatively coupled to the first diaphragm 1774. For example, one or more diaphragms can be operatively coupled to a second example linkage 1784 extending through the first housing portion 1772A. In some examples, a third example linkage (not shown) can be positioned in an example aperture 1786 of the second housing portion 1772B, and the third linkage can operatively couple one or more additional diaphragms to the linkage 1778 and, thus, the first diaphragm 1774.

FIGS. 18A and 18B illustrate a first example accumulator reservoir 1800 in an undeflected position and a deflected position, respectively. In some examples, the first accumulator reservoir 1800 is fluidly coupled to the example gas source 106 to capture bleed gas therefrom. For example, the first accumulator reservoir 1800 is fluidly coupled to the gas source 106 via an example inlet line 1802, and a check valve 1804 is implemented along the inlet line 1802 to enable fluid flow from the gas source 106 to the first accumulator reservoir 1800 and restrict fluid flow (e.g., backflow) from the first accumulator reservoir 1800 to the gas source 106.

In the illustrated example of FIG. 18A, the first accumulator reservoir 1800 includes example sidewalls (e.g., rigid sidewalls) 1806A, 1806B, 1806C and an example diaphragm (e.g., a flexible sidewall) 1808, where the sidewalls 1806A, 1806B, 1806C and the diaphragm 1808 define an example chamber 1810 therein. While the first accumulator reservoir 1800 is substantially rectangular in this example, a different shape (e.g., spherical, elliptical, etc.) of the first accumulator reservoir 1800 may be used instead. For example, the first accumulator reservoir 1800 can include a different number, shape, and/or arrangement of the sidewalls 1806A, 1806B, 1806C and/or the diaphragm 1808 compared to the first accumulator reservoir 1800 shown in FIG. 18A. In some examples, the sidewalls 1806A, 1806B, 1806C are substantially rigid, such that little or no deflection of the sidewalls 1806A, 1806B, 1806B occurs when a pressure in the chamber 1810 varies (e.g., increases or decreases). In some examples, the diaphragm 1808 is a flexible wall that can deflect when the pressure in the chamber 1810 satisfies a pressure threshold (e.g., is greater than 0 psi, is greater than 1 psi, etc.). In the illustrated example of FIG. 18A, the pressure in the chamber 1810 (e.g., 0 psi) does not satisfy the pressure threshold. As a result, the diaphragm 1808 shown in FIG. 18A is in an undeflected position (e.g., a substantially undeflected position, a deflection angle of the diaphragm 1808 is less than ±5 degrees).

In the illustrated example of FIG. 18A, an example scavenge line 1812 extends through the diaphragm 1808, and a first end (e.g., a closed end) 1814 of the scavenge line 1812 is positioned in the chamber 1810 of the first accumulator reservoir 1800. In some examples, a second end 1816 of the scavenge line 1812 can be fluidly coupled to a second location (e.g., the first pipe 102 and/or the second pipe 104 of FIG. 1). In this example, an example sleeve 1818 surrounds (e.g., envelops, encases) a portion of the scavenge line 1812, and the sleeve 1818 is movable and/or slidable along the scavenge line 1812. Further, the sleeve 1818 is coupled to the diaphragm 1808 such that the sleeve 1818 moves with the diaphragm 1808. In the illustrated example of FIG. 18A, the scavenge line 1812 includes an example opening 1820, where the opening 1820 is positioned along a length of the scavenge line 1812 positioned within the chamber 1810. When the diaphragm 1808 is in the undeflected position of FIG. 18A, the sleeve 1818 covers the opening 1820 such that the sleeve 1818 restricts flow of fluid (e.g., bleed gas) through the opening 1820.

Turning to FIG. 18B, the diaphragm 1808 of the first accumulator reservoir 1800 is shown in a deflected position. In some examples, when bleed gas is emitted from the gas source 106, the bleed gas flows from the gas source 106 to the chamber 1810 via the inlet line 1802 to increase a pressure in the chamber 1810. In some examples, the diaphragm 1808 moves from the undeflected position of the FIG. 18A to the deflected position of FIG. 18B when a pressure in the chamber 1810 satisfies (e.g., exceeds) a pressure threshold (e.g., 0 psi, 1 psi, etc.). In such examples, when the diaphragm 1808 deflects in a first example direction 1822 (e.g., leftward in FIG. 18B), the sleeve 1818 moves with the diaphragm 1808 and slides (e.g., moves, translates) along the scavenge line 1812 in the first direction 1822. In some examples, when the sleeve 1818 moves in the first direction 1822 to the position shown in FIG. 18B, the sleeve 1818 uncovers and/or exposes the opening 1820 in the scavenge line 1812. In such examples, the bleed gas in the chamber 1810 flows into the scavenge line 1812 via the opening 1820, and further flows toward the second end 1816 of the scavenge line 1812. In some such examples, the bleed gas from the scavenge line 1812 can be provided to the second location (e.g., the first pipe 102 and/or the second pipe 104) to reduce an amount of bleed gas vented and/or released to the atmosphere.

FIGS. 19A and 19B illustrate a second example accumulator reservoir 1900 in an undeflected position and a deflected position, respectively. In the illustrated example of FIG. 19A, the second accumulator reservoir 1900 is fluidly coupled to the example gas source 106 to capture bleed gas therefrom. For example, the second accumulator reservoir 1900 is fluidly coupled to the gas source 106 via an example inlet line 1902, and a check valve 1904 is implemented along the inlet line 1902 to enable fluid flow from the gas source 106 to the second accumulator reservoir 1900 and restrict fluid flow (e.g., backflow) from the second accumulator reservoir 1900 to the gas source 106.

In the illustrated example of FIG. 19A, similar to the first example accumulator reservoir 1800 of FIGS. 5A and/or 5B, the second accumulator reservoir 1900 includes example sidewalls (e.g., rigid sidewalls) 1906A, 1906B, 1906C and an example diaphragm (e.g., a flexible sidewall) 1908, where the sidewalls 1906A, 1906B, 1906C and the diaphragm 1908 define an example chamber 1910. While the second accumulator reservoir 1900 is substantially rectangular in this example, a different shape (e.g., spherical, elliptical, etc.) of the second accumulator reservoir 1900 may be used instead. For example, the second accumulator reservoir 1900 can include a different number, shape, and/or arrangement of the sidewalls 1906A, 1906B, 1906C and/or the diaphragm 1908 compared to the second accumulator reservoir 1900 shown in FIG. 19A. In some examples, the sidewalls 1906A, 1906B, 1906C are substantially rigid, such that little or no deflection of the sidewalls 1906A, 1906B, 1906B occurs when a pressure in the chamber 1910 varies (e.g., increases or decreases). In some examples, the diaphragm 1908 is a flexible wall that can deflect when the pressure in the chamber 1910 satisfies a pressure threshold (e.g., is greater than 0 psi, is greater than 1 psi, etc.). In the illustrated example of FIG. 19A, the pressure in the chamber 1910 (e.g., 0 psi) does not satisfy the pressure threshold. As a result, the diaphragm 1908 shown in FIG. 19A is in an undeflected position (e.g., a substantially undeflected position).

In the illustrated example of FIG. 19A, an example scavenge line 1912 extends through one of the sidewalls 1906C, and terminates at a first end (e.g., an open end) 1914 positioned in the chamber 1910. In some examples, a second end 1916 of the scavenge line 1812 can be fluidly coupled to a second location (e.g., the first pipe 102 and/or the second pipe 104 of FIG. 1). While the scavenge line 1912 extends through a first one of the sidewalls 1906C in this example, the scavenge line 1912 can extend through a different one of the sidewalls 1906A, 1906B in other examples. In the illustrated example of FIG. 19A, when the diaphragm 1908 is in the undeflected position, the diaphragm 1908 contacts the first end 1914 of the scavenge line 1812 to seal the first end 1914 and/or to restrict fluid (e.g., bleed gas) from entering the scavenge line 1812 at the first end 1914.

Turning to FIG. 19B, the diaphragm 1908 of the second accumulator reservoir 1900 is shown in a deflected position. In some examples, when bleed gas is emitted from the gas source 106, the bleed gas flows from the gas source 106 to the chamber 1910 via the inlet line 1902 to increase a pressure in the chamber 1910. In some examples, the diaphragm 1908 moves from the undeflected position of the FIG. 19A to the deflected position of FIG. 19B when a pressure in the chamber 1910 satisfies (e.g., exceeds) a pressure threshold (e.g., 0 psi, 1 psi, etc.). In such examples, when the diaphragm 1908 deflects in a first example direction 1918 (e.g., leftward in FIG. 19B), the diaphragm 1908 is spaced apart from the first end 1914 of the scavenge line 1912. As a result, fluid (e.g., bleed gas) from the chamber 1910 can enter the scavenge line 1912 via the first end 1914, and can flow to the second end 1916 of the scavenge line 1912. In some such examples, the bleed gas from the scavenge line 1912 can be provided to the second location (e.g., the first pipe 102 and/or the second pipe 104) to reduce an amount of bleed gas vented and/or released to the atmosphere.

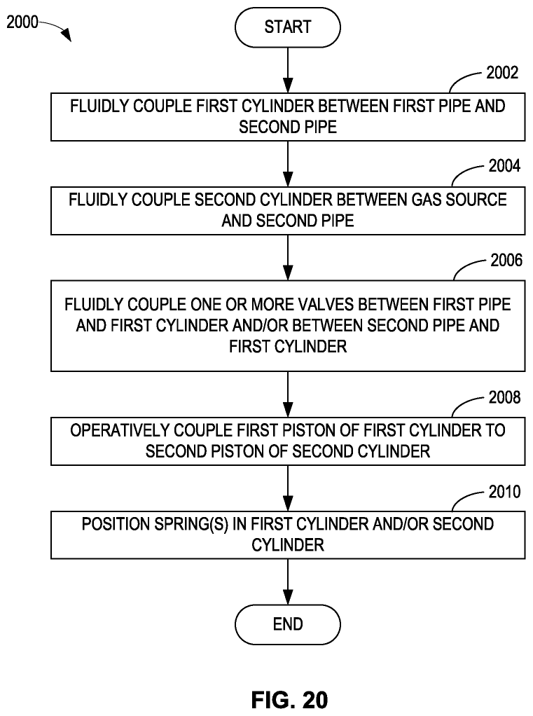

In some examples, the first example drive system 200 shown in FIG. 2, the second example drive system 300 shown in FIG. 3, the third example drive system 400 shown in FIG. 4, the fourth example drive system 700 shown in FIG. 7, the fifth example drive system 800 shown in FIG. 8, the sixth example drive system 900 shown in FIG. 9, the seventh example drive system 1000 shown in FIG. 10, the eighth example drive system 1400 shown in FIG. 14, the ninth example drive system 1600 shown in FIG. 16, or the tenth example drive system 1700 shown in FIG. 17A, and/or any suitable combination thereof, can be used to implement the example drive device 108 of FIG. 1. In some examples, the example drive device 108 of FIG. 1 (e.g., including one or more of the example drive systems 200, 300, 400, 700, 800, 900, 1000, 1400, 1600, 1700) can be implemented in a variety of ways, such as shown and described below in connection with FIGS. 20-28.

FIG. 20 is a flowchart representative of an example method 2000 to produce the first example drive system 200 of FIG. 2, the second example drive system 300 of FIG. 3, and/or the third example drive system 400 of FIG. 4. Although the example method is described with reference to the flowchart illustrated in FIG. 20, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example method 2000 of FIG. 20 begins at block 2002, at which a first example cylinder is fluidly coupled between the first and second pipes 102, 104 of FIG. 1. In some examples, the first cylinder corresponds to the first cylinder 202 of FIG. 2 and/or the first cylinder 302 of FIGS. 3 and/or 4. In some examples, the first and second pipes 102, 104 are fluidly coupled to the first chamber 309 of the first cylinder 302 of FIGS. 3 and/or 4, and/or to both the first and second chambers 220, 226 of the first cylinder 202 of FIG. 2. In such examples, fluid (e.g., gas) from the first pipe 102 can flow to the first cylinder 202 of FIG. 2 and/or the first cylinder 302 of FIGS. 3 and/or 4, and the fluid can be evacuated and/or expelled from the first cylinder 202 of FIG. 2 and/or the first cylinder 302 of FIGS. 3 and/or 4 to the second pipe 104.

At block 2004, a second example cylinder is fluidly coupled between the example gas source 106 and the second pipe 102 of FIG. 1. In some examples, the second cylinder corresponds to the second cylinder 204 of FIG. 2 and/or the second cylinder 304 of FIGS. 3 and/or 4. In some examples, the first and second pipes 102, 104 are fluidly coupled to the third chamber 240 of the second cylinder 204 of FIG. 2, and/or to the fourth chamber 320 of the second cylinder 304 of FIGS. 3 and/or 4. In such examples, bleed gas from the gas source 106 can flow to the second cylinder 204 of FIG. 2 and/or the second cylinder 304 of FIGS. 3 and/or 4, and the bleed gas can be evacuated and/or expelled from the second cylinder 204 of FIG. 2 and/or the second cylinder 304 of FIGS. 3 and/or 4 to the second pipe 102.

At block 2006, one or more example valves are fluidly coupled between the first pipe 102 and the first cylinder and/or between the second pipe 104 and the first cylinder. For example, the first and second valves 212, 214 are fluidly coupled between the first pipe 102 and the first and second chambers 220, 226 of the first cylinder 202 of FIG. 2, and the third and fourth valves 232, 236 are fluidly coupled between the second pipe 104 and respective ones of the first and second chambers 220, 226. Additionally or alternatively, the first valve 330 is fluidly coupled between the first pipe 102 and the first chamber 309 of the first cylinder 302 of FIGS. 3 and/or 4, and the second valve 334 is fluidly coupled between the second pipe 104 and the first chamber 309. In some examples, opening and/or closing of one(s) of the valves 212, 214, 232, 236, 330, 334 can be used to control fluid flow to and/or from the first cylinder 202 of FIG. 2 and/or the first cylinder 302 of FIGS. 3 and/or 4.

At block 2008, a first example piston of the first cylinder is operatively coupled to a second example piston of the second cylinder. For example, the first piston 206 positioned in and/or slidable within the first cylinder 202 of FIG. 2 is operatively coupled (e.g., via the rod 210) to the second piston 208 positioned in and/or slidable within the second cylinder 204 of FIG. 2. Additionally or alternatively, the first piston 306 positioned in and/or slidable within the first cylinder 302 of FIGS. 3 and/or 4 is operatively coupled (e.g., via the rod 326) to the second piston 308 positioned in and/or slidable within the second cylinder 304 of FIGS. 3 and/or 4. In some examples, differential pressure between the first pipe 102 and the second pipe 104 drives reciprocal motion of the first piston 206 within the first cylinder 202 of FIG. 2 and, as a result, drives corresponding reciprocal motion of the second piston 208 within the second cylinder 204 of FIG. 2. In some examples, differential pressure between the first pipe 102 and the second pipe 104 drives reciprocal motion of the first piston 306 within the first cylinder 302 of FIGS. 3 and/or 4 and, as a result, drives corresponding reciprocal motion of the second piston 308 within the second cylinder 304 of FIGS. 3 and/or 4. In such examples, the reciprocal motion of the second piston 208 within the second cylinder 204 of FIG. 2 and/or the reciprocal motion of the second piston 308 within the second cylinder 304 of FIGS. 3 and/or 4 is used to draw bleed gas from the gas source 106 and pump the bleed gas to the second pipe 104, thus reducing an amount of bleed gas to be vented from the gas source 106.

At block 2010, one or more example springs are positioned in at least one of the first cylinder or the second cylinder. For example, the first example spring 324 of FIGS. 3 and/or 4 is positioned in the second chamber 312 of the first cylinder 302 of FIGS. 3 and/or 4 and is operatively coupled between the first piston 306 and the second end 314 of the first cylinder 302. Additionally or alternatively, the second example spring 402 of FIG. 4 is positioned in the fourth chamber 320 of the second cylinder 304 of FIGS. 3 and/or 4 and is operatively coupled between the second piston 308 and the fourth end 322 of the second cylinder 304. In some examples, the first spring 324 and/or the second spring 402 facilitate return of the first piston 306 and the second piston 308 to a leftward position in the respective first and second cylinders 302, 304 of FIGS. 3 and/or 4.

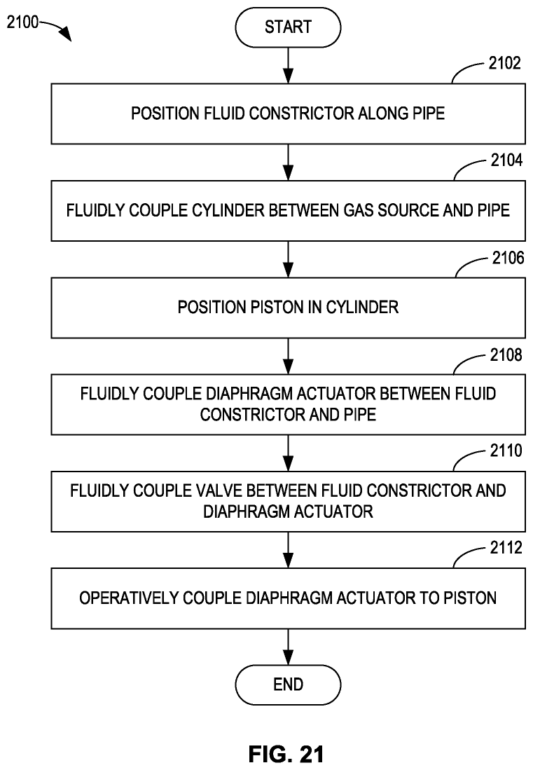

FIG. 21 is a flowchart representative of an example method 2100 to produce the fourth example drive system 700 of FIG. 7. Although the example method is described with reference to the flowchart illustrated in FIG. 21, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example method 2100 of FIG. 21 begins at block 2102, at which the example Fluid constrictor 702 of FIG. 7 is positioned along an example pipe (e.g., the first example pipe 102 of FIG. 1). For example, example nozzles 706, 708 are coupled to the first pipe 102, and an example pipe section 704 is coupled between the nozzles 706, 708 to produce the Fluid constrictor 702 of FIG. 7. In some examples, as fluid in the pipe 102 flows through the Fluid constrictor 702, the Fluid constrictor 702 causes a pressure of the fluid to drop and/or causes a velocity of the fluid to increase. As a result, the fluid in the pipe section 704 of the Fluid constrictor 702 is at a first pressure less than a second pressure of the fluid in the pipe 102.

At block 2104, the example cylinder 712 is fluidly coupled between the example gas source 106 and the first pipe 102. For example, the cylinder 712 is implemented along the example bleed line 714 fluidly coupled between the gas source 106 and a first portion of the first pipe 102 on a first side of the Fluid constrictor 702. In some examples, bleed gas from the gas source 106 can flow to the cylinder 712 and/or the bleed gas can flow from the cylinder 712 to the first pipe 102.

At block 2106, the example piston 710 of FIG. 7 is positioned in the example cylinder 712. For example, the piston 710 is positioned in and/or slidable within the cylinder 712 along the first and second directions 734, 736 of FIG. 7. In some examples, reciprocal motion of the piston 710 within the cylinder 712 can be used to draw bleed gas from the gas source 106 into the cylinder 712 and pump the bleed gas from the cylinder 712 into the first pipe 102.

At block 2108, the example diaphragm actuator 716 of FIG. 21 is fluidly coupled between the Fluid constrictor 702 and the first pipe 102. For example, the first chamber 720 of the diaphragm actuator 716 is fluidly coupled to the pipe section 704 of the Fluid constrictor 702 and is further fluidly coupled to a second portion of the first pipe 102 on a second side of the Fluid constrictor 702 (e.g., opposite the first side). Further, the second chamber 722 of the diaphragm actuator 716 is fluidly coupled to the second portion of the first pipe 102. In some examples, the first chamber 720 is fluidly coupled to the first pipe 102 at a first location, and the second chamber 722 is fluidly coupled to the first pipe 102 at a second location upstream relative to the first location.

At block 2110, the example valve 732 of FIG. 7 is fluidly coupled between the Fluid constrictor 702 and the diaphragm actuator 716. For example, valve 732 is implemented along the first fluid line 726 between the first chamber 720 of the diaphragm actuator 716 and the pipe section 704 of the Fluid constrictor 702. In some examples, by repeatedly opening and closing the valve 732, a relative pressure between the first and second chambers 720, 722 of the diaphragm actuator 716 can be adjusted to cause deflection of the diaphragm 718 (e.g., along the first and second directions 734, 736 of FIG. 7).

At block 2112, the example diaphragm actuator 716 is operatively coupled to the example piston 710. For example, the example rod 724 of FIG. 7 operatively couples the diaphragm 718 of the diaphragm actuator 716 to the piston 710, such that deflection of the diaphragm 718 results in corresponding movement (e.g., reciprocal motion) of the piston 710 within the cylinder 712, and, thus, causes bleed gas to be drawn from the gas source 106 and provided to the first pipe 102.

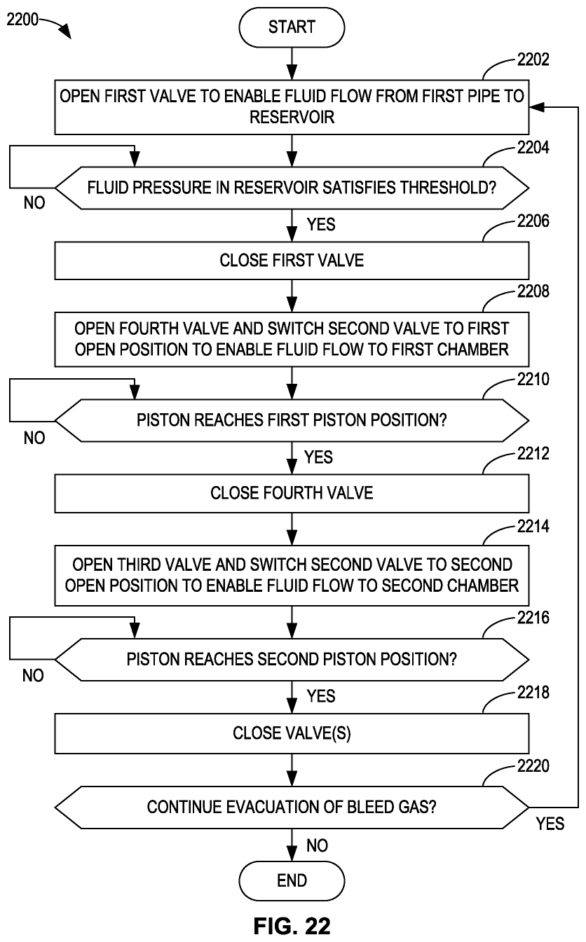

FIG. 22 is a flowchart representative of example operations 2200 to implement a gas recovery procedure using the first example drive system 200 of FIG. 2. Although the example method is described with reference to the flowchart illustrated in FIG. 22, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example. The operations 2200 begin with the example valves 212, 214, 232, 236 of FIG. 2 in a closed position.

At block 2202, the first example valve 212 is opened to enable fluid flow from the first example pipe 102 to the example reservoir 216 of FIG. 2. For example, the first valve 212 moves to an open position in which the fluid can flow therethrough from the first pipe 102 to the reservoir 216. In some examples, the first valve 212 can be opened manually (e.g., by an operator) and/or automatically (e.g., by a pneumatic and/or electrical signal from a control system operatively coupled to the first valve 212).

At block 2204, the fluid pressure in the reservoir 216 is evaluated based on an example threshold (e.g., a pressure threshold). In some examples, the threshold corresponds to a pressure of the fluid in the first pipe 102. In response to the fluid pressure in the reservoir 216 not satisfying the threshold (e.g., block 2204 returns a result of NO), control returns to block 2204 until the fluid pressure satisfies the threshold. In response to the fluid pressure in the reservoir 216 satisfying the threshold (e.g., block 2204 returns a result of YES), control proceeds to block 2206.

At block 2206, the first valve 214 is closed. For example, the first valve 214 moves to the closed position to restrict further fluid flow from the first pipe 102 to the reservoir 216. In some examples, the first valve 212 can be closed manually (e.g., by an operator) and/or automatically (e.g., by a pneumatic and/or electrical signal from a control system operatively coupled to the first valve 212).

At block 2208, the fourth example valve 236 is opened and the second example valve 214 switches to the first open position to enable fluid flow from the reservoir 216 to the first example chamber 220 of the first cylinder 202. For example, the second and fourth valves 214, 236 can be opened manually (e.g., by an operator) and/or automatically (e.g., by a pneumatic and/or electrical signal from a control system operatively coupled to the second and fourth valves 214, 236). For example, fluid flows from the reservoir 216 to the first chamber 220, and pressure buildup in the first chamber 220 causes the first piston 206 to move in a first direction (e.g., rightward in FIG. 2) toward the second end 228 of the first cylinder 202. As a result, the first piston 206 pushes the second piston 208 toward the fourth end 242 of the second cylinder 204, which expels bleed gas from the third chamber 240 of the second cylinder 204 toward the second pipe 104.

At block 2210, a position of the first piston 206 is evaluated based on a first piston position. For example, the first piston 206 is in the first piston position when a first pressure in the first chamber 220 corresponds to a second pressure in the second chamber 226, and/or when the first piston 206 is stationary and/or is no longer moving in the first direction (e.g., rightward in FIG. 2). In response to the first piston 206 not reaching the first piston position (e.g., block 2210 returns a result of NO), control returns to block 2210 until the first piston 206 reaches the first piston position. Alternatively, in response to the first piston 206 reaching the first piston position (e.g., block 2210 returns a result of YES), control proceeds to block 2212.

At block 2212, the fourth valve 236 is closed. For example, the fourth valve 236 moves to the closed position to restrict fluid flow from the second chamber 226 of the first cylinder 202 to the second pipe 104. In some examples, the fourth valve 236 can be closed manually (e.g., by an operator) and/or automatically (e.g., by a pneumatic and/or electrical signal from a control system operatively coupled to the fourth valve 236).

At block 2214, the third example valve 232 is opened and the second example valve 214 switches to the second open position to enable fluid flow from the reservoir 216 to the second example chamber 226 of the first cylinder 202. For example, the second and third valves 214, 232 can be closed manually (e.g., by an operator) and/or automatically (e.g., by a pneumatic and/or electrical signal from a control system operatively coupled to the second and third valves 214, 232). In some examples, fluid flows from the reservoir 216 to the second chamber 226, and pressure buildup in the second chamber 226 causes the first piston 206 to move in a second direction (e.g., leftward in FIG. 2) toward the first end 222 of the first cylinder 202. As a result, the first piston 206 pulls the second piston 208 toward the third end 238 of the second cylinder 204, which draws bleed gas from the gas source 106 to the third chamber 240 of the second cylinder 204.

At block 2216, a position of the first piston 206 is evaluated based on a second piston position. For example, the first piston 206 is in the second piston position when a first pressure in the first chamber 220 corresponds to a second pressure in the second chamber 226, and/or when the first piston 206 is stationary and/or is no longer moving in the second direction (e.g., leftward in FIG. 2). In response to the first piston 206 not reaching the second piston position (e.g., block 2216 returns a result of NO), control returns to block 2216 until the first piston 206 reaches the second piston position. Alternatively, in response to the first piston 206 reaching the second piston position (e.g., block 2216 returns a result of YES), control proceeds to block 2218.

At block 2218, one or more of the valves 212, 214, 232, 236 are closed. For example, the second and fourth valves 214, 236 are moved to the closed position to restrict fluid flow to the first cylinder 202 and/or to the second pipe 104. In some examples, the second and fourth valves 214, 236 can be closed manually (e.g., by an operator) and/or automatically (e.g., by a pneumatic and/or electrical signal from a control system operatively coupled to the second and fourth valves 214, 236).

At block 2220, the operator and/or the control system determines whether to continue evacuation of bleed gas from the gas source 106. In response to a determination that the evacuation of the bleed gas is to continue (e.g., block 2220 returns a result of YES), control returns to block 2202. Alternatively, in response to a determination that the evacuation of the bleed gas is not to continue (e.g., block 2220 returns a result of NO), control ends.

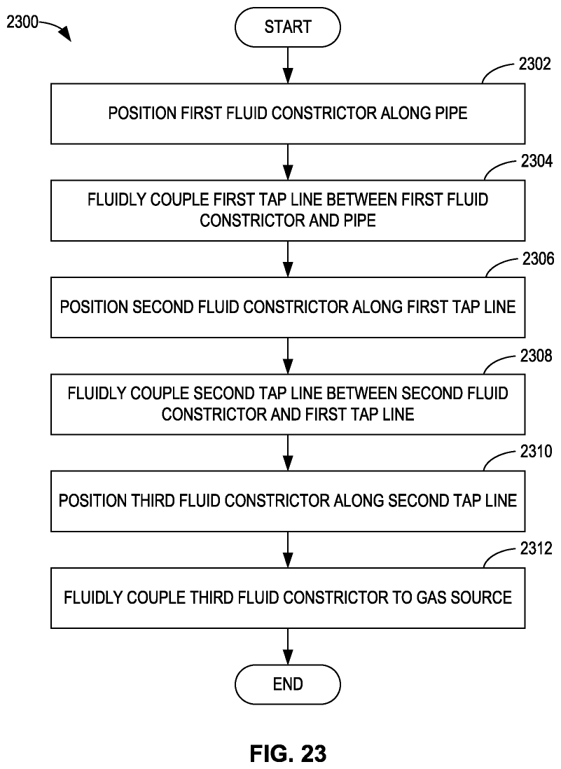

FIG. 23 is a flowchart representative of an example method 2300 to produce the fifth example drive system 800 of FIG. 8. Although the example method is described with reference to the flowchart illustrated in FIG. 23, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example method 2300 of FIG. 23 begins at block 2302, at which the first example fluid constrictor 802 of FIG. 8 is positioned along an example pipe (e.g., the first example pipe 102 of FIG. 1). For example, the first example nozzles 810, 812 are coupled to the first pipe 102, and the first example pipe section 808 is coupled between the first nozzles 810, 812 to produce the first fluid constrictor 802 of FIG. 8. In some examples, as gas from the first pipe 102 flows through the first fluid constrictor 802, a pressure of the gas drops and/or a velocity of the gas increases. As a result, the gas in the first pipe section 808 of the first fluid constrictor 802 is at a first pressure (e.g., less than 900 psi, less than 1400 psi, etc.) less than a second pressure (e.g., between 900 psi and 1500 psi) of the gas in the first pipe 102.

At block 2304, the first example tap line 816 of FIG. 8 is fluidly coupled between the first fluid constrictor 802 and the first pipe 102. For example, the first tap line 816 is fluidly coupled to the first pipe section 808 of the first fluid constrictor 802 and further fluidly coupled to the first location 817 of the first pipe 102, where the first location 817 is upstream relative to the first fluid constrictor 802. In some examples, a first pressure differential between the first pipe 102 and the first fluid constrictor 802 generates a second flow of gas through the first tap line 816 from the first location 817 to the first pipe section 808.

At block 2306, the second example fluid constrictor 804 of FIG. 8 is positioned along the first tap line 816. For example, the second example nozzles 820, 822 are coupled to the first tap line 816, and the second example pipe section 818 is coupled between the second nozzles 820, 822 to produce the second fluid constrictor 804 of FIG. 8. In some examples, a pressure of the second flow of gas drops as the gas flows from the first tap line 816 through the second fluid constrictor 804. As a result, the gas in the second pipe section 818 of the second fluid constrictor 804 is at a third pressure less than a fourth pressure of the gas in the first tap line 816.

At block 2308, the second example tap line 824 of FIG. 8 is fluidly coupled between the second fluid constrictor 804 and the first tap line 816. For example, the second tap line 824 is fluidly coupled to the second pipe section 818 of the second fluid constrictor 804 and further fluidly coupled to the second location 825 of the first tap line 816, where the second location 825 is upstream relative to the second fluid constrictor 804. In some examples, a second pressure differential between the first tap line 816 and the second fluid constrictor 804 generates a third flow of gas through the second tap line 824 from the second location 825 to the second pipe section 818.

At block 2310, the third example fluid constrictor 806 of FIG. 8 is positioned along the second tap line 824. For example, the third example nozzles 828, 830 are coupled to the second tap line 824, and the third example pipe section 826 is coupled between the third nozzles 828, 830 to produce the third fluid constrictor 806 of FIG. 8. In some examples, a pressure of the third flow of gas drops as the gas flows from the second tap line 824 through the third fluid constrictor 806. As a result, the gas in the third pipe section 826 of the third fluid constrictor 806 is at a fifth pressure less than a sixth pressure of the gas in the second tap line 824.

At block 2312, the third fluid constrictor 806 is fluidly coupled to the gas source 106. For example, the bleed line 114 fluidly couples the gas source 106 to the third pipe section 826 of the third fluid constrictor 806. In some examples, as a result of a negative pressure differential between the gas source 106 and the third fluid constrictor 806, bleed gas is drawn from the gas source 106 to the third fluid constrictor 806, and the bleed gas can further flow into the first pipe 102 via the first and second tap lines 816, 824. In some examples, the negative pressure differential is between 0.5 psi and 1 psi less than an output pressure from the gas source 106. In some examples, the negative pressure differential can be different (e.g., greater than 1 psi, less than 0.5 psi, etc.).

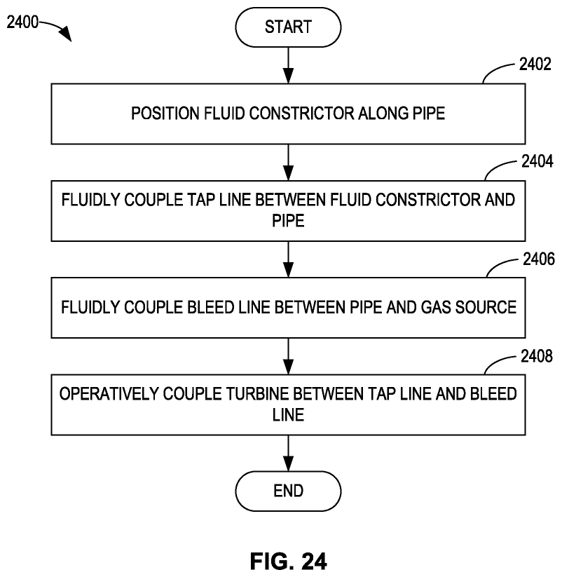

FIG. 24 is a flowchart representative of an example method 2400 to produce the sixth example drive system 900 of FIG. 9. Although the example method is described with reference to the flowchart illustrated in FIG. 24, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example method 2400 of FIG. 24 begins at block 2402, at which the example fluid constrictor 902 of FIG. 9 is positioned along an example pipe (e.g., the first example pipe 102 of FIG. 1). For example, the example nozzles 906, 908 are coupled to the first pipe 102, and the example pipe section 904 is coupled between the nozzles 906, 908 to produce the fluid constrictor 902 of FIG. 9. In some examples, as gas from the first pipe 102 flows through the fluid constrictor 902, a pressure of the gas drops and/or a velocity of the gas increases. As a result, the gas in the pipe section 904 of the fluid constrictor 902 is at a first pressure less than a second pressure of the gas in the first pipe 102.

At block 2404, the example tap line 912 of FIG. 9 is fluidly coupled between the fluid constrictor 902 and the first pipe 102. For example, the tap line 912 is fluidly coupled to the pipe section 904 of the fluid constrictor 902 and further fluidly coupled to the first location 914 of the first pipe 102, where the first location 914 is upstream relative to the fluid constrictor 902. In some examples, a first pressure differential between the first pipe 102 and the fluid constrictor 902 generates a second flow of gas through the tap line 912 from the first location 914 to the pipe section 904.

At block 2406, the example bleed line 114 is fluidly coupled between the first pipe 102 and the gas source 106. For example, the bleed line 114 is coupled to the gas source 106 and further fluidly coupled to the first pipe 102. In some examples, the bleed line 114 is fluidly coupled to the first pipe 102 at a location between the fluid constrictor 902 and the first location 914.

At block 2408, the example turbine 916 of FIG. 9 is operatively coupled between the tap line 912 and the bleed line 114. For example, the first example turbine blades 918 of the turbine 916 are positioned in the tap line 912, and the second example turbine blades 920 of the turbine 916 are positioned in the bleed line 114. In some examples, the second flow of gas through the tap line 912 drives rotation of the first turbine blades 918, and the rotation of the first turbine blades 918 is translated to the second turbine blades 920 via the example shaft 922 operatively coupled between the first and second turbine blades 918, 920. As a result, the rotation of the first turbine blades 918 drives rotation of the second turbine blades 920 within the bleed line 114. In some examples, the second turbine blades 920 draw and compress bleed gas from the gas source 106, and provide the compressed bleed gas into the pipe section 904 to mix with the gas therein.

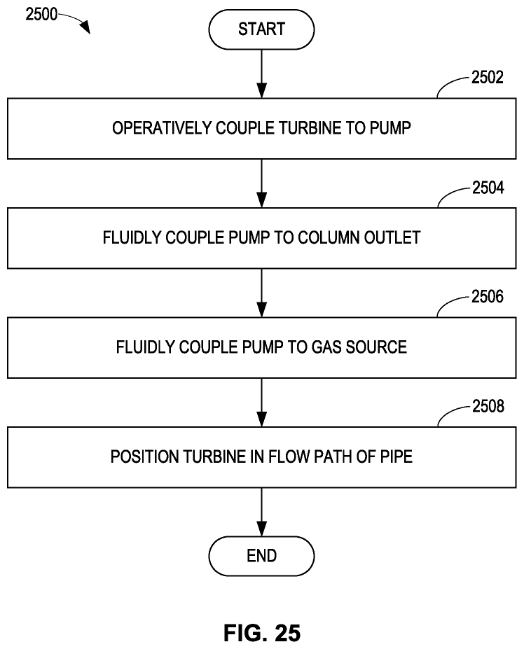

FIG. 25 is a flowchart representative of an example method 2500 to produce the seventh example drive system 1000 of FIG. 10. Although the example method is described with reference to the flowchart illustrated in FIG. 25, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example method 2500 of FIG. 25 begins at block 2502, at which the example turbine 1004 of FIG. 10 is operatively coupled to the example pump 1002 of FIG. 10. For example, the turbine 1004 is operatively coupled to the pump 1002 such that rotation of the example turbine blades 1010 of the turbine 1004 drive operation of the pump 1002. In some examples, the pump 1002 corresponds to the example screw-driven pump 1100 of FIG. 11, the example vane pump 1200 of FIG. 12, and/or the example swash plate pump 1300 of FIG. 13. In some examples, the example shaft 1116 of the turbine 1004 is coupled (e.g., operatively coupled) to an example self-reversing screw 1114 of the screw-driven pump 1100 of FIG. 11 to drive reciprocal motion of the self-reversing screw 1114. In some examples, the turbine 1004 is operatively coupled to the example rotor 1218 of the vane pump 1200 of FIG. 12 to drive rotation of the example rotor 1218 and/or the corresponding vanes 1202. In some examples, the turbine 1004 is operatively coupled to the example swash plate 1306 of the swash plate pump 1300 of FIG. 13 to drive rotation of the swash plate pump 1300. In some examples, the turbine 1004 is coupled to the pump 1002 via the example column 1006 of FIG. 10.

At block 2506, the pump 1002 is fluidly coupled to the example column outlet 1016 of the example column 1006. For example, the pump 1002 is fluidly coupled to the column outlet 1016 of FIG. 10 via the example outlet line 1108 of FIG. 11, the example outlet line 1212 of FIG. 12, and/or the example outlet line 1316 of FIG. 13. In some examples, the column outlet 1016 corresponds to an opening in the column 1006 through which fluid can flow. In some examples, one or more example check valves are implemented along the outlet line 1108 of FIG. 11, the outlet line 1212 of FIG. 12, and/or the outlet line 1316 of FIG. 13 to enable fluid flow from the pump 1002 to the column outlet 1016 and/or restrict fluid flow from the column outlet 1016 to the pump 1002.

At block 2508, the pump 1002 is fluidly coupled to the gas source 106. For example, the pump 1002 is fluidly coupled to the gas source 106 via the example inlet line 1107 of FIG. 11, the example inlet line 1210 of FIG. 12, and/or the example inlet lines 1312A, 1312B of FIG. 13. In some examples, one or more example check valves are implemented along the inlet line 1107 of FIG. 11, the inlet line 1210 of FIG. 12, and/or the inlet lines 1312A, 1312B of FIG. 13 to enable fluid flow from the gas source 106 to the pump 1002 and/or restrict fluid flow from the pump 1002 to the gas source 106.

At block 2510, the example turbine 1004 is positioned in a flow path of the example pipe 1008 of FIG. 10. For example, the turbine 1004 is positioned and/or oriented in the pipe 1008 such that a flow of fluid through the pipe 1008 drives rotation of the turbine blades 1010 about an example rotational axis 1012 of the turbine 1004. In such examples, the rotation of the turbine blades 1010 drives operation of the pump 1002, where the pump 1002 operates to draw bleed gas from the gas source 106 and compress and/or provide the bleed gas to the pipe 1008.

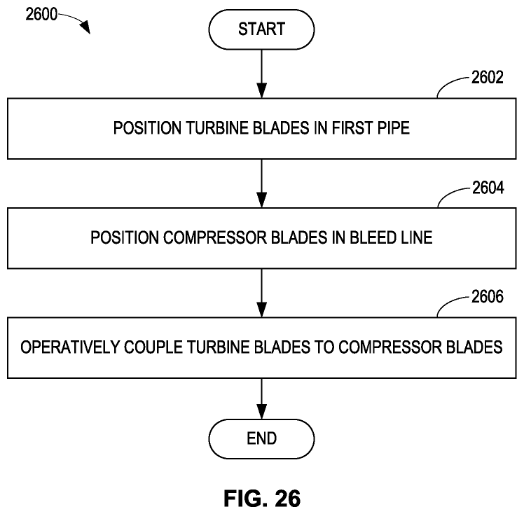

FIG. 26 is a flowchart representative of an example method 2600 to produce the eighth example drive system 1400 of FIG. 14. Although the example method is described with reference to the flowchart illustrated in FIG. 26, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example method 2600 of FIG. 26 begins at block 2602, at which the example turbine blades 1404 of FIG. 14 are positioned in the first example pipe 102 of FIGS. 1 and/or 6. For example, the first example turbine blades 1404A of the first example compressor unit 1402A, the second example turbine blades 1404B of the second example compressor unit 1402B, and/or the third example turbine blades 1404C of the third example compressor unit 1402C of FIG. 14 are positioned in the first pipe 102 between the first end 1410 and the second end 1412 of the first pipe 102. In some examples, the second end 1412 is fluidly coupled to the second example pipe 104 of FIG. 1, and a pressure differential between the first pipe 102 and the second pipe 104 produces a flow of fluid through the first pipe 102 from the first end 1410 to the second end 1412. In some such examples, the fluid flow from the first end 1410 to the second end 1412 drives rotation of the turbine blades 1404.

At block 2604, the example compressor blades 1406 of FIG. 14 are positioned in the example bleed line 114 of FIGS. 1 and/or 6. For example, the first example compressor blades 1406A of the first example compressor unit 1402A, the second example compressor blades 1406B of the second example compressor unit 1402B, and/or the third example compressor blades 1406C of the third example compressor unit 1402C of FIG. 14 are positioned in the bleed line 114 between the gas source 106 and the third end 1416 of the bleed line 114. In some examples, the third end 1416 of the bleed line 114 is fluidly coupled to the second pipe 104 of FIG. 1.

At block 2606, the turbine blades 1404 are operatively coupled to respective ones of the compressor blades 1406. For example, the first turbine blades 1404A are operatively coupled to the first compressor blades 1406A via the first example shaft 1408A, the second turbine blades 1404B are operatively coupled to the second compressor blades 1406B via the second example shaft 1408B, and the third turbine blades 1404C are operatively coupled to the third compressor blades 1406C via the third example shaft 1408C. In such examples, the shafts 1408C transfer rotational motion of the turbine blades 1404 to the respective compressor blades 1406, such that rotation of the turbine blades 1404 drives corresponding rotation of the respective compressor blades 1406. In some examples, the rotation of the compressor blades 1406 is used to draw bleed gas from the gas source 106, compress the bleed gas, and/or provide the compressed bleed gas to the third end 1416 of the bleed line 114 and, thus, to the second pipe 104 of FIG. 1.

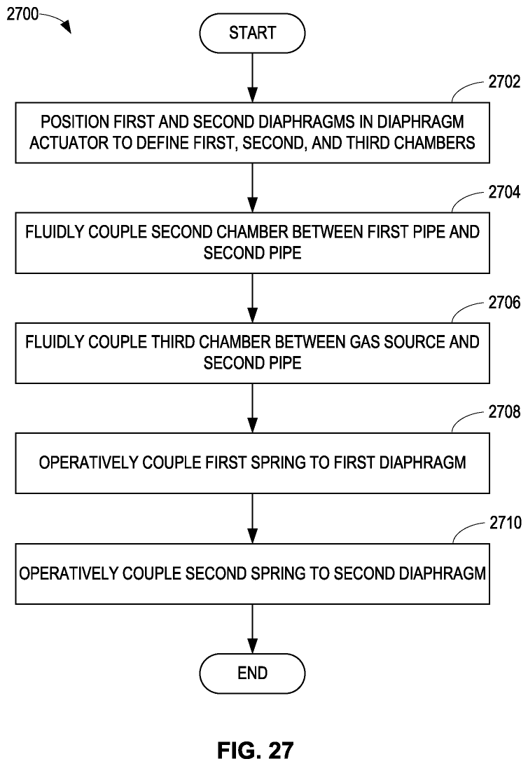

FIG. 27 is a flowchart representative of an example method 2700 to produce the ninth example drive system 1600 of FIG. 16. Although the example method is described with reference to the flowchart illustrated in FIG. 27, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example method 2700 of FIG. 27 begins at block 2702, at which the first and second example diaphragms 1604, 1606 are positioned in the example diaphragm actuator 1602 of FIG. 16 to define a first example chamber 1608, a second example chamber 1610, and a third example chamber 1614 in the diaphragm actuator 1602. For example, the first chamber 1608 is defined between the first and second diaphragms 1604, 1606, the second chamber 1610 is defined between the first diaphragm 1604 and the first end 1612 of the diaphragm actuator 1602, and the third chamber 1614 is defined between the second diaphragm 1606 and the second end 1616 of the diaphragm actuator 1602. In some examples, the first chamber 1608 is sealed between the first and second diaphragms 1604, 1606, such that the first and second diaphragms 1604, 1606 restrict and/or prevent leakage of fluid from the first chamber 1608 to the second chamber 1610 and/or the third chamber 1614.

At block 2704, the second example chamber 1610 is fluidly coupled between the first example pipe 102 and the second example pipe 104. For example, the second chamber 1610 is fluidly coupled to the first pipe 102 via the first example inlet line 1618 of FIG. 16 to receive fluid from the first pipe 102, and is fluidly coupled to the second pipe 104 via the first example outlet line 1620 of FIG. 16 to provide the fluid to the second pipe 104. In some examples, the first example valve 1630 of FIG. 16 is implemented along the first inlet line 1618 to enable flow of fluid to the second chamber 1610 when the first valve 1630 is in an open position, and a buildup of pressure in the second chamber 1610 results in deflection of the first diaphragm 1604 (e.g., in the first direction 1642 of FIG. 16). In some examples, the example bleed valve 1634 of FIG. 16 is implemented along the first outlet line 1620 to gradually release the fluid to the second pipe 104 at a pressure at or near a pressure in the second pipe 104. In some examples, release of the fluid from the second chamber 1610 enables the first diaphragm 1604 to return to a starting (e.g., undeflected) position. In some examples, repeated opening and closing of the first valve 1630 drives reciprocal motion of the first diaphragm 1604 between the deflected and undeflected positions.

At block 2706, the third example chamber 1614 is fluidly coupled between the example gas source 106 and the second example pipe 104. For example, the third chamber 1614 is fluidly coupled to the gas source 106 via the second example inlet line 1622 to receive bleed gas from the gas source 106, and is fluidly coupled to the second pipe 104 via the second example outlet line 1624 to provide the bleed gas to the second pipe 104. In some examples, the second example valve 1632 is implemented along the first inlet line 1618 to enable flow of bleed gas to the second chamber 1610 when the second valve 1632 is in an open position. In some examples, the example check valves 1626, 1628 are implemented along the second inlet line 1622 and the second outlet line 1624 to restrict backflow of bleed gas from the second pipe 104 to the third chamber 1614 and/or from the third chamber 1614 to the gas source 106.

At block 2708, the first example spring 1636 of FIG. 16 is operatively coupled to the first example diaphragm 1604. For example, the first spring 1636 is operatively coupled between the first diaphragm 1604 and the inner surface 1638 of the diaphragm actuator 1602. In some examples, the first spring 1636 biases and/or facilitates return of the first diaphragm 1604 to the undeflected position.

At block 2710, the second example spring 1640 of FIG. 16 is operatively coupled to the second example diaphragm 1606. For example, the second spring 1640 is operatively coupled between the second diaphragm 1606 and the second end 1616 of the diaphragm actuator 1602. In some examples, reciprocal motion of the first diaphragm 1604 varies a pressure in the first chamber 1608 and, thus, drives reciprocal motion of the second diaphragm 1606. In some examples, the reciprocal motion of the second diaphragm 1606 (e.g., between a deflected and undeflected position) drives pumping of bleed gas from the gas source 106 into the third chamber 1614, and from the third chamber 1614 into the second pipe 104. In some examples, the second spring 1640 biases and/or facilitates return of the second diaphragm 1606 to the undeflected position.

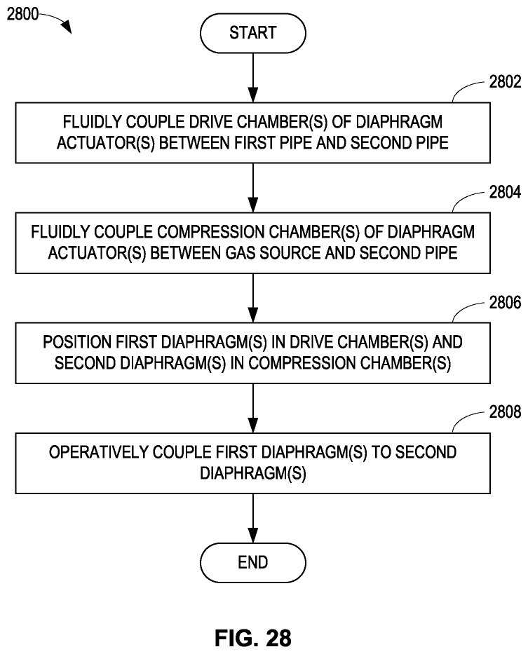

FIG. 28 is a flowchart representative of an example method 2800 to produce the tenth example drive system 1700 of FIG. 17A. Although the example method is described with reference to the flowchart illustrated in FIG. 28, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example method 2800 of FIG. 28 begins at block 2802, at which the example drive chambers 1704A, 1704B, 1704C of the example diaphragm actuators 1702A, 1702B, 1702C are fluidly coupled between the first example pipe 102 and the second example pipe 104. For example, the drive chambers 1704A, 1704B, 1704C are fluidly coupled to the first pipe 102 via respective ones of the example inlet lines 1722A, 1722B, 1722C, and are fluidly coupled to the second pipe 104 via respective ones of the example outlet lines 1724A, 1724B, 1724C of FIG. 17A.

At block 2804, the example compression chambers 1706A, 1706B, 1706C of the diaphragm actuators 1702A, 1702B, 1702C are fluidly coupled between the example gas source 106 and the second pipe 104. For example, the example bleed line 1726 of FIG. 17A is fluidly coupled between the gas source 106 and the second pipe 104, and the compression chambers 1706A, 1706B, 1706C are implemented in series along the bleed line 1726.

At block 2806, the first example diaphragms 1708A, 1708B, 1708C of FIG. 17A are positioned in respective ones of the drive chambers 1704A, 1704B, 1704C, and the second example diaphragms 1714A, 1714B, 1714C of FIG. 17A are positioned in respective ones of the compression chambers 1706A, 1706B, 1706C. For example, the first diaphragms 1708A, 1708B, 1708C are positioned in the respective ones of the drive chambers 1704A, 1704B, 1704C to define the first example chamber portions 1710A, 1710B, 1710C and the second example chamber portions 1712A, 1712B, 1712C of the respective drive chambers 1704A, 1704B, 1704C. Additionally, the second diaphragms 1714A, 1714B, 1714C are positioned in the respective ones of the compression chambers 1706A, 1706B, 1706C to define the third example chamber portions 1716A, 1716B, 1716C and the fourth example chamber portions 1718A, 1718B, 1718C of the respective compression chambers 1706A, 1706B, 1706C.

At block 2808, the first diaphragms 1708A, 1708B, 1708C are operatively coupled the second diaphragms 1714A, 1714B, 1714C. For example, the example rods 1720A, 1720B, 1720C operatively couple the first diaphragms 1708A, 1708B, 1708C to respective ones of the second diaphragms 1714A, 1714B, 1714C, such that the first diaphragms 1708A, 1708B, 1708C and the respective ones of the second diaphragms 1714A, 1714B, 1714C move and/or deflect together (e.g., in a same direction). In some examples, fluid from the first pipe 102 is provided to alternating ones of the first chamber portions 1710A, 1710B, 1710C and the second chamber portions 1712A, 1712B, 1712C to drive reciprocal motion of the first diaphragms 1708A, 1708B, 1708C. Further, the reciprocal motion of the first diaphragms 1708A, 1708B, 1708C drives corresponding reciprocal motion of the second diaphragms 1714A, 1714B, 1714C. In such examples, the reciprocal motion of the second diaphragms 1714A, 1714B, 1714C draws bleed gas to and/or pumps bleed gas from alternating ones of the third chamber portions 1716A, 1716B, 1716C and the fourth chamber portions 1718A, 1718B, 1718C, such that compressed bleed gas is provided and/or returned to the second pipe 104.

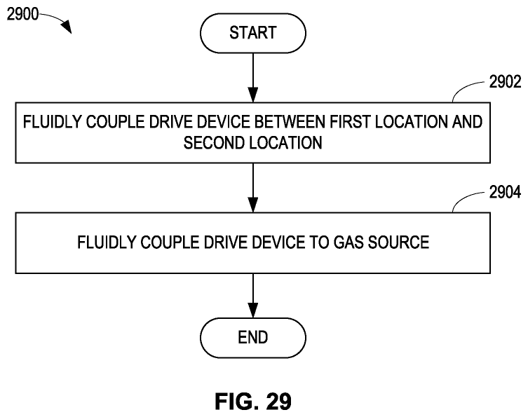

FIG. 29 is a flowchart representative of an example method 2800 to produce the example gas recovery system 100 of FIG. 1. Although the example method is described with reference to the flowchart illustrated in FIG. 29, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

At block 2902, the example drive device 108 of FIG. 1 is fluidly coupled between a first example location and a second example location. In some examples, the first location corresponds to the first example pipe 102 of FIG. 1, and the second location corresponds to the second example pipe 104 of FIG. 2. In some examples, the first and second locations correspond to different locations along a same length of pipe (e.g., the first pipe 102 or the second pipe 104). In some examples, the drive device 108 includes at least one of a piston, a diaphragm actuator, a turbine, or a fluid constrictor. In some examples, the drive device 108 includes at least one of the first example drive system 200 shown in FIG. 2, the second example drive system 300 shown in FIG. 3, the third example drive system 400 shown in FIG. 4, the fourth example drive system 700 shown in FIG. 7, the fifth example drive system 800 shown in FIG. 8, the sixth example drive system 900 shown in FIG. 9, the seventh example drive system 1000 shown in FIG. 10, the eighth example drive system 1400 shown in FIG. 14, the ninth example drive system 1600 shown in FIG. 16, or the tenth example drive system 1700 shown in FIG. 17A. In some examples, a pressure differential between the first and second location drives operation of the example drive device 108.

At block 2904, the example drive device 108 is fluidly coupled to the example gas source 106 of FIG. 1. For example, the drive device 108 is fluidly coupled to the gas source 106 such that operation of the drive device 108 drives evacuation and/or compression of bleed gas from the gas source 106. In some examples, the operation of the drive device 108 also causes the evacuated and/or compressed bleed gas to be routed and/or pumped to a third example location. In some examples, the third location corresponds to the first pipe 102, the second pipe 104, one or more different pipes, a gas storage location, etc.

In some examples, the drive device 108 can be implemented in a variety of ways to capture and/or evacuate bleed gas from an example bleed gas source, thus reducing an amount of bleed gas to be vented and/or otherwise released to the atmosphere. For example, the drive device 108 can be implemented using at least one of the first example drive system 200 of FIG. 2, the second example drive system 300 of FIG. 3, and/or the third example drive system 400 of FIG. 4 produced using the example method of FIG. 20, the fourth example drive system 700 of FIG. 7 produced using the example method 2100 of FIG. 21, the fifth example drive system 800 of FIG. 8 produced using the example method 2300 of FIG. 23, the sixth example drive system 900 of FIG. 9 produced using the example method 2400 of FIG. 24, the seventh example drive system 1000 of FIG. 10 produced using the example method 2500 of FIG. 25, the eighth example drive system 1400 of FIG. 14 produced using the example method 2600 of FIG. 26, the ninth example drive system 1600 of FIG. 16 produced using the example method 2700 of FIG. 27, or the tenth example drive system 1700 of FIG. 17A produced using the method 2800 of FIG. 28.

In operation, the example drive system 108 of FIG. 1 can implement an example gas recovery procedure to capture and/or evacuate bleed gas from a bleed gas source and provide the evacuated bleed gas to an example location (e.g., a pipe, a gas storage location, etc.) to reduce an amount of bleed gas to be vented and/or released to the atmosphere.

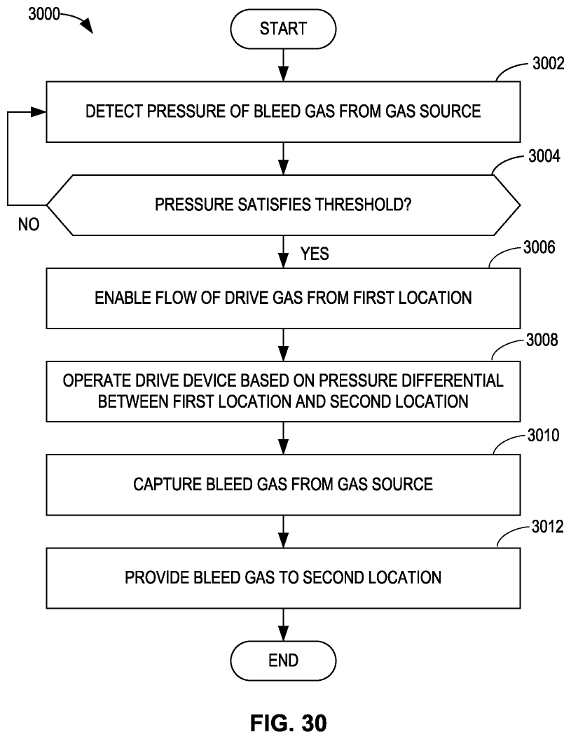

For example, FIG. 30 is a flowchart representative of an example method 3000 to implement an example gas recovery procedure using the example gas recovery system 100 of FIG. 1. Although the example method is described with reference to the flowchart illustrated in FIG. 30, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example. The example method 3000 begins as the drive system 108 is implemented as described above in one or more of FIGS. 20-29 above.

At block 3002, the example sensor 116 of FIG. 1 detects a pressure of bleed gas from the example gas source 106 of FIG. 1. For example, the sensor 116 is operatively coupled to the gas source 106 to detect and/or measure the pressure of the bleed gas therefrom. In some examples, the bleed gas from the gas source 106 is provided to an example accumulator, and the sensor 116 is operatively coupled to the accumulator to measure the pressure of the bleed gas therein.

At block 3004, the example sensor 116 detects whether the pressure of the bleed gas satisfies an example threshold. For example, the sensor 116 can detect a presence of bleed gas when the pressure satisfies the threshold (e.g., is at or above 1 psi, 1.5 psi, etc.). In response to the sensor 116 detecting that the pressure does not satisfy the threshold (e.g., block 3004 returns a result of NO), control returns to block 3002. Alternatively, in response to the sensor 116 detecting that the pressure satisfies the threshold (e.g., block 3004 returns a result of YES), control proceeds to block 3006.

At block 3006, the example sensor 116 enables flow of drive gas from a first location (e.g., the first example pipe 102 of FIG. 1). For example, the sensor 116 provides the example control signal 118 to the example drive device 108 of FIG. 1, where the control signal 118 enables the flow of drive gas to turn on and/or activate the drive device 108. In some examples, the drive gas flows from the first pipe 102 to the drive device 108 to drive operation of one or more example components (e.g., an example piston, an example diaphragm actuator, and example turbine, etc.).

At block 3008, the example drive device 108 operates based on a pressure differential between the first location (e.g., the first pipe 102 of FIG. 1) and a second location (e.g., the second example pipe 104 of FIG. 1, a different location of the first pipe 102, etc.). In some examples, the pressure differential drives the flow of drive gas to one or more components of the drive device (e.g., between different chambers of an example cylinder and/or an example diaphragm actuator, to an example turbine, to an example Venturi and/or one or more tap lines fluidly coupled thereto, etc.). In some examples, the flow of drive gas drives operation of the drive device 108 (e.g., reciprocal motion of a diaphragm and/or a piston, rotation of a turbine, etc.) to enable evacuation of bleed gas from the gas source 106.

At block 3010, the example drive device 108 captures bleed gas from the gas source 106. For example, as a result of the operation of the drive device 108, bleed gas is drawn and/or evacuated from the gas source 106 to the drive device 108. In some examples, the bleed gas is provided to an example cylinder of the drive device 108, an example chamber of a diaphragm actuator of the drive device 108, etc.

At block 3012, the example drive device 108 provides the bleed gas to the second location (e.g., the second pipe 104). For example, as a result of the operation of the drive device 108, the evacuated bleed gas is compressed and/or is pumped to the second location. In some examples, the second location corresponds to the second pipe 104, a location along the first pipe 102 different from the first location, a gas storage location and/or storage tank, etc. In some examples, the drive device 108 provides the evacuated bleed gas to the second location at a second example pressure (e.g., 45 psi, 50 psi, 55 psi, etc.) greater than a first example pressure (e.g., 1 psi, 1.5 psi, 2 psi, etc.) of the bleed gas from the gas source 106. In some examples, as a result of the drive device 108 providing the evacuated bleed gas to the second location, the gas recovery system 100 can reduce an amount of bleed gas to be vented and/or otherwise released to the atmosphere.

In some examples, means for providing bleed gas can be implemented by the gas source 106 of FIGS. 1, 2, 3, 4, 7, 8, 9, 10, 11, 12, 13, 14, 16, 17A, 18A, 18B, 19A, and/or 19B. In some examples, means for sensing can be implemented by the sensor 116 of FIG. 1. In some examples, means for driving can be implemented by the first drive system 200 of FIG. 2, the second drive system 300 of FIG. 3, the third drive system 400 of FIG. 4, the fourth drive system 700 of FIG. 7, the fifth drive system 800 of FIG. 8, the sixth drive system 900 of FIG. 9, the seventh drive system 1000 of FIG. 10, the eighth drive system 1400 of FIG. 14, the ninth drive system 1600 of FIG. 16, or the tenth drive system 1700 shown in FIG. 17A. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

In some examples, programmable circuitry can be used to control aspects of one or more devices (e.g., the valves 212, 214, 232, 236 of FIG. 2, the valve 330 of FIG. 3, the valve 732 of FIG. 7, the valves 1630, 1632 of FIG. 16, etc.) disclosed herein. As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that capture bleed gas from a gas source (e.g., one or more gas-operated devices) and return the captured bleed gas to a pipeline. Examples disclosed herein implement an example gas recovery system including an example drive device fluidly coupled between a first example location and a second example location. In some examples, a pressure differential between the first and second locations drives operation of the drive device. Further, the drive device is fluidly coupled to an example gas source (e.g., a bleed gas source). In some examples, the operation of the drive device drives evacuation and/or compression of bleed gas from the bleed gas source, and the evacuated and/or compressed bleed gas is routed and/or pumped to a third location (e.g., corresponding to the first location, the second location, and/or a different location). Advantageously, the disclosed systems, methods, apparatus, and articles of manufacture reduce emission of bleed gas into the atmosphere, which reduces environmental harm, economic waste, and/or risk of accidental combustion compared to venting of the bleed gas.

Example gas recovery systems and methods are disclosed herein. Further examples and combinations thereof include the following:
Example 1 includes an apparatus comprising a bleed gas source, and a drive device fluidly coupled to the bleed gas source and further fluidly coupled between a first location and a second location, a pressure differential between the first and second locations to drive operation of the drive device, the operation of the drive device to evacuate bleed gas from the bleed gas source and route the evacuated bleed gas to a third location.
Example 2 includes the apparatus of example 1, further including a sensor operatively coupled to the drive device and to the bleed gas source, the sensor to detect a pressure of the bleed gas from the bleed gas source, when the detected pressure satisfies a threshold, enable, based on a control signal, flow of drive gas from the first location to the drive device, and when the detected pressure does not satisfy the threshold, shut off, based on the control signal, the flow of the drive gas to the drive device.
Example 3 includes the apparatus of example 2, further including a valve fluidly coupled between the first location and the drive device, the sensor operatively coupled to the valve, the sensor to switch, based on the control signal to the valve, the valve between (a) an open position in which the valve enables the flow of the drive gas to the drive device and (b) a closed position in which the valve restricts the flow of the drive gas to the drive device.
Example 4 includes the apparatus of example 1, wherein the drive device includes a cylinder fluidly coupled between the bleed gas source and the third location, a piston positioned in the cylinder, and an actuator operatively coupled to the piston and fluidly coupled between the first location and the second location, the pressure differential between the first and second locations to drive reciprocal motion of the actuator and the piston, the reciprocal motion of the piston to draw the bleed gas from the bleed gas source to the cylinder and pump the bleed gas from the cylinder to the second location.
Example 5 includes the apparatus of example 4, wherein the piston is a first piston, the cylinder is a first cylinder, the actuator includes a second piston positioned in a second cylinder, the first piston operatively coupled to the second piston via a rod extending through a first end of the first cylinder and a second end of the second cylinder.
Example 6 includes the apparatus of example 1, wherein the first location corresponds to a pipe section of a fluid constrictor positioned along a pipe, a first diameter of the pipe section less than a second diameter of the pipe, the second location corresponding to the pipe upstream of the fluid constrictor, the third location corresponding to the pipe downstream of the fluid constrictor.
Example 7 includes the apparatus of example 6, wherein the fluid constrictor is a first fluid constrictor, the drive device including at least one of a turbine, a second fluid constrictor, or a diaphragm actuator operatively coupled to a piston.
Example 8 includes the apparatus of example 1, wherein the drive device includes a turbine positioned in a pipe, the pressure differential to produce a fluid flow through the pipe between the first and second locations, the fluid flow to drive rotation of turbine blades of the turbine, and a pump operatively coupled to the turbine and fluidly coupled between the bleed gas source and the third location, the rotation of the turbine blades to drive operation of the pump, the operation of the pump to draw the bleed gas from the bleed gas source and direct the bleed gas to the third location.
Example 9 includes the apparatus of example 8, wherein the pump includes at least one of a screw-driven pump, a vane pump, or a swash plate pump.
Example 10 includes the apparatus of example 1, wherein the drive device includes a diaphragm actuator fluidly coupled between the first location and the second location, the pressure differential to drive reciprocal motion of a diaphragm of the diaphragm actuator, and a compression device operatively coupled to the diaphragm and fluidly coupled between the bleed gas source and the third location, the reciprocal motion of the diaphragm to drive reciprocal motion of the compression device, the reciprocal motion of the compression device to draw the bleed gas from the bleed gas source and direct the bleed gas to the third location.
Example 11 includes the apparatus of example 10, wherein the diaphragm is a first diaphragm, the diaphragm actuator is a first diaphragm actuator, the compression device including a second diaphragm positioned in at least one of (a) a second diaphragm actuator operatively coupled to the first diaphragm actuator or (b) a housing of the first diaphragm actuator.
Example 12 includes the apparatus of example 1, wherein the third location corresponds to one of the first location or the second location.
Example 13 includes a method comprising fluidly coupling a drive device between a first location and a second location, a pressure differential between the first and second locations to drive operation of the drive device, and fluidly coupling the drive device to a bleed gas source, the operation of the drive device to evacuate bleed gas from the bleed gas source and route the evacuated bleed gas to a third location.
Example 14 includes the method of example 13, further including operatively coupling a sensor to the drive device and to the bleed gas source, the sensor to detect a pressure of the bleed gas from the bleed gas source, when the detected pressure satisfies a threshold, enable, based on a control signal, flow of drive gas from the first location to the drive device, and when the detected pressure does not satisfy the threshold, shut off, based on the control signal, the flow of the drive gas to the drive device.
Example 15 includes the method of example 14, further including fluidly coupling a valve between the first location and the drive device, and operatively coupling the sensor to the valve, the sensor to switch, based on the control signal to the valve, the valve between (a) an open position in which the valve enables the flow of the drive gas to the drive device and (b) a closed position in which the valve restricts the flow of the drive gas to the drive device.
Example 16 includes the method of example 15, further including fluidly coupling a cylinder of the drive device between the bleed gas source and the third location, positioning a piston of the drive device in the cylinder, operatively coupling an actuator of the drive device to the piston, and fluidly coupling the actuator between the first location and the second location, the pressure differential between the first and second locations to drive reciprocal motion of the actuator and the piston, the reciprocal motion of the piston to draw the bleed gas from the bleed gas source to the cylinder and pump the bleed gas from the cylinder to the second location.
Example 167 includes the method of example 16, wherein fluidly coupling the drive device between the first location and the second location includes fluidly coupling the drive device to a pipe section of a fluid constrictor positioned along a pipe, a first diameter of the pipe section less than a second diameter of the pipe, and fluidly coupling the drive device to the pipe upstream of the fluid constrictor.
Example 18 includes the method of example 17, further including positioning a turbine of the drive device in a pipe, the pressure differential to produce a fluid flow through the pipe between the first and second locations, the fluid flow to drive rotation of turbine blades of the turbine, operatively coupling a pump of the drive device to the turbine, and fluidly coupling the pump between the bleed gas source and the third location, the rotation of the turbine blades to drive operation of the pump, the operation of the pump to draw the bleed gas from the bleed gas source and direct the bleed gas to the third location.
Example 19 includes an apparatus comprising means for providing bleed gas, and means for driving fluidly coupled to the means for providing bleed gas and further fluidly coupled between a first location and a second location, a pressure differential between the first and second locations to drive operation of the means for driving, the operation of the means for driving to evacuate bleed gas from the means for providing bleed gas and route the evacuated bleed gas to a third location.
Example 20 includes the apparatus of example 19, further including means for sensing operatively coupled to the means for driving and to the means for providing bleed gas, the means for sensing to detect a pressure of the bleed gas from the means for providing bleed gas, when the detected pressure satisfies a threshold, enable, based on a control signal, flow of drive gas from the first location to the means for driving, and when the detected pressure does not satisfy the threshold, shut off, based on the control signal, the flow of the drive gas to the means for driving.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a bleed gas source; and
a drive device fluidly coupled to the bleed gas source and further fluidly coupled between a first location and a second location, a pressure differential between the first and second locations to drive operation of the drive device, the operation of the drive device to evacuate bleed gas from the bleed gas source and route the evacuated bleed gas to a third location.

2. The apparatus of claim 1, further including a sensor operatively coupled to the drive device and to the bleed gas source, the sensor to:
detect a pressure of the bleed gas from the bleed gas source;
when the detected pressure satisfies a threshold, enable, based on a control signal, flow of drive gas from the first location to the drive device; and
when the detected pressure does not satisfy the threshold, shut off, based on the control signal, the flow of the drive gas to the drive device.

3. The apparatus of claim 2, further including a valve fluidly coupled between the first location and the drive device, the sensor operatively coupled to the valve, the sensor to switch, based on the control signal to the valve, the valve between (a) an open position in which the valve enables the flow of the drive gas to the drive device and (b) a closed position in which the valve restricts the flow of the drive gas to the drive device.

4. The apparatus of claim 1, wherein the drive device includes:
a cylinder fluidly coupled between the bleed gas source and the third location;
a piston positioned in the cylinder; and
an actuator operatively coupled to the piston and fluidly coupled between the first location and the second location, the pressure differential between the first and second locations to drive reciprocal motion of the actuator and the piston, the reciprocal motion of the piston to draw the bleed gas from the bleed gas source to the cylinder and pump the bleed gas from the cylinder to the second location.

5. The apparatus of claim 4, wherein the piston is a first piston, the cylinder is a first cylinder, the actuator includes a second piston positioned in a second cylinder, the first piston operatively coupled to the second piston via a rod extending through a first end of the first cylinder and a second end of the second cylinder.

6. The apparatus of claim 1, wherein the first location corresponds to a pipe section of a fluid constrictor positioned along a pipe, a first diameter of the pipe section less than a second diameter of the pipe, the second location corresponding to the pipe upstream of the fluid constrictor, the third location corresponding to the pipe downstream of the fluid constrictor.

7. The apparatus of claim 6, wherein the fluid constrictor is a first fluid constrictor, the drive device including at least one of a turbine, a second fluid constrictor, or a diaphragm actuator operatively coupled to a piston.

8. The apparatus of claim 1, wherein the drive device includes:
a turbine positioned in a pipe, the pressure differential to produce a fluid flow through the pipe between the first and second locations, the fluid flow to drive rotation of turbine blades of the turbine; and
a pump operatively coupled to the turbine and fluidly coupled between the bleed gas source and the third location, the rotation of the turbine blades to drive operation of the pump, the operation of the pump to draw the bleed gas from the bleed gas source and direct the bleed gas to the third location.

9. The apparatus of claim 8, wherein the pump includes at least one of a screw-driven pump, a vane pump, or a swash plate pump.

10. The apparatus of claim 1, wherein the drive device includes:
a diaphragm actuator fluidly coupled between the first location and the second location, the pressure differential to drive reciprocal motion of a diaphragm of the diaphragm actuator; and
a compression device operatively coupled to the diaphragm and fluidly coupled between the bleed gas source and the third location, the reciprocal motion of the diaphragm to drive reciprocal motion of the compression device, the reciprocal motion of the compression device to draw the bleed gas from the bleed gas source and direct the bleed gas to the third location.

11. The apparatus of claim 10, wherein the diaphragm is a first diaphragm, the diaphragm actuator is a first diaphragm actuator, the compression device including a second diaphragm positioned in at least one of (a) a second diaphragm actuator operatively coupled to the first diaphragm actuator or (b) a housing of the first diaphragm actuator.

12. The apparatus of claim 1, wherein the third location corresponds to one of the first location or the second location.

13. A method comprising:
fluidly coupling a drive device between a first location and a second location, a pressure differential between the first and second locations to drive operation of the drive device; and
fluidly coupling the drive device to a bleed gas source, the operation of the drive device to evacuate bleed gas from the bleed gas source and route the evacuated bleed gas to a third location.

14. The method of claim 13, further including operatively coupling a sensor to the drive device and to the bleed gas source, the sensor to:
detect a pressure of the bleed gas from the bleed gas source;
when the detected pressure satisfies a threshold, enable, based on a control signal, flow of drive gas from the first location to the drive device; and
when the detected pressure does not satisfy the threshold, shut off, based on the control signal, the flow of the drive gas to the drive device.

15. The method of claim 14, further including:
fluidly coupling a valve between the first location and the drive device; and
operatively coupling the sensor to the valve, the sensor to switch, based on the control signal to the valve, the valve between (a) an open position in which the valve enables the flow of the drive gas to the drive device and (b) a closed position in which the valve restricts the flow of the drive gas to the drive device.

16. The method of claim 13, further including:
fluidly coupling a cylinder of the drive device between the bleed gas source and the third location;
positioning a piston of the drive device in the cylinder;
operatively coupling an actuator of the drive device to the piston; and
fluidly coupling the actuator between the first location and the second location, the pressure differential between the first and second locations to drive reciprocal motion of the actuator and the piston, the reciprocal motion of the piston to draw the bleed gas from the bleed gas source to the cylinder and pump the bleed gas from the cylinder to the second location.

17. The method of claim 13, wherein fluidly coupling the drive device between the first location and the second location includes:
fluidly coupling the drive device to a pipe section of a fluid constrictor positioned along a pipe, a first diameter of the pipe section less than a second diameter of the pipe; and
fluidly coupling the drive device to the pipe upstream of the fluid constrictor.

18. The method of claim 13, further including:
positioning a turbine of the drive device in a pipe, the pressure differential to produce a fluid flow through the pipe between the first and second locations, the fluid flow to drive rotation of turbine blades of the turbine;
operatively coupling a pump of the drive device to the turbine; and
fluidly coupling the pump between the bleed gas source and the third location, the rotation of the turbine blades to drive operation of the pump, the operation of the pump to draw the bleed gas from the bleed gas source and direct the bleed gas to the third location.

19. An apparatus comprising:
means for providing bleed gas; and
means for driving fluidly coupled to the means for providing bleed gas and further fluidly coupled between a first location and a second location, a pressure differential between the first and second locations to drive operation of the means for driving, the operation of the means for driving to evacuate bleed gas from the means for providing bleed gas and route the evacuated bleed gas to a third location.

20. The apparatus of claim 19, further including means for sensing operatively coupled to the means for driving and to the means for providing bleed gas, the means for sensing to:
detect a pressure of the bleed gas from the means for providing bleed gas;
when the detected pressure satisfies a threshold, enable, based on a control signal, flow of drive gas from the first location to the means for driving; and
when the detected pressure does not satisfy the threshold, shut off, based on the control signal, the flow of the drive gas to the means for driving.
